(19) United States
(12) Patent Application Publication
(10) Pub. No.: US 2016/0202670 A1
(43) Pub. Date: Jul. 14, 2016

(54) SYSTEM AND METHOD FOR SEQUENTIAL ACTION CONTROL FOR NONLINEAR SYSTEMS

(71) Applicant: NORTHWESTERN UNIVERSITY, EVANSTON, IL (US)

(72) Inventors: Alexander R. Ansari, Chicago, IL (US); Todd D. Murphey, Evanston, IL (US)

(21) Appl. No.: 14/975,355

(22) Filed: Dec. 18, 2015

Related U.S. Application Data
(60) Provisional application No. 62/101,087, filed on Jan. 8, 2015.

(51) Int. Cl. G05B 13/02

(52) U.S. Cl. CPC G05B 13/026

(57) ABSTRACT

A system includes a mechanism for preforming an action. A processor connects with the mechanism, the processor for executing instructions stored in a memory. The instructions when executed by the processor causes the processor to determine an action for a mechanism, determine when to act on the action, determine a duration for the action, send the action to the mechanism, including when to act and the duration for the action, and receive feedback from the mechanism based on the action.

### CROSS-REFERENCE TO RELATED APPLICATION

This application claims the benefit of U.S. Provisional Application Ser. No. 62/101,087, filed Jan. 8, 2015, which is incorporated in its entirety herein.

### GOVERNMENT LICENSE RIGHTS

This invention was made with government support under grant number CMMI1200321 awarded by the National Science Foundation. The government has certain rights in the invention.

### BACKGROUND

Robots can include many moving bodies that may interact with the environment in locomotion and manipulation tasks. Such systems can lead to nonlinear, hybrid, underactuated, and high-dimensional control problems subject to both state and control constraints (e.g., actuator limits). The nonlinear control problems can be particularly challenging. Though a number of techniques have been devised, most controllers are highly specialized, designed for implementation on a specific robot under idealized conditions. In spite of years of research, many modern control designers rely on simplifying assumptions and try to operate robots in restricted, linear domains in order to use proportional-integral-derivative (PID) control or simple linear systems techniques developed in the last century. Although these control strategies may prove easier to implement and analyze than nonlinear alternatives, they can result in significant performance sacrifice.

Control for nonlinear systems can be an open and challenging problem for which a number of different methods have been devised. As one alternative, researchers dedicate their efforts to the derivation of Lyapunov functions for control policy generation on specific robotic systems. When they can be obtained, Lyapunov functions provide powerful guarantees regarding the stability of a given controller. For instance, control Lyapunov methods can yield a constructive means generate stable dynamic walking controllers for hybrid dynamical models with only one degree of underactuation. While in this case the techniques are shown to extend to classes of underactuated systems that have an invariant zero dynamics surface and an exponentially stable periodic orbit transverse to their switching surface, more generally Lyapunov functions can be difficult to find and are often specialized to a system model.

As opposed to control policy generation based on Lyapunov functions, alternative feedback linearization methods provide a relatively straightforward approach to control synthesis for fully actuated classes of nonlinear systems that is not system specific. Partial feedback linearization extends control to some underactuated systems. While very popular, these feedback linearization methods suffer performance drawbacks. Though they are easy to apply, they use control effort to overpower, rather than take advantage of system dynamics the way optimization based control methods do. Hence, they often result in significantly greater control effort than required by alternative solutions and provide no guarantee that solutions will satisfy control constraints.

Optimization has a long and significant history in control. Stemming from the classical calculus of variations, fundamental developments in the 1950s lead to the Hamilton-Jacobi-Bellman (RIB) equations and Pontryagin's Maximum Principle (PMP), which marked the birth of the field of optimal control. Using dynamic programming principles (e.g., searching for solutions to the RIB partial differential equations), control designers can obtain globally optimal control solutions that drive a robot from an arbitrary initial state and minimize a user specified trajectory objective. However, solutions to the HJB partial differential equations can only be found in the simplest of cases (typically twice differentiable systems with linear dynamics and simple convex objectives). As an alternative, Approximate Dynamic Programming (ADP) techniques rely on discretization of state and control spaces and iterative optimization to approximate solutions to the HJB difference equations. These methods accommodate more complicated nonlinear and constrained robotic systems and approximate optimal trajectories through state space (again from arbitrary initial conditions). Though powerful, these dynamic programming techniques suffer from the curse of dimensionality and are limited to low-dimensional systems (usually six or fewer states based on current processing capabilities).

### BRIEF DESCRIPTION OF DRAWINGS

FIG. 1 is a flow diagram of an overview of an example sequential action control (SAC) process.

FIG. 2 is a graph of an example action determined by the SAC process.

FIG. 3 is a graph of an example trajectory optimization.

FIG. 4 is a graph of an example comparison of control methods in terms of potential impact and generality.

FIG. 5 is a block diagram of example configuration variables for a cart-pendulum system.

FIG. 6 is a graph of an example schedule of optimal actions.

FIG. 7 is a plot of an example real component of the two eigenvalues.

FIGS. 8A-B are graphs of a closed-loop response of the (nonlinear) cart-pendulum system.

FIGS. 9A-B are graphs showing an SAC process is applied to invert the cart-pendulum system at a low sampling and control sequencing frequency.

FIG. 10A-B are graphs of example cost (FIG. 10A) and time (FIG. 10B) to complete open-loop optimal trajectory from SQP as a function of the optimization time horizon.

FIGS. 11A-B are graphs of example control solutions on-line and in closed-loop.

FIGS. 12A-B are graphs of example SAC algorithm controls the reduced state cart-pendulum in tracking a sinusoidal angular trajectory.

FIG. 13 is a block diagram of example configuration variables for the acrobot and pendubot systems.

FIGS. 14A-B and FIGS. 15A-B show the trajectories produced by SAC when each system is initialized at the downward, stable equilibrium and the desired position is the equilibrium with both links fully inverted.

FIGS. 16A-B are graphs of an example SAC process 100 that can exactly recover the analytically optimal bang-bang control solution to the minimum time parking problem on-line and faster than real-time in closed-loop application.

FIG. 17 is graphs of a perturbed control (top) and a corresponding (hypothetical) state variation (bottom) for a hybrid system.

FIG. 18 is a graph of an example mass dropped from a height.

FIGS. 19 and 20 are graphs including a 1D example to demonstrate the calculation of the variational equation, adjoint equation, and the sensitivity of a cost to control equation (47).

FIG. 21 is a graph of an example to use equation (47) (based on the adjoint in equation (48)) to amend SAC calculations in order to control a bouncing ball through impacts and toward a goal state.

FIGS. 22A-B are graphs of example accelerations SAC applies in the horizontal (see FIG. 22A) and vertical (see FIG. 22B) directions.

FIG. 23 and FIGS. 24A-B are graphs of example results obtained in a scenario where SAC is specified to track the desired state.

FIG. 25 is a system and flow diagram of another exemplary SAC process.

FIG. 26 is a diagram of an example marionette system and corresponding graph of example state trajectories.

FIG. 27 is a block diagram of example planar configuration variables for the SLIP system.

FIGS. 28A-B are block diagrams of example snapshots of the SLIP model successfully hopping up stairs and over sinusoidal terrain.

FIGS. 29A-F are graphs of an example trajectory corresponding to the SLIP hopping up stairs (FIG. 28A).

### DESCRIPTION

A system and method can compute predictive optimal controls on-line and in closed loop for broad classes of challenging nonlinear systems, including one or more of hybrid impulsive, underactuated, and state and control constrained systems. Rather than iteratively optimize finite horizon control sequences to minimize an objective, the systems and methods derive a closed-form expression for individual control actions (e.g., control values that can be applied for short duration) at each instant that optimally improve a tracking objective over a long time horizon. Under mild assumptions, the expression for optimal actions becomes a linear state feedback control law near equilibria that permits stability analysis and performance based parameter selection. Optimal actions can reduce to linear-quadratic (LQ) regulators with determined local stability properties as a special case. However, globally, derivations prove the optimal actions are solutions to a class of Tikhonov regularization problems and so inherit guarantees for existence and uniqueness.

By sequencing optimal actions on-line, the systems and methods form a piecewise continuous min-max constrained response to state that avoids the overhead typically required to impose control saturation constraints. Benchmark examples show that the approach can outperform both traditional optimal controllers and recently published, case-specific methods from literature in terms of tracking performance, and at computational speeds many orders of magnitude faster than traditionally achievable for nonlinear closed-loop predictive control. The results do not require seed trajectories and show that control synthesis based on optimal actions, which improve rather than directly minimize trajectory cost, can avoid local minima issues that can cause nonlinear trajectory optimization to converge to undesirable solutions. Further examples show the same approach controls both a high-dimensional continuous nonlinear system (e.g., a 56 dimensional, state and control constrained marionette model) and a hybrid model for dynamic locomotion (e.g., the spring-loaded inverted pendulum), based only on high-level models (e.g., a robot operating system (ROS) unified robot description format (URDF) or other operating system and file format) and trajectory goals. The examples show the systems and methods automate control policy generation for very different systems and can apply to a wide variety of robotics needs. The systems and methods apply to any mechanism with a physical manifestation that has a mathematical model of the forms specified, e.g., a robotic system and/or other electro-mechanical device. In one example, for purposes of explanation the systems and methods are described for a robot.

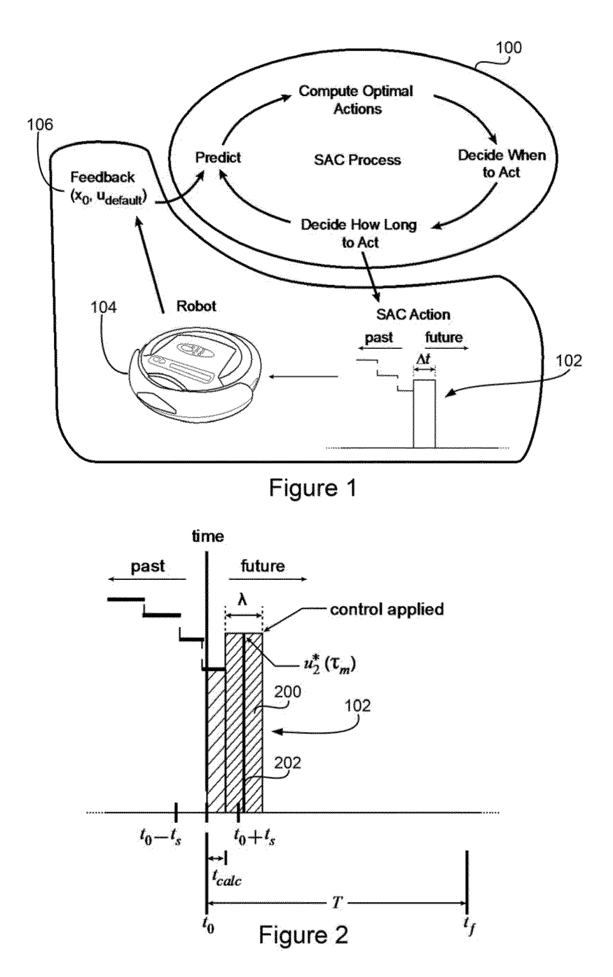

FIG. 1 is a flow diagram of an overview of an example sequential action control (SAC) process 100. The SAC process 100 can compute optimal actions, decide when to act, e.g., within the robotic actions, decide how long to act, make predictions, etc. The SAC process 100 can be implemented with hardware, firmware, software, and/or any combination thereof. Each cycle of the SAC process 100 can compute an action 102 that is sent to a robot 104, or other mechanism. At determined sampling times, the SAC process 100 can incorporate feedback 106 to the prediction and repeat the cycle to compute and apply the subsequent action 102. The determined sampling times can be fixed in one example, and random in other implementations. The process is typically very fast and subsequent actions are usually synthesized and applied before the robot 104 completes implementing the previously planned control. Although each action is designed for a short application duration, they provide long time horizon (from [t₀,t_{f}] in FIG. 2) improvements in system performance.

The SAC process 100 can be used to automate the process of control policy generation for broad classes of nonlinear robotic systems, e.g., using a computational approach to control synthesis. A model-based control algorithm uses optimization to rapidly synthesize predictive optimal controls in real time from a closed-form expression. The SAC process 100 develops a closed-loop response to state that can take advantage of complicated hybrid and underactuated nonlinear dynamics to capitalize on motion capabilities and allow robots to react to the environment on-line. The SAC process 100 can include a control algorithm that can automatically generate control policies for a variety of traditionally challenging classes of (nonlinear) robotic systems (e.g., continuous, underactuated, hybrid, hybrid impulsive, and constrained systems) based directly on encoded, high-level robot models and trajectory goals.

FIG. 2 is a graph of an example action 102 determined by the SAC process 100. The SAC process 100 can be used to control differentiable nonlinear systems with drift and affine control (with stability results and control constraints). The closed-loop approach to the SAC process 100 can be used to synthesize controls in a framework procedurally similar to continuous-time nonlinear receding horizon control. Following this framework, the SAC process 100 constructs a closed-loop control signal from a succession of open-loop, finite horizon optimal control problems. However, these open-loop problems typically require expensive, nonlinear iterative optimizations to derive each optimal control sequence.

Instead of iteratively optimizing control sequences to directly minimize the current trajectory objective, the SAC process 100 can directly compute infinitesimal optimal actions at each instant that iteratively and optimally improve the system trajectory objective. The SAC 100 can determine control action as a control vector, u, with constant values applied for a (possibly infinitesimal) duration, λ, at a specific time, τ. An example duration is, e.g., 0.001 second, or 0.3 second, or 1.5 second lengths of time, etc. The shaded region 200 represents a SAC action 102 of finite duration applied at time τ=zₘ. The curve 202 reflects an infinitesimal duration action with the same application time. By planning optimal actions individually, the approach ensures controls can be efficiently computed from a simple closed-form function of the current state and adjoint (co-state). Using a line search, SAC process 100 finds finite durations to apply each optimal action and sequences these actions into a piecewise continuous, closed-loop control response. Examples show SAC process 100 rapidly compute optimal/near-optimal solutions to benchmark problems.

Though actions in SAC process 100 are each designed to be applied for a short application duration, λ, they are specified to optimally improve system performance (according to a user specified tracking objective) over a longer horizon [t₀,t_{f}]. Following the first three steps in the cyclic process in FIG. 1, SAC process 100 computes an optimal infinitesimal duration action 202 to be applied at a selected (pre-specified or from optimization) application time τₘε(t₀+t_{calc},t_{f}). The value of the optimal infinitesimal action, u₂*(τₘ), specifies the value of the next SAC action 200. A line search is applied to set the action's duration, λ. The control law from the previous computations is applied from [t₀,t₀+t_{calc}] while current calculations complete. In receding horizon fashion, SAC process 100 incorporates feedback and sampling times every tₛ seconds and repeats the process in FIG. 1 to synthesize the next action while the current action is being carried out by the robot 104. The SAC process 100 develops a piecewise continuous response to state.

The one of the infinitesimal optimal actions 202 that SAC process 100 computes can avoid the overhead required to derive optimal control curves (optimal sequences of actions from [t₀,t_{f}]) in alternative receding horizon control strategies. Each infinitesimal optimal action is a needle variation relative to a nominal control around which the system trajectory is linearized. As is the case in FIG. 2, the nominal control is often assumed to be null (the zero vector), so actions are optimal relative to leaving the system unforced. These infinitesimal actions specify the value of each finite action SAC applies (as mentioned a line search determines the duration of the action). By optimizing over the space of individual (infinitesimal) control actions, the SAC process 100 requires none of the traditional overhead to deal with control saturation constraints. Additionally, SAC process 100 circumvents the

$$\frac{n \times n + n}{2}$$

unique Riccati differential equations traditionally solved for each open-loop optimal control with state ε [symbol] ⁿ. More generally, by computing infinitesimal optimal actions individually, SAC process 100 does not need to solve the numerically challenging two-point boundary-value problems used to derive finite horizon optimal controls in indirect methods, nor does it need to discretize to solve the high dimensional nonlinear programming problems addressed by direct methods. Instead, SAC process 100 avoids iterative optimization and makes constrained optimal control calculation roughly as inexpensive as simulation. Thus measurement incorporation and feedback synthesis can occur at higher bandwidth. Because controls can be expressed as an analytical formula, the systems and method can be implemented in code. SAC process 100 can enable predictive optimal control methods to be applied on-line and in closed-loop for robotic systems where such methods would normally prove infeasible.

While the SAC process 100 gains significant computational advantages in planning actions individually rather than solving for optimal sequences of actions, single action planning normally results in greedy control policies that do not account for the effect of later action (the robot 104 can always take the best action at the current time). To address this, the SAC process 100 can include a decision variable not normally incorporated in alternative control schemes. The SAC process 100 provides the option to use optimization to choose when to act over each planning horizon (it chooses the time τₘε(t₀+t_{calc},t_{f}) to apply an action). Though SAC process 100 applies actions one after another in FIG. 1, examples below show the SAC process 100 can choose to wait and do nothing, saving control authority until an optimal time to act. As a result of this process, SAC process 100 takes advantage of free dynamics in underactuated control problems and develops energy conserving swing-up solutions in inversion problems (e.g., swing-up and inversion control examples below). The behavior is not typical of a greedy approach.

To demonstrate performance, the SAC process 100 can be used with four simulated benchmark examples, the cart-pendulum, the pendubot, the acrobot, and a minimum time parking problem for a linear system. For reference, results from the cart-pendulum system are compared to the optimal trajectories computed using an implementation of a sequential quadratic programming (SQP) algorithm. The SAC process 100 is able to bypass local minima that cause SQP to converge prematurely. Compared to open-loop trajectories produced by SQP, SAC computes high-bandwidth (feedback at 1,000 Hz) closed-loop trajectories with better final cost in significantly less time (e.g., milliseconds/seconds compared to hours). Moreover, compared to optimal controllers computed using methods like SQP, control synthesis does not rely on discretization of the state and control space; SAC calculations directly utilize continuous system dynamics. Hence, the SAC process 100 benefits from efficient, variable time-step integration and avoids difficulties involved in a-priori selection of appropriate discretization levels.

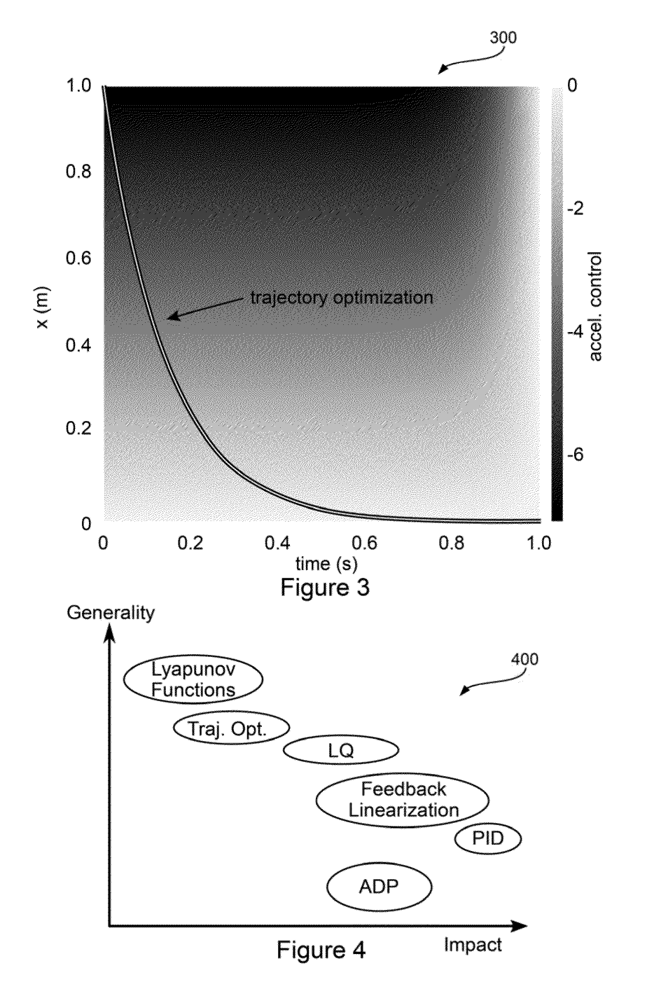

FIG. 3 is a graph of an example trajectory optimization 300. The control to drive a single integrator, \dot{x}=u, to the origin while minimizing a convex cost, J=∫₀¹∫₀¹ 50x(t)²+u²dt. Solutions to the HJB equations provide an optimal control at any state/time, while trajectory optimization is faster but (generally) yields the optimal control only along a single trajectory (along the black curve) from an initial condition. In both cases, solutions are only valid in regions where the system dynamics are approximated by those of the single integrator. In this special LQ case, obtain (from a Riccati equation) a feedback solution to trajectory optimization that solves the HJB equations and so provides the optimal control from any state (as in the figure).

To address the curse of dimensionality, trajectory optimization techniques narrow the scope of the optimization. Rather than searching globally for solutions from arbitrary positions in state space, trajectory optimization yields optimal control trajectories from a single, pre-determined initial condition (see the curve in FIG. 3). There are special cases (such as the LQ case) where trajectory optimization leads to closed-form optimal feedback laws that solve the HJB equations and provide the optimal control from any state. Trajectory optimization is generally performed numerically, by (iteratively) approximating nonlinear system dynamics about a nominal trajectory using time-varying linearizations. Derived control laws are therefore also only valid (approximately optimal) in local regions of the state space where the dynamics are well-approximated. Similarly, the process usually requires local approximations of trajectory objectives when anything but simple, quadratic objectives are applied. While it comes at the sacrifice of global optimality, the process of trajectory optimization is much faster and scales to systems with state dimension in the tens and possibly even hundreds.

Though solutions are local, trajectories from trajectory optimization can also be combined in global planning to develop global solutions through state space using sample-based methods. For instance, trajectory optimization can serve as a local planner, extending nodes in rapidly exploring random trees or connecting probabilistic roadmaps in constrained environments. Though methods exist that asymptotically converge to globally optimal solutions (based on probabilistic completeness arguments), in practice, sample-based planning provides a means to develop good (sub-optimal) trajectories through state-space at rates faster than direct dynamic programming alternatives. Note that these sample-based techniques are still far from real-time, especially for robots 104 with non-trivial dynamics operating in complex environments. As the systems and methods offer rapid generation of constrained trajectories for a variety of traditionally challenging robot models, one potential direction is as a local planner in dynamic sample-based motion planning.

In practice, there are several ways to perform trajectory optimization. These are broadly categorized into direct and indirect methods. In each case the overarching goal of trajectory optimization is to search for trajectories that minimize a tracking objective subject to differential motion constraints (along with other state or control constraints the robot obeys). Objectives are usually functions/functionals that depend on state and control trajectories and incorporate pseudo-norms on state errors and a norm on control effort. Direct methods rely on discretization and transcribe the optimization problem into an algebraically constrained nonlinear programming problem that may be subject to tens of thousands of variables and constraints. Popular software packages such as Sparse Nonlinear Optimizer (SNOPT) (based on the sequential quadratic programming (SQP) algorithm) solve these problems to return discretized optimal control sequences. Although they require discretization of states and/or controls, which can be difficult to choose a-priori and may significantly affect optimization performance, direct methods for optimal control have become particularly popular (especially collocation methods) as they easily extend to incorporate control and state constraints during optimization.

In contrast, indirect methods for trajectory optimization apply optimality principles (from PMP or the HJB equations) to the trajectory optimization problem, leading to a two-point boundary-value problem (TPBVP) for both free and fixed endpoint control problems. Indirect methods solve the TPBVP to obtain the optimal control. However, these problems are particularly challenging to solve numerically. In spite of the significantly reduced optimization dimension, the TPBVP may actually be harder to solve than the nonlinear programming problem in direct methods. In certain conditions, such as for the LQ problem where robot dynamics are linear (linearized) time-varying and the cost is quadratic, the TPBVP can be translated to matrix of Riccati differential equations with single endpoint constraints. Solutions to the Riccati equation can be obtained by integration and thus avoid the numerical issues in solving the TPBVP directly. In these cases, indirect methods offer an alternative to direct optimization that can utilize computationally efficient variable time-step integration and avoid a-priori discretization (both in state and control spaces as well as temporally). As one primary drawback, it is much more difficult to incorporate state and especially control constraints when using an indirect method (again, in the special case of the LQ problem and at the cost of a-priori discretization, constrained numerical optimization can be relatively efficient).

Many nonlinear trajectory optimization routines take advantage of LQ problem in optimization because it permits computationally efficient solutions with guarantees of existence and uniqueness. These nonlinear optimization methods leverage the fact that the LQ problem is convex and so LQ trajectory optimization yields a single, globally optimal analytical feedback solution that does not require iteration. In contrast, nonlinear system dynamics generally result in non-convex trajectory optimization problems that require computationally intensive, constrained iterative optimization. In what can be considered a generalization of SQP to function spaces, many nonlinear trajectory optimization methods follow an iterative process in which they quadratize cost and linearize dynamical constraints, solve the approximating LQ problem to update the current optimal control solution, and then repeat until convergence. However, because the underlying optimization problem is non-convex, optimal control laws resulting from nonlinear trajectory optimization problems are only locally optimal with respect to both initial conditions and trajectory objective. Because of local minima, nonlinear trajectory optimization methods tend to be highly sensitive to the initial guess/nominal trajectory “seed” about which the system trajectory is initially approximated. As such, optimization may yield poor solutions unless initialized with a high-quality seed trajectory.

Similarly, linear receding horizon control, also known as model predictive control (MPC), takes advantage of the structure of LQ problems and develops optimization-based closed-loop control solutions by stringing together LQ solutions computed over receding time horizons. The method has become ubiquitous in industry and process control applications since the 1980s and represents one of the major success stories for optimal control.

Referring to FIG. 2 (for simplicity assume the time required for control calculations is negligible, t_{calc}=0), MPC computes optimal control curves extending for a horizon, [t₀,t_{f}], from the current time, t_{curr} [symbol] t₀. Because the trajectory optimization problem is an LQ problem, the solutions are obtained efficiently from the analytically optimal control expression. After applying the control for a short sampling duration, iₛ (often a single time step in discrete time implementation), MPC incorporates state feedback and updates the current time and horizon. At this point the process repeats and MPC computes the next optimal LQ control solution. While the MPC process is highly effective, combining finite horizon optimal trajectories to explore larger areas of the state space, it is intended for linear systems with quadratic cost.

Nonlinear variants of model predictive control (NMPC) attempt to extend the MPC process to develop optimization-based solutions that take advantage of more complicated system dynamics and more general objectives. However, the trajectory optimization problem that NMPC solves at each horizon is non-convex and so no longer permits the simple analytical LQ solution, e.g., linear quadratic Gaussian (LQG) problems. Instead, NMPC computes a feedforward optimal control solution over each finite horizon using the iterative optimization techniques previously described. These solutions are followed in open-loop until the next sampling time, when the algorithm incorporates state feedback and repeats the process. Due to the sequence of non-covex, iterative constrained optimization problems, NMPC is computationally intensive and limited to lower bandwidth applications. The additional local minima in these non-convex problems also present issues that can cause NMPC controllers to converge to undesirable local solutions.

Instead of planning controls over a finite horizon, SAC process 100 (e.g., in FIGS. 1-2) can search for infinitesimal control actions to which the tracking objective is maximally sensitive. As such, open-loop optimal controls in SAC process 100 are switching controls that the algorithm sequences in moving horizon fashion. Each switches from an assumed nominal control mode, u₁ (typically specified as 0), to applying the optimal alternative control action with value u₂*(tₘ), and then switches back to u₁. However, traditional switching time/mode scheduling optimizations can suffer the same drawback as NMPC in that planning with finite switching intervals requires constrained iterative optimizations subject to local minima. In contrast, SAC process 100 assumes infinitesimal durations, λ→0⁺, to solve for optimal control actions without dynamic constraints. This is even true when considering min/max input constraints. The process provides a closed-form expression for the optimal action as a continuous function of time over each prediction horizon. These solutions, u₂*(t)∀tε[t₀,t_{f}], are schedules of the constant valued infinitesimal optimal action that should be applied at any application time selected in the current prediction horizon. Although SAC process 100 I can be somewhat myopic in that it plans actions individually, these closed-form control schedules allow SAC to use optimization to choose an optimal time to act over each planning horizon. In measuring the utility of potential future action and in-action, SAC process 100 can avoid greedy control policies and gains computational advantage.

Because it linearizes nonlinear dynamics about nominal trajectories (resulting from u₁), SAC process 100 is local relative to a nominal trajectory. However, SAC process 100 actions globally optimize convex control objectives over each finite horizon and so are not subject to the local minima generated by the series of non-convex finite horizon optimizations in NMPC. That is, the process of searching for actions that optimally improve, rather than directly minimize the current finite horizon tracking objective results in analytical control actions that minimize a convex control objective similarly to the case of linear MPC and the LQ problem in optimal control. The closed-form SAC control actions exist and are unique for a wide variety of different tracking costs, even those that are non-convex or unbounded (e.g., SAC process 100 can compute solutions that continually reduce a linear state tracking objective with no finite minimum). Therefore, SAC actions are efficient to compute and, though they are planned for short duration application, provide long time horizon trajectory improvements. SAC sequencing controls at high frequency can avoid local minima that affect nonlinear trajectory optimization.

To determine actions that optimize the rate of descent of a trajectory tracking cost functional relative to their application duration, the SAC process 100 minimizes an objective function that includes an L₂ norm on the mode insertion gradient. This tool from hybrid systems theory measures the first-order sensitivity of a cost function to an infinitesimal duration switch in dynamics. The mode insertion gradient is applied in mode scheduling problems to determine the optimal switching sequence of continuously differentiable dynamic modes, assuming the modes are known a-priori. In comparison, the SAC process 100 assumes the switching sequence previously described (e.g., switching from nominal control to optimal action and back). The mode insertion gradient can be used to determine both the optimal value of the alternate control mode (the value of the optimal action, u₂*(τₘ)), and a best time to switch. Additionally, derivations described below can extend the mode insertion gradient to hybrid impulsive systems with resets.

FIG. 4 is a graph of an example comparison 400 of control methods in terms of potential impact and generality. An algorithm with high potential impact is determined as one that is easy to implement and understand. An algorithm that is highly general is one that applies to large state dimension systems as well as systems with different types of dynamics and objectives, e.g., one that applies to large state dimension systems, accommodates different types of dynamics, objectives, and constraints.

PID is ranked highest in impact. The generality scale ranks algorithms based on how broadly they apply. In this category, PID is relatively low in rank as it does not (easily) apply to different objectives and constraints, underactuated control problems, etc. Feedback linearization methods are also relatively straightforward to implement but are limited in system type and do not satisfy control constraints. Lyapunov based controllers are very general in theory but are often difficult to derive. Sums-of-Squares methods provide ways to automatically generate Lyapunov functions but limit the types of systems and constraints that can be considered (they apply to systems that are representable as sums of squares polynomials). The ADP algorithm is (relatively) easy to understand and powerful, but limited to low-dimensional systems. Finally, LQ methods are special cases of trajectory optimization that are less general but easier to understand and apply.

Although it is difficult, and potentially impossible, to provide a thorough and fair comparison since SAC process 100 is new, a SAC-based algorithm is most likely in the vicinity of trajectory optimization and LQ methods in terms of generality and potential impact. While there can be systems where standard trajectory optimization methods outperform SAC process 100 and vice versa, in terms of generality, SAC is usually faster and better scales to high dimensional systems (both methods can develop constrained solutions). Additionally, trajectory optimization does not easily extend to non-smooth hybrid and impacting systems, while SAC process 100 can often control these systems without any modification (see the SLIP example below). The SAC process 100 is also similar to LQ in that it is relatively easy to implement since control actions are based on a closed-form expression. However, as mentioned, these rankings can be subjective.

Referring also to FIG. 1, a cyclic control synthesis process of SAC process 100 is determined for a broad class of differentiable nonlinear systems of control-affine form.

A closed-form expression is determined for a curve (or schedule) of infinitesimal open-loop optimal control actions that SAC process 100 can take at any point in time over the current (receding) horizon. Then, SAC process 100 determines a value of the next action to apply by searching the curve of infinitesimal optimal actions for application times that maximize the expected impact of control action. The value of the infinitesimal optimal action at the selected application time specifies the value of the next control action. To specify the action Section 2 describes the process SAC process 100 uses to compute application durations for each action that result in improved trajectory tracking performance. Table 1 includes notation used throughout.

| Symbol | Description |
|---|---|
| D₂f (x, u) | $partial derivative \frac{\partial f ( \cdot , \cdot )}{\partial u}$ |
| Dₓf (·) | $partial derivative \frac{\partial f ( \cdot )}{\partial x}$ |
| ∥·∥_{M} | norm where M provides the metric |
| | (e.g., ∥ x(t) ∥_{Q}² = x(t)^{T} Q x(t) ) |
| R^{-T} | equivalent to (R^{T})⁻¹ |
| R > 0 | indicates R is positive definite (≧ for semi-definite) |

Analytical Solution for Infinitesimal Optimal Actions

This section presents a process and method to compute the schedule of infinitesimal optimal actions associated with the current horizon T=[t₀,t_{f}]. When applied around any chosen time, τₘε[t₀+t_{calc},t_{f}], each action can improve system performance relative to control effort over the horizon. Calculations result in a closed-form expression for this optimal action schedule even for systems with dynamics,

\dot{x}(t)=f(t,x(t),u(t),u(t))∀t, (1)
nonlinear in state x: [symbol] ^{n×1}. Though these methods apply more broadly, the expression for the optimal action schedule is derived for the case where (1) is linear with respect to the control, u: [symbol] ^{m×1}. Dynamics therefore satisfy control-affine form,

f(t,x(t),u(t))=g(t,x(t))+h(t,x(t))u(t)∀t. (2)

The cost functional,

J₁=∫ₜ_{₀}^{t}^{_{f}}l₁(t,x(t))dt+m(x(t_{f})), (3)
measures trajectory tracking performance to gauge the improvement provided by optimal actions. Though not required, (3) is non-negative if it is to provide a performance measure in the formal sense. For brevity, the time dependence in (1), (2), and (3) is dropped so f(t,x(t),u(t)) [symbol] f(x(t),u(t)), g(t,x(t)) [symbol] g(x(t)), h(t,x(t)) [symbol] h(x(t)), and l₁(t,x(t)) [symbol] l₁(x(t)). The following definitions and assumptions clarify the types of systems and cost functionals addressed.

Piecewise continuous functions are referred to as \tilde{C}⁰. These are C⁰ functions that may contain a set of discontinuities of Lebesgue measure zero, where the one-sided limits exist in a local neighborhood on each side. At discontinuities, \tilde{C}⁰ functions are determined according to one of their side limits.

Though actions are determined by a triplet consisting of a value, duration, and application time (determined above), for the sake of brevity, this refers to actions according to their value and will disambiguate by specifying the application time and duration as required. As such, [symbol] ₂ [symbol] {u₂*(τ_{m,i})|iε{1, . . . , c}, cε [symbol] } represents the set of optimal actions applied by SAC process 100. The set of application intervals associated with each action is determined as

$$Π {=}^{Δ} \{ [ {τ}_{m , i} - \frac{{λ}_{i}}{2} , {τ}_{m , i} + \frac{{λ}_{i}}{2} ] \vert i ∈ \{ 1 , … , c \} \} ,$$

where τ_{m,i} represents an action's application time and λᵢ is its duration.

Assumption 1: The elements of dynamics vector (1) are real, bounded, C¹ in x, and C⁰ in t and u. Generally, the dynamics can be \tilde{C}⁰ in t if application times τ_{m,i} exclude these points of discontinuity.

Assumption 2: The terminal cost, m(x(t_{f})), is real and differentiable with respect to x(t_{f}). Incremental cost l₁(x) is real, Lebesgue integrable, and C¹ in x and u.

Assumption 3: SAC control signals, u, are real, bounded, and \tilde{C}⁰ such that

$$u ( t ) = \{ \begin{matrix}{u}_{1} ( t ) & : t ∉ Π \\ {u}_{2}^{*} ( {τ}_{m , i} ) & : t ∈ Π\end{matrix} ,$$

with nominal control, u₁, that is C⁰ in t. The nominal control can be \tilde{C}⁰ in t if application times τ_{m,i} exclude points of discontinuity in u₁(t).

Assumption 1 includes dynamics that are continuous with respect to each individual argument, (t, x, u), while the others are fixed. However, u generates discontinuities in (1) when it switches (e.g., determined as a function of time, f(t)∀tε[t₀,t_{f}], the dynamics are \tilde{C}⁰). Hence, the dynamics are modeled by the switched system,

$$f ( t ) {=}^{Δ} \{ \begin{matrix}f ( x ( t ) , {u}_{1} ( t ) ) & : t ∉ Π \\ f ( x ( t ) , {u}_{2}^{*} ( {τ}_{m , i} ) ) & : t ∈ Π\end{matrix} .$$

SAC process 100 computes each optimal action u₂*(τ_{m,i})∀iε{1, . . . , c} on-line and in sequence using feedback to re-initialize the current state and time (xᵢₙᵢₜ,t₀). Each action is associated with a separate “moving” optimization horizon [t₀,t_{f}=t₀+T]. Planning individual actions is open-loop in that each action is designed to meet stated objectives (minimize control effort while providing a specified improvement in cost (3) over [t₀,t_{f}]) without considering the effect of later actions. When sequenced in closed-loop, actions are often applied consecutively as in FIG. 2. Hence, the nominal control may never actually be applied. Thus the planning process assumes the system switches from a (default) nominal mode,

f₁(t) [symbol] f(x(t),u₁(t)),
to the mode associated with the optimal action,

f₂(t,σ_{m,i}) [symbol] f(x(t),u₂(τ_{m,i}),
and then back to f₁ over the course of each horizon [t₀,t_{f}].

Consider the case where the system evolves according to nominal control dynamics f₁, and optimal action u₂*(τ_{m,i}) is applied (dynamics switch to f₂) for an infinitesimal duration before switching back to nominal control. This is the condition depicted by the curve 202 in FIG. 2 where nominal control u₁=0. In this case, the mode insertion gradient,

$$\frac{d {J}_{1}}{d {λ}_{i}^{+}} = {ρ ( s )}^{T} ( {f}_{2} ( s , s ) - {f}_{1} ( s ) ) ∀ s ∈ [ {t}_{0} , {t}_{f} ] , \qquad ( 4 )$$

evaluated at s=τ_{m,i} measures the first-order sensitivity of cost function (3) to infinitesimal application of f₂, which provide a more general derivation that extends (4) to hybrid impulsive dynamical systems with resets). The state in both dynamics f₁ and f₂ in the mode insertion gradient is determined only in terms of the nominal control, x(s) [symbol] x(s,u₁(s))∀sε[t₀,t_{f}]. The term, ρ: [symbol] ^{n×1}, is the adjoint (co-state) variable calculated from the nominal system trajectory according to,

\dot{ρ}=−Dₓl₁(x)^{T}−Dₓf(x,u₁)^{T}ρ, (5)
such that at the final time ρ(t_{f})=∇m(x(t_{f})). As opposed to traditional fixed-horizon optimal control methods, this adjoint is easily computed because it does not depend on the closed-loop, optimal state, x*(t,u₂*(τ_{m,i})). The control duration is evaluated infinitesimally, as λᵢ→0⁺.

While infinitesimal optimal actions cannot change the state or tracking cost, the cost (3) is sensitive to their application. The mode insertion gradient (4) indicates this sensitivity at any potential application time, sε[t₀,t_{f}]. To specify a desired sensitivity, a control objective selects infinitesimal optimal actions that drive (4) to a desired negative value, α_{d}ε [symbol] ⁻. At any potential application time sε[t₀,t_{f}], the infinitesimal optimal action that minimizes,

$$\begin{matrix}{l}_{2} ( s ) {=}^{Δ} {l}_{2} ( x ( s ) , {u}_{1} ( s ) , {u}_{2} ( s ) , ρ ( s ) ) \\ = {\frac{1}{2} [ \frac{d {J}_{1}}{d {λ}_{i}^{+}} - {α}_{d} ]}^{2} + \frac{1}{2} {‖ {u}_{2} ( s ) ‖}_{R}^{2} \\ = {\frac{1}{2} [ {ρ ( s )}^{T} ( {f}_{2} ( s , s ) - {f}_{1} ( s ) ) - {α}_{d} ]}^{2} + \frac{1}{2} {‖ {u}_{2} ( s ) ‖}_{R}^{2} ,\end{matrix} \qquad ( 6 )$$

minimizes control authority in achieving the desired sensitivity. The first expression highlights that the objective corresponds to actions at a specific time. The matrix R=R^{T}>0 provides a metric on control effort. Because the space of positive semi-definite/definite cones is convex is convex with respect to infinitesimal actions u₂(s).

To minimize (6) and return the infinitesimal optimal action at any potential application time sε[t₀,t_{f}] the mode insertion gradient exists at that time. This includes continuity (in time) of ρ, f₁, f₂, and u₁ in a neighborhood of s. While Assumptions 1-3 ensure continuity is met, the assumptions may be overly restrictive. Generally, Assumptions 1 and 3 can be relaxed to permit dynamics and nominal controls that are \tilde{C}⁰ in time if points of discontinuity are excluded from the set of potential application times, or if the mode insertion gradient is determined using one-sided limits at discontinuities. Below discusses the case where system dynamics are non-smooth with respect to state (e.g., the case of hybrid impulsive systems with resets). As this is only an issue at isolated points (a set of Lebesgue measure zero), this chapter uses the slightly more restrictive assumptions and ignores these special cases.

With Assumptions 1-3, the mode insertion gradient exists, is bounded, and (6) can be minimized with respect to u₂ (s)∀sε[t₀,t_{f}]. The following theorem performs this minimization to compute the schedule of infinitesimal optimal actions.

Theorem 1: Determine Λ [symbol] h(x)^{T}ρρ^{T}h(x). The schedule of infinitesimal optimal actions,

$${u}_{2}^{*} ( t ) {=}^{Δ} arg {min}_{{u}_{2} ( t )} {l}_{2} ( t ) ∀ t ∈ [ {t}_{0} , {t}_{f} ] , \qquad ( 7 )$$

to which cost (3) is optimally sensitive at any time is

u₂*=(Λ+R^{T})⁻¹[Λu₁+h(x)^{T}ρα_{d}] (8)

Proof. Evaluated at any time tε[t₀,t_{f}], the schedule of infinitesimal optimal actions, u₂*, provides an infinitesimal optimal action that minimizes (6) at that time. The schedule therefore also minimizes the (infinite) sum of costs (6) associated with the infinitesimal optimal action at every time ∀tε[t₀,t_{f}]. Hence, (7) can be obtained by minimizing

J₂=fₜ_{₀}^{t}^{_{f}}l₂(x(t),u₁(t),u₂(t),ρ(t))dt. (9)

Because the sum of convex functions is convex, and x in (4) is determined only in terms of u₁, minimizing (9) with respect to u₂(t) ∀tε[t₀,t_{f}] is convex and unconstrained. It is sufficient for (global) optimality to find the u₂* for which the first variation of (9) is 0∀δu₂*εC⁰. Using the Gâteaux derivative and the definition of the functional derivative,

$$\begin{matrix}δ {J}_{2} = {\int }_{{t}_{0}}^{{t}_{f}} \frac{δ {J}_{2}}{δ {u}_{2}^{*} ( t )} δ {u}_{2}^{*} ( t ) d t \\ = \frac{d}{d ɛ} {\int }_{{t}_{0}}^{{t}_{f}} {l}_{2} ( x ( t ) , {u}_{1} ( t ) , {u}_{2}^{*} ( t ) + ɛη ( t ) , ρ ( t ) ) d t {\vert}_{ɛ = 0} \\ = {\int }_{{t}_{0}}^{{t}_{f}} \frac{d}{d ɛ} {l}_{2} ( x ( t ) , {u}_{1} ( t ) , {u}_{2}^{*} ( t ) + ɛη ( t ) , ρ ( t ) ) {\vert}_{ɛ = 0} d t \\ = {\int }_{{t}_{0}}^{{t}_{f}} \frac{\partial {l}_{2} ( x ( t ) , {u}_{1} ( t ) , {u}_{2}^{*} ( t ) , ρ ( t ) )}{\partial {u}_{2} ( t )} η ( t ) d t \\ = 0 ,\end{matrix} \qquad ( 10 )$$

where ε is a scalar and εη=δu₂*.

The final equivalence in (10) holds ∀η. A generalization of the Fundamental Lemma of Variational Calculus, implies

$$\frac{\partial {l}_{2} ( \cdot )}{\partial {u}_{2}} = 0$$

at the optimizer. The resulting expression,

$$\begin{matrix}{( \frac{\partial {l}_{2} ( \cdot )}{\partial {u}_{2}} )}^{T} = {( ( {ρ}^{T} h ( x ) [ {u}_{2}^{*} - {u}_{1} ] - {α}_{d} ) {ρ}^{T} h ( x ) + {u}_{2}^{* T} R )}^{T} \\ = {h ( x )}^{T} ρ ( {ρ}^{T} h ( x ) [ {u}_{2}^{*} - {u}_{1} ] - {α}_{d} ) + {R}^{T} {u}_{2}^{*} \\ = [ {h ( x )}^{T} {ρρ}^{T} h ( x ) ] {u}_{2}^{*} + {R}^{T} {u}_{2}^{*} - \\ [ {h ( x )}^{T} {ρρ}^{T} h ( x ) ] {u}_{1} - {h ( x )}^{T} {ρα}_{d} \\ = 0 ,\end{matrix} \qquad ( 11 )$$

can therefore be solved in terms of u₂* to find the schedule that minimizes (6) at any time. Algebraic manipulation confirms this optimal schedule is (8).

To provide intuition regarding the properties of these solutions, the following proposition proves that the optimization posed to derive control actions (8) is equivalent to a well-studied class of Tikhonov regularization problems.

Proposition 1: Assume u, u₂, ρ, hε [symbol] where [symbol] is an infinite dimensional reproducing kernel Hilbert function space (RKHS). Practically, this is not a very stringent requirement. Most spaces of interest are RKHS. With change of variables, z=u₂ z₀=u₁, Γ=ρ^{T}h(x), and b=α_{d}, minimization of (9) satisfies the structure of generalized continuous-time linear Tikhonov regularization problem. Norm ∥•∥ refers to the L₂ norm and [symbol] is assumed to be an L₂ space.

$${min}_{z} {‖ {Γ}_{z} - b ‖}^{2} + {κ}^{2} {‖ L ( z - {z}_{0} ) ‖}^{2} , \qquad ( 12 )$$

and (8) has the structure of associated solution

z*=(Γ^{T}Γ+κ²L^{T}L)⁻¹(Γ^{T}b+κ²Lz₀). (13)

Proof. Using the control-affine form of dynamics f₁ and f₂, (9) can be stated as

$${J}_{2} = \frac{1}{2} {\int }_{{t}_{0}}^{{t}_{f}} {[ {ρ ( t )}^{T} h ( x ( t ) ) ( {u}_{2} ( t ) - {u}_{1} ( t ) ) - {α}_{d} ]}^{2} + {‖ {u}_{2} ( t ) ‖}_{R}^{2} d t .$$

Performing the change in variables yields

$${J}_{2} = \frac{1}{2} {\int }_{{t}_{0}}^{{t}_{f}} {[ Γ ( t ) z ( t ) - b ]}^{2} d t + \frac{1}{2} {\int }_{{t}_{0}}^{{t}_{f}} {‖ z ( t ) - {z}_{0} ( t ) ‖}_{R}^{2} d t .$$

Because R=R^{T}>0, it can be Cholesky factorized as R=M^{T}M. Pulling out a scaling factor, κ², yields R=M^{T}M=κ²(L^{T}L). Applying this factorization results in

$${J}_{2} = \frac{1}{2} {‖ {Γ}_{z} - b ‖}^{2} + \frac{1}{2} {‖ κ L ( z - {z}_{0} ) ‖}^{2} .$$

Minimization of (9) is thus equivalent to (12) up to a constant factor of ½ that can be dropped as it does not affect z*.

Additionally, equivalence of solutions (8) and (13) can be proved directly. With the specified change of variables, u₂* can be written as z*−z₀ and (8) as

z*−z₀=(Γ^{T}Γ+κ²L^{T}L)⁻¹(−Γ^{T}Γz₀+Γ^{T}b).

Algebraic manipulation verifies this is equal to Tikhonov regularization solution (13).

As the following corollary indicates, because minimization of (9) can be posed as a Tikhonov regularization problem, solutions (8) inherit useful properties.

Corollary 1: With the assumptions stated in Proposition 1, solutions (8) for minimization of (9) exist and are unique.

Proof. The proof follows from Proposition 1, which shows the minimization can be formulated as a Tikhonov regularization problem with convex L₂ error norm,

∥Γz−b∥. These problems have solutions that exist and are unique.

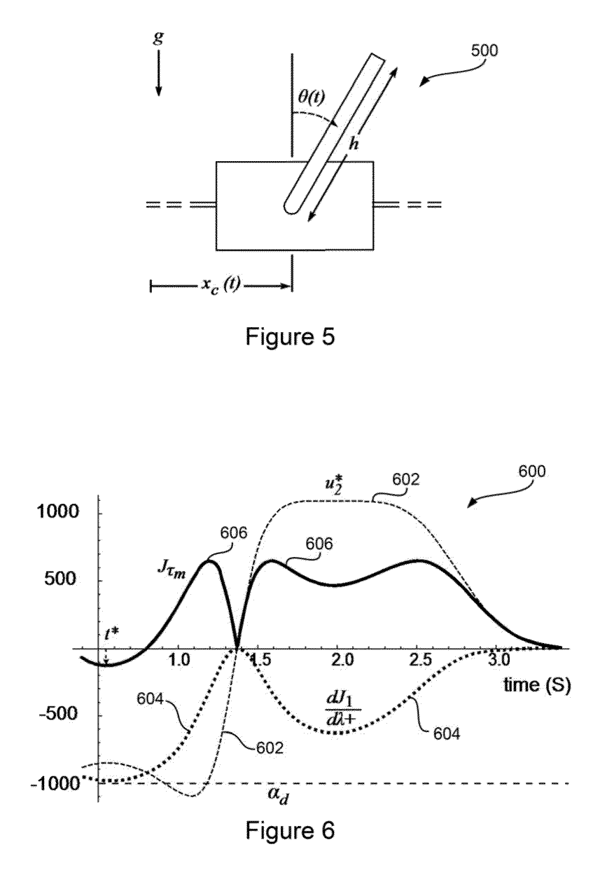

FIG. 5 is a block diagram of example configuration variables for a cart-pendulum 500 system, e.g., for determining the time for control application.

Theorem 1 provides a schedule of infinitesimal optimal control actions that minimize control authority while tracking a desired sensitivity, α_{d}, in cost (3) at any application time τ_{m,i}ε[t₀,t_{f}]. By continually computing and applying optimal actions u₂*(t_{m,i}) immediately (at t₀+t_{calc}), SAC process 100 can approximate a continuous response. However, it is not always desirable to act at the beginning of each horizon. It can make sense to wait for a system's free dynamics to carry it to state where a control action will have increased effect.

Consider a simple model of the cart-pendulum 500 where the state vector consists of the angular position and velocity of the pendulum and the position and lateral velocity of the cart, x=(θ, \dot{θ}, x_{c}, \dot{x}_{c}). With the cart under acceleration control, u=(a_{c}), the underactuated system dynamics are modeled as

$$f ( x , u ) = ( \begin{matrix}\dot{θ} \\ \frac{g}{h} sin ( θ ) + \frac{{a}_{c} cos ( θ )}{h} \\ {\dot{x}}_{c} \\ {a}_{c}\end{matrix} ) . \qquad ( 14 )$$

The constant h represents the pendulum length, specified as 2 m, and g is the gravitational constant. Any time the pendulum is horizontal

$$( e . g . , θ ( t ) = \frac{π}{2} rad ) ,$$

no action is capable of pushing θ toward the origin to invert the pendulum. Only by waiting for the free dynamics to carry the pendulum past this singularity will control prove useful in helping it swing up.

To find the most effective time t_{m,i}ε[t₀+t_{calc},t_{f}] to apply a control action from u₂*, SAC process 100 searches for application times that optimize an objective function,

$${J}_{{τ}_{m}} ( t ) = ‖ {u}_{2}^{*} ( t ) ‖ + \frac{d {J}_{1}}{d {λ}_{i}^{+}} {\vert}_{t} + {( t - {t}_{0} )}^{β} , \qquad ( 15 )$$

determining the trade-off between control efficiency and the cost of waiting. Implementation examples apply β=1.6 as a balance between time and control effort in achieving tracking tasks, but any choice of β>0 works. This nonlinear and potentially non-convex choice of objective selects application times near the current time that drive the mode insertion gradient most negative relative to control magnitude.

FIG. 6 is a graph 600 of an example schedule of optimal actions, u₂*, computed for the system (14) starting at t₀=0.4 s into an example closed-loop SAC trajectory. The schedule of optimal actions, u₂*, is depicted (curve 602) for a T=3 s predicted trajectory of the cart-pendulum system (14) starting at current time t₀=0.4 s. These actions minimize acceleration in driving the mode insertion gradient toward α_{d}=−1,000. The mode insertion gradient curve 604 approximates the change in cost (3) achievable by short application of u₂* (t) at different points in time. An objective, J_{τ}_{ₘ}, (curve 606) is minimized to find an optimal time, t*, to act. Waiting to act at τ_{m,i}=t* rather than at τ_{m,i}=t₀, SAC process 100 generates greater cost reduction using less effort. Actions in u₂* are designed to drive the mode insertion gradient (curve 604), which is proportional to the achievable change in (3), toward α_{d}=1,000 if switched to at any time. At t≈1.39 s the pendulum passes through the horizontal singularity and control becomes ineffective as indicated by the mode insertion gradient going to 0. The mode insertion gradient also goes to 0 toward the end of the trajectory as no finite control action can improve cost (3) if applied at the end of the time horizon. As the curve of J_{τ}_{ₙ}, vs time (curve 606) indicates, to optimize the trade-off between wait time and effectiveness of the action, the system can do nothing and drift until optimal, as determined by (15), time t*≈0.57 s.

Computing the Control Duration

Temporal continuity of ρ, f₁, f₂ and u₁ provided by Assumption 1-3 ensures the mode insertion gradient (sensitivity of the tracking cost) is continuous with respect to duration around where λᵢ→0⁺∀τ_{m,i}ε[t₀,t_{f}]. Therefore, there exists an open, non-zero neighborhood, Vᵢ= [symbol] (λᵢ0⁺), where the sensitivity indicated by (4) models the change in cost relative to application duration to first-order and the generalized derivation below. For finite durations λᵢεVᵢ the change in tracking cost (3) is locally modeled as

$$Δ {J}_{1} \approx \frac{d {J}_{1}}{d {λ}_{i}^{+}} {\vert}_{s = {τ}_{m , i}} {λ}_{i} . \qquad ( 16 )$$

As u₂*(τ_{m,i}) regulates

$$\frac{d {J}_{1}}{d {λ}_{i}^{+}} \approx {α}_{d} ,$$

(16) becomes ΔJ₁≈α_{d}λᵢ. Thus the choice of λᵢ and α_{d} allows the control designer to specify the desired degree of change provided by actions u₂*(τ_{n,i}). Also note that for a given

$$\frac{d {J}_{1}}{d {λ}_{i}^{+}}$$

and any choice of λᵢ, (16) can be applied to test if λᵢεVᵢ or that it at least provides a ΔJ₁ that is known to be achievable for λᵢεVᵢ.

Though the neighborhood where (16) provides a reasonable approximation varies depending on system, in practice it is straightforward to select a λᵢεVᵢ. The easiest approach is to select a single conservative estimate, λ. This is analogous to choosing a fixed time step in finite differencing of Euler integration. However, to avoid a-priori selection of a λεV and conservative (unnecessarily short) durations, SAC process 100 uses a line search with a descent condition to select a λᵢεVᵢ or one that provides a minimum acceptable change in cost (3). The line search iteratively reduces the duration from an initial value. By continuity, the process is guaranteed to find a duration that produces a change in cost within tolerance of that predicted from (16). In implementations, an iteration limit bounds the algorithm in time, even though it is usually possible to choose initial durations that do not require iteration.

Because the pair (α_{d},λᵢ) determines the change in cost each action can provide, it is worth noting that a sufficient decrease condition can be applied during the line search. In addition, stability can be provided by determining this condition to guarantee that each control provides sufficient improvement for convergence to an optimizer.

SAC: Local Stability and Input Constraints

In spite of the fact that SAC process 100 controls are hybrid in nature, near equilbria the analytical solution for optimal control actions facilitates straightforward stability analysis. In particular, under mild assumptions the formula for SAC control actions reduces to a simple linear feedback regulator that can be computed a-priori. As discussed below, by applying these actions as a continuous feedback response, local stability can be guaranteed using linear analysis methods from continuous control theory. A special case is where SAC actions become LQ regulators. Following these stability results, efficient means can be used to incorporate min/max constraints on SAC controls that avoid numerical constrained optimization. In addition to control constraints, SAC process 100 can accommodate unilateral constraints, automated constraint handling can be demonstrated based on forced Euler Lagrange equations.

Local Stability Results

Globally, optimal control actions (8) inherit properties of Tikhonov regularization solutions. However, the following corollary shows that near equilibrium points, solutions (8) simplify to linear state feedback laws. This linear form permits local stability analysis based on continuous systems techniques.

Corollary 2: Assume system (2) contains equilibrium point x=0, the state tracking cost (3) is quadratic,

$${J}_{1} = \frac{1}{2} {\int }_{{t}_{0}}^{{t}_{f}} {‖ x ( t ) - {x}_{d} ( t ) ‖}_{Q}^{2} d t + \frac{1}{2} {‖ x ( {t}_{f} ) - {x}_{d} ( {t}_{f} ) ‖}_{{P}_{1}}^{2} , \qquad ( 17 )$$

with x_{d}=x_{d}(t_{f})=0, Q=Q^{T}≧0, and P₁=P₁^{T}≧0 defining measures on state error, and u₁=0. Quadratic cost (17) is assumed so that resulting equations emphasize the local similarity between SAC controls and LQR. There exists neighborhoods around the equilibrium, [symbol] (0), and final time, [symbol] (t_{f}), where optimal actions (8) are equivalent to linear feedback regulators,

u₂*(t)=R⁻¹h(0)^{T}P(t)x(t)α_{d}∀tε [symbol] (t_{f}). (18)

Proof. At final time, ρ(t_{f})=P₁x(t_{f}). Due to continuity Assumptions 1-2, this linear relationship between the state and adjoint exists for a nonzero neighborhood of the final time, [symbol] (t_{f}), such that

ρ(t)=P(t)x(t)∀tε [symbol] (t_{f}). (19)

Applying this relationship, (8) can formulated as

u₂*=(h(x)^{T}Pxx^{T}P^{T}h(x)+R^{T})⁻¹

[h(x)^{T}Pxx^{T}P^{T}h(x)u₁+h(x)^{T}Pxα_{d}].

This expression contains terms quadratic in x. For xε [symbol] (0), these quadratic terms go to zero faster than the linear terms, and controls converge to (18).

By continuity Assumption 1 and for xε [symbol] (0), the dynamics (1) can be approximated as an LTI system, \dot{x}=A x+B u, (where A and B are linearizations about the equilibrium). Applying this assumption and differentiating (19) produces

$$\begin{matrix}\dot{ρ} = \dot{P} x + P \dot{x} \\ = \dot{P} x + P ( Ax + {Bu}_{1} ) .\end{matrix}$$

Inserting relation (5) yields

−Dₓl₁(x)^{T}−A^{T}Px=\dot{P}x+P(Ax+Bu₁),
which can be re-arranged such that

0=(Q+\dot{P}+A^{T}P+PA)x+PBu₁.

When the nominal control u₁=0, this reduces to

0=Q+A^{T}P+PA+\dot{P}. (20)

Note the similarity to a Lyapunov equation. As mentioned, this relationship exists for a nonzero neighborhood, [symbol] (t_{f}). Therefore, there exists neighborhoods [symbol] (t_{f}) and [symbol] (0) in which schedule (8) simplifies to a time-varying schedule of linear feedback regulators (18), where P(t) can be computed from (20) subject to P(t_{f})=P₁. Note the h(0)^{T} term in (18) is equal to B^{T}. The term shows up because the system is assumed to be in a neighborhood where the dynamics can be linearly modeled.

For the assumptions in Corollary 2, actions (18) are linear time-varying state feedback laws near equilibrium. Although the corollary is derived in a neighborhood of the final time, [symbol] (t_{f}), it is worth noting that because (20) is linear in P, the equation cannot exhibit finite escape time. Through a global version of the Picard-Lindelöf theorem, the relation (20) can be verified (and therefore (18)) exists and is unique for arbitrary horizons and not just around t_{f}. As such, predetermine the linear feedback law (18) by simulating (20) backwards in time. Assuming SAC process 100 is specified with a fixed horizon length, T, and designed to apply actions at the (receding) initial time, t=t₀, the value of P(t=t₀) is fixed (it is independent of trajectory and absolute time at which controls are applied). Under these conditions, (18) yields a constant feedback law, u₂*(t)=−K x(t), where K depends on the system's linearizations, weight matrices, Q, R, and P₁, the time horizon, T, and the α_{d} term. While it is challenging to develop general stability proofs for switched systems, if (near equilibrium) SAC process 100 switches to continuous application of control based on this determined feedback law, local stability can be assessed using continuous systems methods.

In particular, example calculations above demonstrate how designers can analyze local stability based on the eigenvalues of a closed-loop (LTI) system resulting from u₂*(t)=−K x(t). These LTI stability considerations provide means to specify parameters of the SAC algorithm. For instance, by expressing eigenvalues in terms of α_{d}, the calculations enable selection of an α_{d} that guarantees (local) convergence to an equilibrium. Although it is usually unnecessary in practice, it is also possible to determine the condition indicating when SAC process 100 should switch to continuous control (18) using Lyapunov analysis. A computational approach can be used to automate the generation of closed-loop Lyapunov functions and optimized (conservative) regions of attraction using Sums-of-Squares (SOS) and the S-procedure.

In addition to proving stability to equilibrium points, these SOS techniques can also provide algorithm parameters to guarantee stability of trajectory tracking. By changing to error coordinates and (slightly) modifying Corollary 2 so that linearizations are taken about the desired trajectory, x_{d}(t), rather than the equilibrium point, show that SAC generates a time varying linear state feedback expression (in terms of error coordinates) locally around the desired trajectory. Assuming SAC applies the feedback expression continuously in this neighborhood, use existing methods for LTV systems to prove stability of the error system. The numerical SOS techniques can be used because they are general and automate the process, providing Lyapunov functions that guarantee stability and estimate the region of attraction for different combinations of SAC parameters.

If (3) is quadratic and the nominal control, u₁, modeled as applying consecutively computed optimal actions (18) near equilibrium, (20) becomes a Riccati differential equation for the closed-loop system and actions (18) simplify to finite horizon LQR controls. In this case prove the existence of a Lyapunov function and guarantee stability for SAC using methods from LQR theory to drive \dot{P}→0. As for NMPC this can be achieved using infinite horizons or by applying a terminal cost and stabilizing constraints that approximate the infinite horizon cost. The Lyapunov function can be provided by (20) with \dot{P}=0.

### Illustrative Example

### Local Stability for the Cart-Pendulum

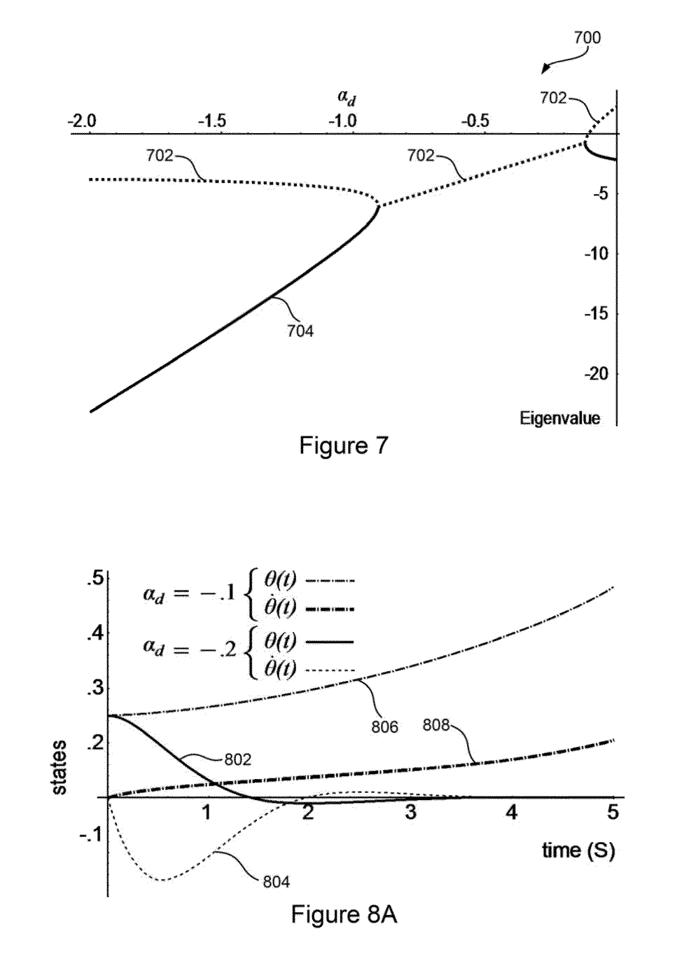

FIG. 7 is a plot 700 of an example real component of the two eigenvalues (curves 702 and 704) as a function of α_{d} for a closed-loop cart-pendulum model linearized about the inverted equilibrium with the linear state feedback SAC process 100 control (18). Choosing α_{d}<0.1 ensures both eigenvalues are negative and so guarantees local stability under (continuous) application of SAC control.

The following example demonstrates the calculations required for stability analysis when SAC is applied to invert an acceleration controlled cart-pendulum in a local neighborhood of the inverted equilibrium. To simplify results, this section uses a reduced state cart-pendulum model where the dynamics correspond to the first two components of (14). Though the cart states are ignored, they can be determined from integration of the acceleration control,

$$u = ( {a}_{c} ) = ( {\ddot{x}}_{c} \frac{m}{{s}^{2}} ) .$$

The calculations to follow use linear analysis to select values of α_{d} that provide stable tracking of the inverted equilibrium, x_{d}(t)=(0, 0), when the tracking objective is quadratic (17) and SAC controls are linear state feedback regulators (18) based on Corollary 2.

Assuming the SAC control (18) is applied continuously, the application time will always correspond to the current time at the beginning of each time horizon, τ_{curr}=t₀. Based on linearizations about the equilibrium,

$$A = ( \begin{matrix}0 & 1 \\ 4.905 & 0\end{matrix} ) and B = ( \begin{matrix}0 \\ 0.5\end{matrix} ) ,$$

the linearized, closed-loop system dynamics are

\dot{x}=Ax+α_{d}BR⁻¹B^{T}P(t₀)x

\dot{x}=(A−BK)x (21)
near the equilibrium. With Q=Diag[1000,1], P₁=0, T=0.5 s, and R=[1] weighting the norm on control authority, (20) yields

$$P ( {t}_{0} ) = ( \begin{matrix}762.05 & 186.13 \\ 186.13 & 53.92\end{matrix} )$$

for arbitrary t₀ such that the eigenvalues for the closed-loop system (21) are expressed as functions of α_{d},

$$\frac{13.48 {α}_{d} \pm \sqrt{19.62 + 186.13 {α}_{d} + 181.74 {α}_{d}^{2}}}{2} .$$

FIG. 7 plots the real component of the closed-loop eigenvalues for different values of α_{d}. The figure shows that the system is locally stable (the real component of the eigenvalues is negative) if the user selects any α_{d}<−0.1, and indicates bifurcations near α_{d}=−0.1 and −0.9.

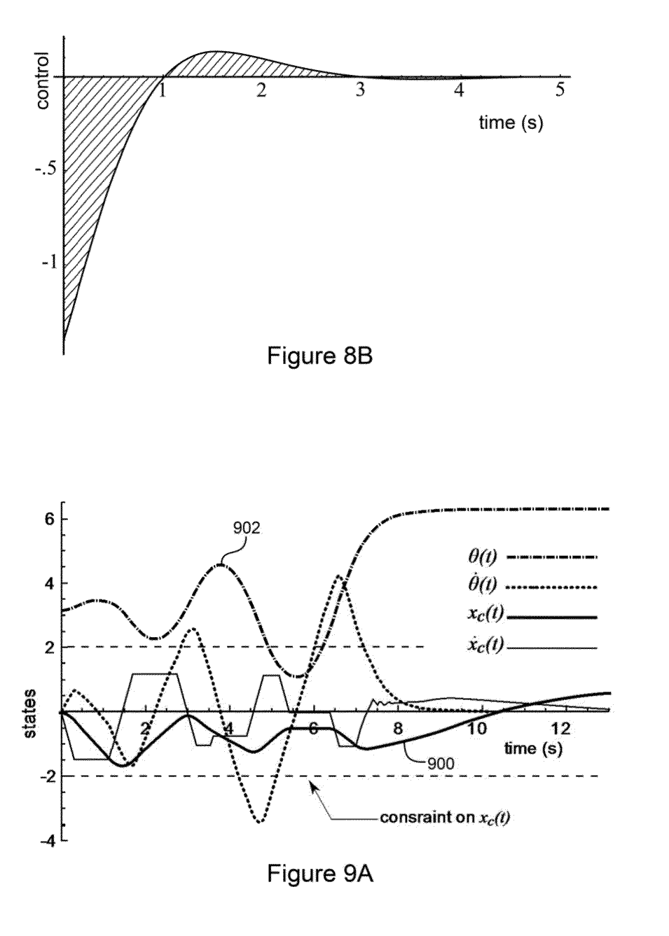

FIGS. 8A-B are graphs of a closed-loop response of the (nonlinear) cart-pendulum system. The closed-loop response of the (nonlinear) cart-pendulum system is based on (18) with α_{d}=−0.1 and α_{d}=−0.2. Linear analysis accurately predicts α_{d}=−0.1 yields an unstable system. The value of α_{d}=−0.2 produces the stable, oscillatory response expected as the states converge to the equilibrium (the origin). The stabilizing control

$$( cart acceleration {\ddot{x}}_{c} ( t ) \frac{m}{{s}^{2}} )$$

resulting from α_{d}=−0.2 is in FIG. 8B.

Based on this linear analysis, if α_{d}=−0.1, the system is unstable, as one of the eigenvalues, (−1.51, 0.17), is slightly positive. The choice of α_{d}=−0.2 produces eigenvalues, −1.35±1.61i, which are stable and have an imaginary component indicating oscillatory convergence. The plots in FIG. 8A-B confirm the accuracy of linear analysis when the (nonlinear) system is initialized near the equilibrium at xᵢₙᵢₜ=(0.15 rad, 0). The angle, θ(t) (802), and angular velocity \dot{θ}(t) (804) in FIG. 8A oscillate as they stabilize to the origin when SAC control (18) is applied with α_{d}=−0.2. In contrast, the dashed states 806 and 808 corresponding to SAC control with α_{d}=−0.1 are unstable and diverge. The stabilizing cart acceleration control is in FIG. 8B.

Input Saturation

There can be several ways to incorporate min/max saturation constraints on elements of the optimal action vector. To simplify the discussion and analysis presented, it is assumed that the nominal control vector u₁=0, as in the implementation examples to be discussed.

Control Saturation—Quadratic Programming

While more efficient alternatives is presented subsequently, a general way to develop controls that obey saturation constraints is by minimizing (22) subject to inequality constraints. The following provides the resulting quadratic programming problem in the case of u₁=0.

Proposition 2: At any potential application time s=τ_{m,i}, a control action can be derived that obeys saturation constraints from the constrained quadratic programming problem

$${u}_{2}^{*} ( s ) = {argmin}_{{u}_{2} ( s )} \frac{1}{2} {‖ Γ ( s ) {u}_{2} ( s ) - {α}_{d} ‖}^{2} + \frac{1}{2} {‖ {u}_{2} ( s ) ‖}_{R}^{2} \qquad ( 22 )$$

such that ∀kε{1, . . . , m},

u_{min,k}≧u_{2,k}*(s)≦u_{max,k} (23)

The term Γ^{T} [symbol] h(x)^{T}ρ, and values u_{min,k} and u_{max,k} bound the k^{th} component of u₂*(s).

Proof. For control-affine systems with the null vector as the nominal control, the mode insertion gradient (4) simplifies to

$$\begin{matrix}\frac{d {J}_{1}}{d {λ}_{i}^{+}} = {ρ ( s )}^{T} ( {f}_{2} ( s , s ) - {f}_{1} ( s ) ) \\ = {ρ ( s )}^{T} h ( x ( s ) ) {u}_{2}^{*} ( s ) \\ = 〈 {Γ ( s )}^{T} , {u}_{2}^{*} ( s ) 〉 .\end{matrix} \qquad ( 24 )$$

The final relation is stated in terms of an inner product.

With the linear mode insertion gradient (24), minimizing (22) subject to (23) is equivalent to optimizing (6) at time s to find a saturated action, u₂*(s).

Proposition 2 considers a constrained optimal action, u₂*(s), at a fixed time. However, the quadratic programming approach can be used to search for the schedule of solutions u₂* that obey saturation constraints (though it would increase computational cost). These quadratic programming problems can be solved much more efficiently than the nonlinear dynamics constrained programming problems that result when searching for finite duration optimal control solutions. As described next, even the limited overhead imposed by these problems can be avoided by taking advantage of linearity in (8).

Control Saturation—Vector Scaling

Optimal actions computed from (8) are affine with respect to α_{d} and linear when u₁=0. Thus, scaling α_{d} to attempt more dramatic changes in cost relative to control duration produces actions that are scaled equivalently. Generally, scaling α_{d} does not equivalently scale the overall change in cost because the neighborhood, Vᵢ, where the (16) models the change in cost can change. This would result in a different duration λᵢ for the scaled action. This fact is applied in scaling optimal actions to satisfy input saturation constraints.

Consider the k^{th} component of a control action vector, u_{2,k}*(s), has minimum and maximum saturation constraints encoded by the k^{th} component of saturation vectors of the form u_{min,k}<0<u_{max,k}∀kε{1, . . . , m}. The linear relationship between u₂* (s) and α_{d} implies that if any component u_{2,l}*(s)>u_{max,k} or u_{2,k}*(s)<u_{min,k}, choose a new \hat{α}_{d} that positively scales the entire control vector until constraints are satisfied. If the worst constraint violation is due to a component u_{2,k}*(s)>u_{max,k}, choosing α_{d}=α_{d} u_{max,k}/u_{2,k}*(s) produces a positively scaled u₂*(s) that obeys all constraints. Linearity between u₂*(s) and α_{d} implies that this factor can be directly applied to control actions from (8) rather than re-calculating from \hat{α}_{d}.

To guarantee that scaling control vectors successfully returns solutions that obey constraints and reduce cost (3), constraints are of the form u_{min,k}<0<u_{max,k} ∀k. A feasible range spanning 0 ensures that all scaling factors reduce control vectors toward 0, making it impossible to scale components that already obey constraints out of feasibility. It also generates only positive factors that preserve α_{d}ε [symbol] ⁻ for the scaled control. The following proposition illustrates the importance of this point.

Proposition 3: For the choice α_{d}<0, a control action u₂*(s) evaluated anywhere that Γ(S)^{T} [symbol] h(x(s))^{T}ρ(s)≠0ε [symbol] ^{m×1} results in a negative mode insertion gradient (4) and so can reduce (3).

Proof. Combining (8) with (24), optimal actions that reduce cost result in a mode insertion gradient satisfying

$$\begin{matrix}\frac{d {J}_{1}}{d {λ}_{i}^{+}} = 〈 {Γ ( s )}^{T} , {( {Γ ( s )}^{T} Γ ( s ) + {R}^{T} )}^{- 1} {Γ ( s )}^{T} {α}_{d} 〉 \\ = {α}_{d} {‖ {Γ ( s )}^{T} ‖}_{{( {Γ ( s )}^{T} Γ ( s ) + {R}^{T} )}^{- 1 }}^{2} < 0.\end{matrix}$$

The outer product, Γ(s)^{T}Γ(s), produces a positive semi-definite symmetric matrix. Adding R>0 yields a positive definite matrix. Because the inverse of a positive definite matrix is positive definite, the quadratic norm ∥Γ(s)^{T}∥_{(Γ(s)}_{^{T}}_{Γ(s)+R}_{^{T}}₎_{⁻¹}>0 for Γ(s)^{T}≠ε [symbol] ^{m×1}. Therefore, only choices α_{d}<0 in (9) produce optimal control actions that make

$$\frac{d {J}_{1}}{d {λ}_{i}^{+}} < 0$$

and by (16) can reauce cost (3).

Control Saturation—Element Scaling

Positively scaling the optimal action vector performs well in practice, requires no additional overhead, and maintains direction. However, for multidimensional vectors, scaling can produce overly conservative (unnecessarily small magnitude) controls when only a single vector component violates a constraint. To avoid the issue and reap the computational benefits of vector scaling, one can choose to scale the individual components of a multi-dimensional action, u₂*(s), by separate factors to provide admissible solutions (saturated control actions that reduce (3)). The following proposition presents conditions under which this type of saturation guarantees admissible controls.

Proposition 4: Assume R=c I where I is the identity and cε [symbol] ⁺, α_{d}ε [symbol] ⁻, u₁=0, and separate saturation constraints u_{min,k}≦0≦u_{max,k}∀kε{1, . . . , m} apply to elements of the control vector. The components of any control derived from (8) and evaluated at any time, s, where Γ(s)^{T} [symbol] h(x(s))^{T}ρ(s)≠0ε [symbol] ^{m×1} can be independently saturated. If ∥u₂*(s)∥≠0 after saturation, the action is guaranteed to be capable of reducing cost (3).

Proof. For the assumptions stated in Proposition 4,

u₂*(s)=(Γ(s)^{T}Γ(s)+R^{T})⁻¹Γ(s)^{T}α_{d}.

The outer product, Γ(s)^{T}Γ(s), produces a rank 1 positive semi-definite, symmetric matrix with non-zero eigenvalue=Γ(s)Γ(s)^{T} associated with eigenvector Γ(s)^{T}. Eigenvalue decomposition of the outer product yields Γ(s)^{T}Γ(s)=S D S⁻¹, where the columns of S corresponds to the eigenvectors of Γ(s)^{T}Γ(s) and D is a diagonal matrix of eigenvalues. For R=R^{T}=c I, actions satisfy

$$\begin{matrix}{u}_{2}^{*} ( s ) = {( {SDS}^{- 1} + cI )}^{- 1} {Γ ( s )}^{T} {α}_{d} \\ = ( {SDS}^{- 1} + {cSIS}^{- 1} ) {Γ ( s )}^{T} {α}_{d} \\ = {( S ( D + cI ) {S}^{- 1} )}^{- 1} {Γ ( s )}^{T} {α}_{d} \\ = {S ( D + cI )}^{- 1} {S}^{- 1} {Γ ( s )}^{T} {α}_{d} .\end{matrix}$$

The matrix D+c I in the final statement is symmetric and positive-definite with eigenvalues all equal to c except for the one associated with the nonzero eigenvalue of D. This eigenvalue, Γ(s)Γ(s)^{T}+c, applies to eigenvectors that are scalar multiples of Γ(s)^{T}. After inversion, matrix S (D+c I)⁻¹ S⁻¹ then has an eigenvalue

$$\frac{1}{Γ ( s ) {Γ ( s )}^{T} + c} .$$

Since inversion of a diagonal matrix leaves its eigenvectors unchanged, the eigenvalue scales Γ(s)^{T}. Therefore, the matrix S (D+c I)⁻¹ S⁻¹ directly scales its eigenvector, Γ(s)^{T}, and

$${u}_{2}^{*} ( s ) = \frac{{α}_{d}}{Γ ( s ) {Γ ( s )}^{T} + c} {Γ ( s )}^{T} . \qquad ( 25 )$$

For any α_{d}ε [symbol] ⁻, u₂*(s) is a negative scalar multiple of Γ(s)^{T}. Because two vectors ε [symbol] ^{m} can at most span a 2D plane E⊂ [symbol] ^{m}, the Law of Cosines (the angle, φ, between vectors u and v can be computed from

$$cos ( φ ) = \frac{〈 u , v 〉}{‖ u ‖ ‖ v ‖} )$$

can be applied to compute the angle between any u₂*(s) and Γ(s)^{T}. The Law of Cosines verifies that control (25) is 180° relative to Γ(s)^{T}. Therefore, (25) corresponds to the control of least Euclidean norm that minimizes (24) and so maximizes the expected change in cost. The Law of Cosines and (24) also imply the existence of a hyperplane, hₚ: ={v(s)ε [symbol] ^{m}| [symbol] Γ(s)^{T}, v(s) [symbol] =0}, of control actions, v(s), orthogonal to both (25) and Γ(s)^{T}. This hyperplane divides R^{m} into subspaces composed of vectors capable of reducing cost (3) (they produce a negative mode insertion gradient based on inner product (24)) and those that cannot.

To show that saturation returns a vector in the same subspace as (25), determine the control in terms of component magnitudes, a=(a₁, . . . , aₘ), and signed orthonormal bases from [symbol] ^{m}, ê=(ê₁, . . . , êₘ), so that u₂*(s)=a ê. The Law of Cosines confirms that u₂*(s) can be written only in terms of components aₖ and signed basis vectors êₖ within acute angles of the control. Briefly, the law indicates an aₖ cannot be associated with any basis, êₖ, at 90° of the control because it would require <êᵢ,u₂*(s)>=0, implying aₖ=0. Similarly, an aₖ cannot be associated with an êₖ>90° relative to the control because this is equivalent to <êₖ,u₂*(s)><0, and leads to an aₖ<0 that contradicts definition.

Because (25) is represented by positively scaled bases within 90° of u₂*(s), all these vectors lie on the same side of hₚ as (25). This is also true of any vector produced by a non-negative linear combination of the components of u₂*(s). Since there always exists factors ε[0, ∞), that can scale the elements of an action vector until they obey constraints u_{min,k}≦0≦u_{max,k}∀kε{1, . . . , m}, saturated versions of (25) will still be capable of reducing cost for ∥u₂(s)∥≠0.

Proposition 4 proves that the elements of control actions from (8) can be replaced by saturated versions to modify direction and achieve feasibility. The proof relies on R=c I to derive actions orthogonal to hₚ, and assumes constraints of form u_{min,k}0≦u_{max,k}∀kε{1, . . . , m} so that saturation is equivalent to non-negative element scaling. These conditions are conservative and only required to guarantee scaling returns actions that can reduce cost. Ignoring the assumptions, arbitrarily saturate control actions and check the sign of (24) to test if solutions still reduce (3). This procedure is typically efficient enough that the quadratic programming approach (22) need only be applied as a fallback. However, as the assumptions are easily met, all examples included in this thesis perform saturation based on Proposition 4.

For an overview of the SAC approach outlining the on-line procedure for synthesis of constrained optimal actions, selection of actuation times, and resolution of control durations, refer to Algorithm 1.

Algorithm 1: Sequential Action Control

Initialize α_{d}, minimum change in cost ΔJₘᵢₙ, current time t_{curr}, default control duration Δtᵢₙᵢₜ, nominal control u₁, scale factor βε(0,1), prediction horizon T, sampling time tₛ, the max time for iterative control calculations t_{calc}, the max backtracking iterations kₘₐₓ, and action iteration i.

```
while t_{curr} < ∞ do
i = i + 1
(t₀, t_{f}) = (t_{curr}, t_{curr} + T)
Simulate (x, ρ) from f₁ for t ∈ [t₀, t_{f}]
Compute initial cost J_{1,init}
Specify α_{d} Compute u₂* from (x, ρ) using Theorem 1
Specify / search for time, τ_{m,i} > t₀ + t_{calc}, to apply u₂*
Saturate u₂* (τ_{m,i})
Initialize k = 0, J_{1,new} = ∞
while J_{1,new} − J_{1,init} > ΔJₘᵢₙ and k ≦ kₘₐₓ do
  λᵢ = β ^{k} Δtᵢₙᵢₜ
  $( {τ}_{0} , {τ}_{f} ) = ( {τ}_{m , i} - \frac{{λ}_{i}}{2} , {τ}_{m , i} + \frac{{λ}_{i}}{2} )$
  Re-simulate x applying f₂ for t ∈ [τ₀, τ_{f}]
  Compute new cost J_{1,new}
  k = k + 1
  end while
  u₁(t) = u₂*(τ_{m,i}) ∀t ∈ [τ₀,τ_{f}] ∩ [t₀ + tₛ, t₀ + tₛ + t_{calc}]
  while t_{curr} < t₀ + tₛ do
      Wait( )
    end while
  end while
```

Algorithm 1: At sampling intervals SAC incorporates feedback and simulates the system with a nominal (typically null) control. Optimal alternative actions are computed as a closed-form function of time. A time is chosen to apply the control action. A line search provides a duration that reduces cost.

### Continuous Benchmark Examples

The following provides simulation examples where SAC process 100 is applied on-line to control several benchmark simulation systems in both trajectory tracking and balance control tasks. Each example is intended to highlight different design and performance related aspects of the SAC approach. Results are compared with alternative methods.

Cart-Pendulum

The following description presents three examples where SAC process 100 is applied to the nonlinear cart-pendulum (14) in simulated swing-up and tracking control tasks subject to unilateral constraints. Performance is demonstrated using the cart-pendulum as it provides a well understood underactuated control problem that has long served as a benchmark for new control methodologies.

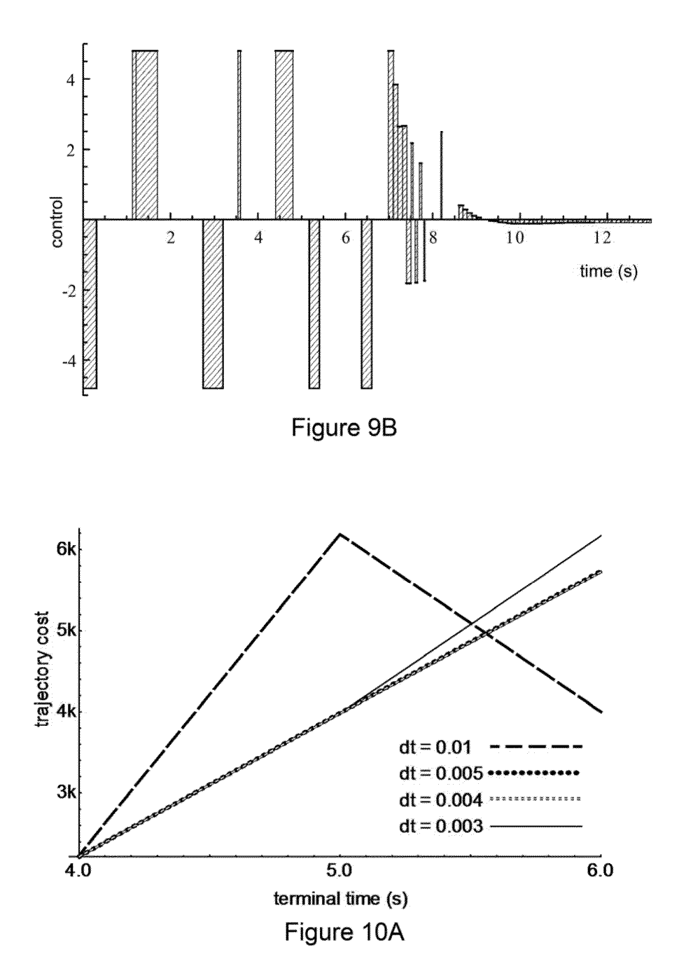

FIGS. 9A-B are graphs showing the SAC process 100 applied to invert the cart-pendulum system at a low sampling and control sequencing frequency, e.g., of 10 Hz, (at equilibrium the dynamics are those of a simple pendulum with natural frequency of 0.35 Hz). The low-frequency control signal (FIG. 9B) illustrates how individual control actions are sequenced into a piecewise continuous response to state (especially apparent between 7 and 10 seconds). Even at this low frequency and with saturation constraints, SAC inverts the system and maintains the cart in the desired region between [−2,2] m. FIG. 9B also shows SAC automatically develops an energy pumping strategy early in the trajectory to invert the pendulum.

Low-Frequency Constrained Inversion

In this example, SAC process 100 is applied to invert the cart-pendulum system (14) under conditions where feedback and sequencing of control actions is performed at a relatively low frequency of 10 Hz. The low-frequency simulation highlights the control synthesis process of SAC.

This example depicts performance under conditions where constraints are applied to both the control signal and state trajectory. Min-max saturation constraints,

$${\ddot{x}}_{c} ∈ [ - 4.8 , 4.8 ] \frac{m}{{s}^{2}} ,$$

are applied to the control input to show SAC can find solutions that require multiple swings to invert the pendulum. Using the quadratic form of the tracking cost (17) with the state dependent weight matrix, Q(x(t))=Diag[200,0,(x_{c}(t)/2)⁸, 50] ∀t, to impose a barrier/penalty function, the cart's position is maintained in a specified region, x_{c}ε[−2,2] m. FIG. 9A demonstrates the results of SAC when initialized with the pendulum hanging at the stable equilibrium and zero initial velocity, xᵢₙᵢₜ=(−π,0). Terminal and control costs in (6) and (17) are determined using P₁=0, R=[0.3], and a horizon of T=1.5 s. Additionally, θ is wrapped such that θε[−π,π) rad.

As the curve 900 from FIG. 9A shows, the penalty function successfully keeps the cart position within the [−2,2] m window. Even with this low sampling rate and stringent saturation constraints, the controller successfully pumps energy into the system to get the pendulum to smoothly swing up and invert (see the dashed curve 902 of pendulum angle θ) while keeping the cart within bounds. Generally, for solutions that require energy pumping behavior, the control search process discussed above is useful. As the control solution shows, the process applies maximal acceleration to get the pendulum swinging in one direction and then waits for the pendulum to swing to a better configuration. Thus it conserves energy before reapplying maximal acceleration in the opposite direction (refer to the first few seconds of control in FIG. 9B).

High-Frequency Constrained Inversion

In the following example, the SAC algorithm is applied to swing-up and invert the cart-pendulum system on-line, with high-frequency feedback at 1,000 Hz. To gauge the quality of the inversion strategy, the closed-loop control solution from SAC is compared to the theoretically optimal, open-loop inversion solution computed from a widely used optimization method known as sequential quadratic programming (SQP).

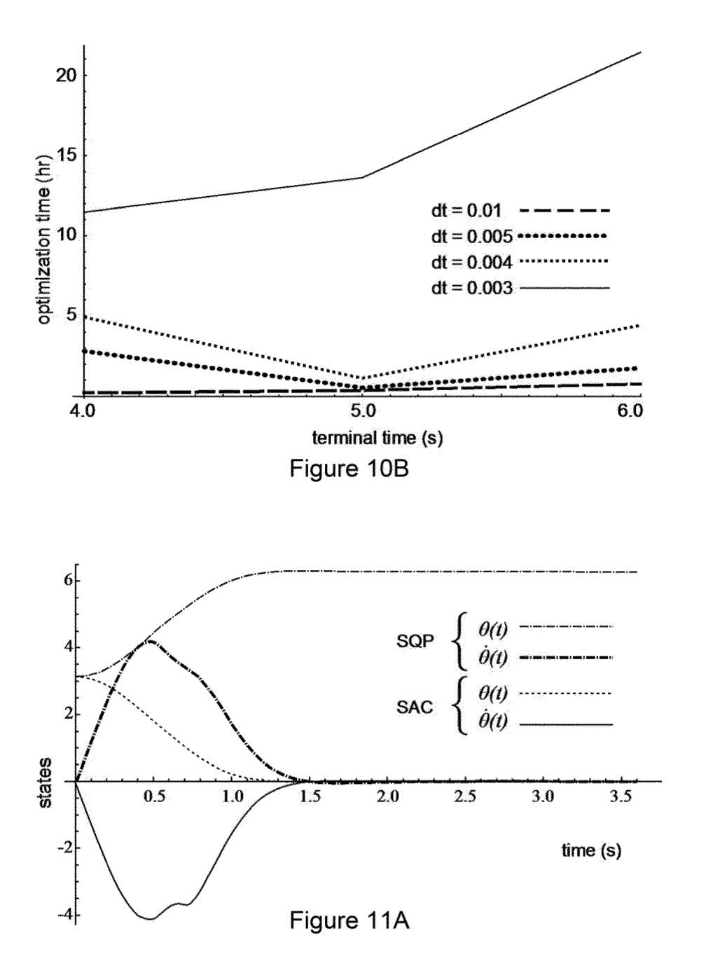

FIG. 10A-B are graphs of example cost (FIG. 10A) and time (FIG. 10B) to complete open-loop optimal trajectory from SQP as a function of the optimization time horizon. Each figure includes results for different choices of discretization level, dt (in seconds), for the state and control signal. In FIG. 10A, the plots associated with discretization every dt=0.005 s and 0.004 s approximately match and so overlap in the figure. Of the sampled time horizons (4 s, 5 s, and 6 s), only the 4 s horizon results in an optimal solution comparable in cost to SAC process 100. SAC solutions typically ranged in cost from 2,215-2,660 for a variety of parameter choices.

SAC can provide control solutions on-line and in closed-loop (these results reflect 1,000 Hz feedback) that achieve performance comparable to or better than fixed horizon open-loop optimal control. For the trajectory depicted, both SAC and SQP achieve a final cost of J_{pend}≈2,215.

Standard open-loop optimal control for the nonlinear constrained cart-pendulum system can converge too many high-cost, local equilibria solutions. This is especially true when trajectories are not initialized with a good estimate of the optimal control. To simplify comparison and avoid these equilibria (and to speed computation of the SQP solutions) the cart position and velocity terms are unconstrained and their error weights ignored so that the dynamics are represented by the first two components of (14). In this case the goal is to minimize a norm on the cart's acceleration while simultaneously minimizing the trajectory error in the pendulum angle relative to the origin (inverted equilibrium). The objective used to compare algorithm performance,

$${J}_{pend} = \frac{1}{2} {\int }_{{t}_{0}}^{{t}_{f}} {‖ x ( t ) - {x}_{d} ( t ) ‖}_{Q}^{2} + {‖ u ( t ) ‖}_{R}^{2} d t , \qquad ( 26 )$$

is applied in discretized form for SQP results. This discretized objective and the associated matrices, Q=Diag[1000, 10] and R=[0.3], also provide the finite horizon cost for computation of optimal trajectories in SQP. Both SAC and SQP are constrained to provide control solutions,

$${\ddot{x}}_{c} ∈ [ - 25 , 25 ] \frac{m}{{s}^{2}} .$$

The SQP algorithm uses both an a-priori choice of discretization and relies on linearization of constraints. For comparison, SQP results are provided for four different choices of discretization (every dt=0.01 s, 0.005 s, 0.004 s, and 0.003 s). Though the SAC results are sequenced (discretized) at 1,000 Hz in this example, discretizing at time steps <0.003 s in SQP was infeasible on the laptop used to test both systems. In one example, results can be obtained on the same laptop with Intel® Core™ i7-4702HQ CPU @ 2.20 GHz×8 and 16 GB RAM. The finite dimensional computation resulted in optimization over too many variables and constraints and consumed all available computational resources. Also, because SQP results were sensitive to the choice of optimization time horizon, results were simulated under three different horizon lengths of 4 s, 5 s, and 6 s. These can be selected based on the assumed minimal amount of time for swing up and stabilization of the pendulum. Plots of tracking cost (26) and time required for optimization versus applied time horizon and discretization for SQP are in FIG. 9B.

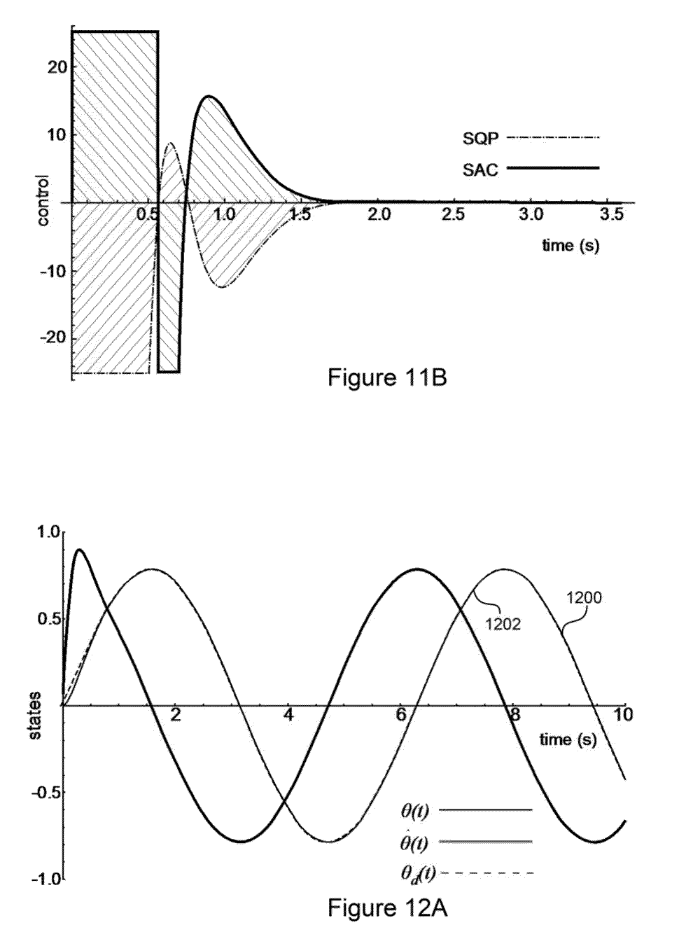

FIGS. 11A-B are graphs of example control solutions on-line and in closed-loop (e.g. 1000 Hz feedback) that achieve performance comparable to or better than fixed horizon open-loop optimal control. For the trajectory depicted, both SAC and SQP achive a final cost of J_{pend}=2,215. In one example, the best (lowest cost) results can be obtained from SQP based on a time horizon of 4 s. Both longer optimal trajectories converged to local minimizers with significantly greater cost (typically more than twice) and required additional swings of the pendulum for inversion. The best case open-loop optimal SQP trajectory, included in FIGS. 11A-B, obtained a cost of J_{pend}=2,215 and the worst case cost reached J_{pend}=6,189. In comparing SAC to SQP, closed-loop SAC solutions were obtained for a variety of parameter combinations and moving horizons from T=0.15 s to T=3 s. These solutions produced costs ranging from J_{pend}=2,215 to J_{pend}=2,660, where the majority of solutions provided costs close to the optimal J_{pend}=2,215. In comparing SAC and SQP solutions, costs J_{pend} are computed from the SQP weight matrices for both cases. The SAC solution depicted in FIG. 11A-B achieves the best case cost of J_{pend}=2,215. This solution is derived from moving horizons of T=0.28 s, with the quadratic cost (17) and parameters Q=0, P₁=Diag[500, 0], and R=[0.3].

As in 11A-B, SAC is able to develop on-line, closed-loop controls that perform as well as the best case optimal trajectory computed by offline, open-loop trajectory optimization using SQP. With high bandwidth feedback and control sequencing at 1,000 Hz, the SAC control law in FIG. 11B appears smooth and continuous and no longer has the piecewise nature of the signal in the previous, low-bandwidth example in FIG. 9B. Both SAC and SQP can produce similar, constrained control solutions that swing-up and invert the system in roughly the same amount of time. However, in practice SAC tends to achieve costs close to the optimal, while SQP varies significantly based on the time horizon and discretization. In simulating control laws of 5 s, 6 s, or longer, SAC solutions remain identical (because they are computed in moving horizon fashion) while the fixed-horizon SQP approach would indicate a significantly worse optimal inversion solution.

Although it may not be entirely fair to compare the computational requirements of the two algorithms considering SAC was implemented in C++ and the SQP algorithm is based on Matlab's implementation, there are several trends worth noting. First, though SQP converged to approximately the same solution across all choices of discretization and 4 s time horizon, the coarser discretization levels (especially dt=0.01 s) would not apply for problems that require higher bandwidth control responses. At finer discretization levels, SQP requires significantly greater time to converge as the number of optimization variables and constraints grows. With a discretization three times as coarse as SAC, SQP requires nearly 12 hours to compute the single, open-loop optimal trajectory in FIG. 11B utilizing the resources of four CPU cores. In contrast, SAC obtains a solution equivalent to the best SQP results on-line with feedback at 1,000 Hz and in less than half a second using a single CPU core (the code has not yet been optimized or expanded to provide multi-threaded functionality). The SAC algorithm achieves this dramatic difference in computation time by avoiding the iterative optimization process, which requires thousands of variables and constraints in the case of SQP. Instead, SAC calculates optimal actions in closed-form and sequences these in closed-loop much faster than real-time.

Sensitivity to Initial Conditions

Using a prediction horizon T=1.2 s, SAC was applied to invert the same, reduced cart-pendulum system from a variety of initial conditions. Simulations used the quadratic tracking cost (17) and weight matrices from (26). A total of 20 initial conditions for θ(t), uniformly sampled over [0,2π), were paired with initial angular velocities at 37 points uniformly sampled over [0.4π].

To gauge performance, a 10 s closed-loop trajectory was constructed from each of the 740 sampled initial conditions, and the state at the final time x(10 s) measured. If the final state was within 0.001 rad of the inverted position and the absolute value of angular velocity was

$$< 0.001 \frac{rad}{s} ,$$

the trajectory was judged to have successfully converged to the inverted equilibrium. Tests confirmed the SAC algorithm was able to successfully invert the pendulum within 10 s from all initial conditions. The average computation time was ≈1 s for each 10 s trajectory on the test laptop.

Trajectory Tracking

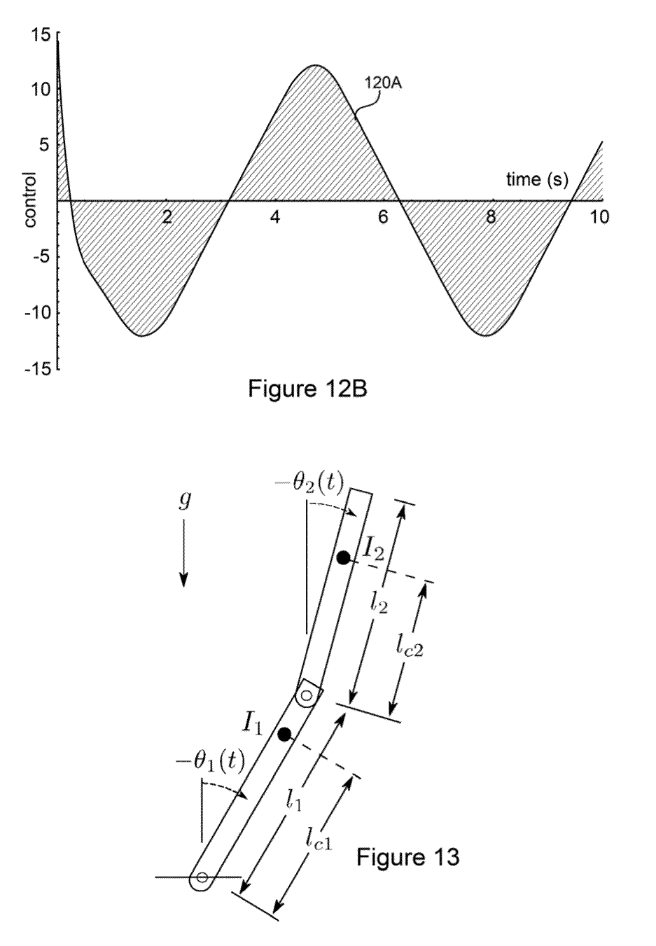

FIGS. 12A-B are graphs of example SAC algorithm controls the reduced state cart-pendulum in tracking a sinusoidal angular trajectory (dashed curve 1200 in FIG. 12A). The angular trajectory (curve 1202) is computed in closed-loop at 1,000 Hz and tracks the reference well enough that it is difficult to distinguish from the desired trajectory curve. FIG. 12B shows the saturated SAC control signal 1204.

In addition to swing-up and balance control, the SAC algorithm can track desired trajectories. FIGS. 12A-B demonstrates a closed-loop tracking task where SAC computes accelerations to drive the reduced cart-pendulum system from the inverted equilibrium, xᵢₙᵢₜ=(0,0). In this scenario, the objective is to apply constrained cart accelerations to track a sinusoidal desired pendulum angle swinging between

$$45 ° and - 45 ° ( {θ}_{d} ( t ) = \frac{π}{4} sin ( t ) rad ) .$$

Tracking is performed in closed loop at 1,000 Hz with the prediction horizon T=0.2 s and controls saturated so that

$${\ddot{x}}_{c} ∈ [ - 15 , 15 ] \frac{m}{{s}^{2}} .$$

The quadratic objective (17) is applied to weight state error relative to the desired angle. With Q=0, P₁=Diag[5,000, 0], and R=[0.3], the full 10 s closed-loop trajectory requires 0.55 s to compute.

As FIGS. 12A-B show, SAC performs well at tracking the desired angle. The desired (dashed curve 1200) and actual (curve 1202) trajectories are nearly indistinguishable except near the start. This is due to the fact that SAC hits the saturation limit of the control early and so briefly lags behind. It quickly catches up and tracks the desired angle and, with high-frequency feedback, produces a near-continuous control signal much faster than real-time.

Pendubot and Acrobot

FIG. 13 is a block diagram of example configuration variables for the acrobot and pendubot systems. Both systems are controlled by a single input torque applied about the first joint for the pendubot system and the second joint for the acrobot. In both cases the uncontrolled joint is passive. The SAC process 100 is applied for swing-up control of two systems, the pendubot and the acrobot. The pendubot is a two-link pendulum system with a single input torque that can be applied about the fixed revolute joint constraining the first (base) link. The acrobot system is identical except the input torque is applied at the joint connecting the two links. A diagram with configuration variables is included in FIG. 13 and model parameters for both systems are copied below. For each system, the state vector is given by x=(θ₁, \dot{θ}₁, θ₂, \dot{θ}₂) with the relevant joint torque as the control, u=(τ).

| | | |
|---|---|---|
| pendubot: | m₁ = 1.0367 kg | m₂ = 0.5549 kg |
| | l₁ = 0.1508 m | l₂ = 0.2667 m |
| | l_{c1} = 0.1206 m | l_{c2} = 0.1135 m |
| | I₁ = 0.0031 kg m² | I₂ = 0.0035 kg m² |
| acrobot: | m₁ = 1 kg | m₂ = 1 kg |
| | l₁ = 1 m | l₂ = 2 m |
| | l_{c1} = 0.5 m | l_{c2} = 1 m |
| | I₁ = 0.083 kg m² | I₂ = 0.33 kg m² |

Due to their underactuated dynamics and many local minima, the pendubot and acrobot provide challenging test systems for control. As a popular approach, researchers apply energy based methods for swing-up control and switch to LQR controllers for stabilization in the vicinity of the inverted equilibrium. To avoid designing weight matrices good for both swing-up and stabilization, this also uses LQR controllers to stabilize the systems once near the inverted equilibrium. However, the results included here show the SAC algorithm can swing-up both systems without relying on special energy optimizing methods. The algorithm utilizes the quadratic state error based cost functional (17), without modification.

While the pendubot simulations use control torques up to a magnitude of 15 for inversion, example results show that inversion is possible with motor torques restricted to a magnitude of 7 Nm. For this reason, SAC input constraints for the pendubot are specified so that τε[−7,7] Nm. The acrobot system torques are constrained to the range τε [−15,15] Nm to invert the system using less than 20 Nm.

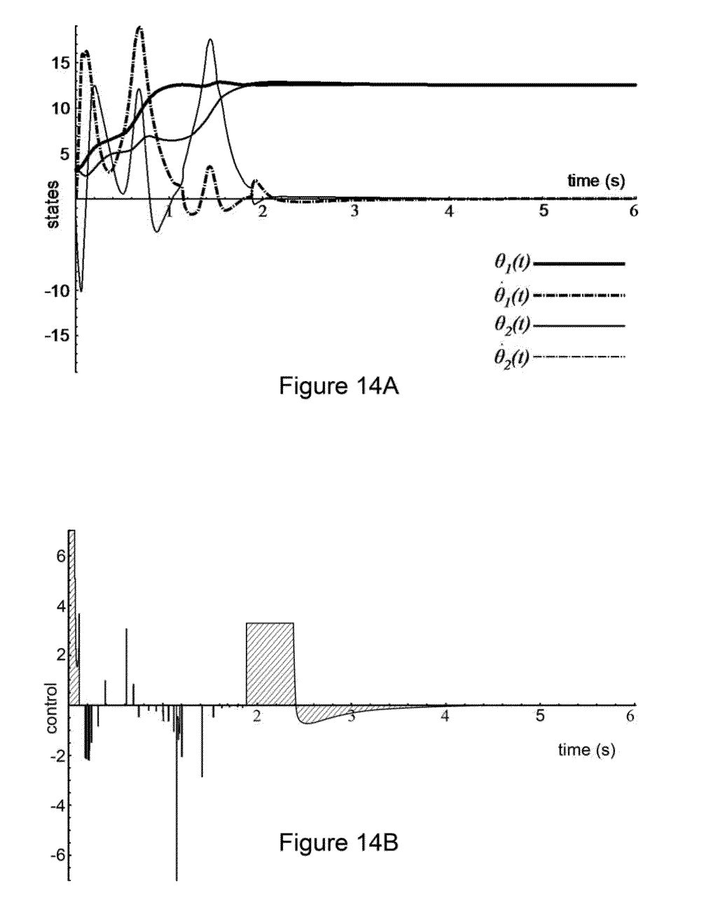

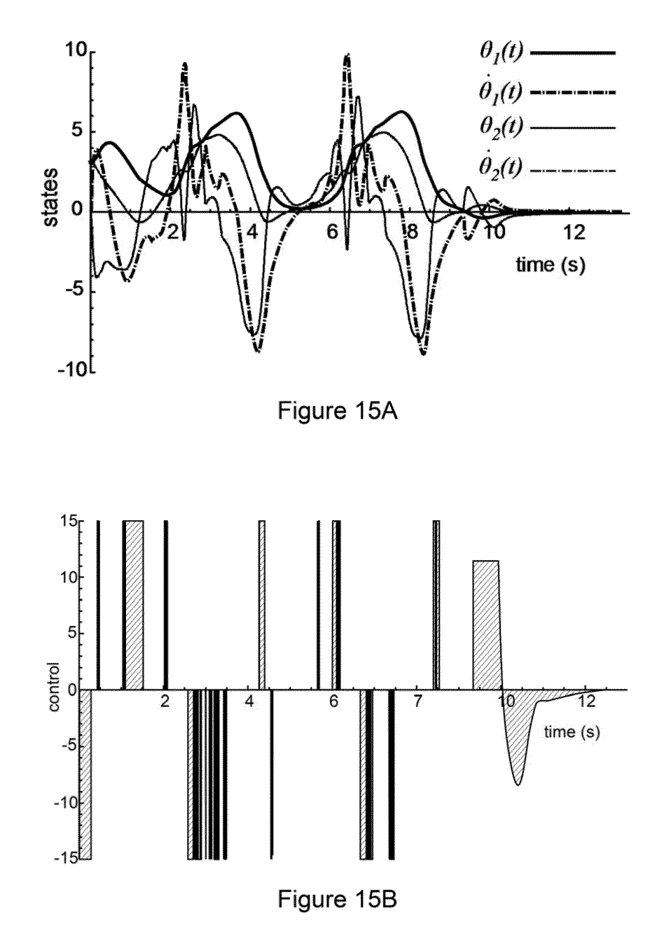

FIGS. 14A-B and FIGS. 15A-B show the trajectories produced by SAC when each system is initialized at the downward, stable equilibrium and the desired position is the equilibrium with both links fully inverted. In FIG. 14A-B, SAC pendubot inversion, the SAC algorithm swings up the pendubot close enough for final stabilization by the LQR controller. The LQR controller takes effect at t=1.89 s. The algorithm inverts the system using less peak control effort and in less time than existing methods from literature with the same parameters. In FIGS. 15A-B, SAC acrobot Inversion, the SAC algorithm swings up the acrobot using less peak effort than alternate methods. At t=9.34 s, the system states are close enough to the inverted equilibrium for final stabilization by the LQR controller.

These results are based on a feedback sampling rate of 200 Hz for the pendubot with Q=Diag[100, 0.0001, 200, 0.0001], P₁=0, and R=[0.1] and 400 Hz for the acrobot with Q=Diag[1,000, 0, 250, 0], P₁=Diag[100, 0,100, 0], and R=[0.1]. The LQR controllers derived offline for final stabilization,

K_{iqr}=(−0.23,−1.74,−28.99,−3.86)

and

K_{lqr}=(−142.73,−54.27,−95.23,−48.42),
were calculated about the inverted equilibrium to stabilize the pendubot and acrobot systems, respectively. With some minor experimentation and tuning, |θ_{1,2}|≦0.05 rad was selected as the switching condition for pendubot stabilization. More formally, a supervisory hybrid/switching controller can control the switch between swing-up and stabilizing controllers based on the region of attraction of the stabilizing controller. Due to the differences in systems parameters, the acrobot switched to stabilizing control once all its configuration variables were ≦0.25 in magnitude.

As in FIGS. 14A-B and FIGS. 15A-B, the SAC process 100 is able to swing each system up close enough for successful stabilization in both cases. In fact, for the same parameters the approach is able to invert the pendubot system using the same peak control authority as required in other examples and less than half that from simulations. SAC also required only 3 seconds to invert, while other simulations needed close to 4 seconds. Where some approaches require switching between separately derived controllers for pumping energy into the system, out of the system, and inverting the system before final stabilization, all these tasks were performed by the SAC algorithm without any change in parameters and with the simple state tracking norm in (17). Applied to the acrobot, FIGS. 15A-B also shows that SAC successfully inverts the system with the desired peak torque magnitude of 15 (¾ of the peak control effort in simulations. These closed-loop control results can be computed on-line and require only 1.23 and 4.7 seconds to compute 20 second trajectories for the pendubot and acrobot systems, respectively.

As in all examples, a range of parameter combinations can successfully achieve the desired tracking goals. However, to invert the pendubot and acrobot in minimal time and under the tight input constraints, the two most important parameters for tuning are the desired change in cost due to each control actuation, α_{d}, and horizon length T. All examples in this thesis specify α_{d} iteratively based on the current initial trajectory cost under the nominal (null) control as α_{d}=γJ_{1,init}. From experimentation, γε[−15, 1] tends to work best, but because of the speed of SAC computations, good parameter values can be found relatively quickly using sampling. These pendubot and acrobot results are based on γ=15 and similar time horizons of T=0.5 s and T=0.6 s respectively. In nearly all cases SAC solutions also appear to be less sensitive to the terms in the Q, R, and P₁ matrices than traditional optimal control.

As described earlier, traditional optimal control methods that use simple state tracking norms rather than energy metrics are not typically applied for swing-up or inversion of the pendubot and acrobot. These methods generally fail to invert these systems as they result in many local minima that cause solutions to become stuck and converge to undesirable trajectories based on these cost functions. Considering SQP would fail to produce an optimal trajectory that inverts these systems under the same objective and initial conditions, it is noteworthy that SAC process 100 is able to invert both systems on-line and faster than real-time using its state tracking objective (17).

One Dimensional Minimum Time Parking

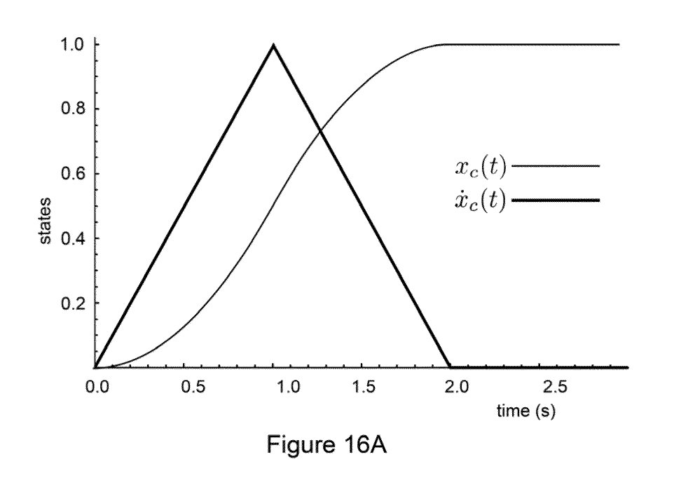

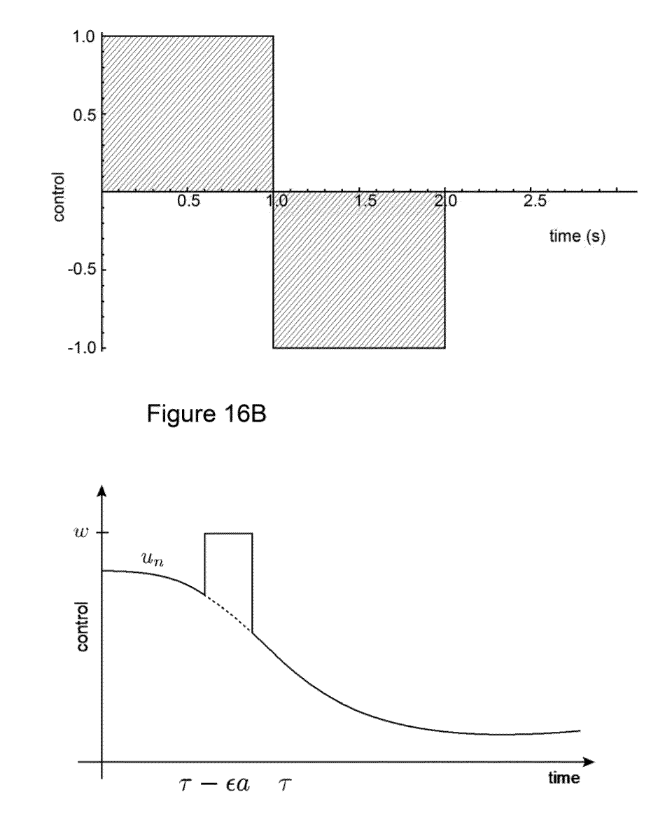

FIGS. 16A-B are graphs of an example SAC process 100 that can exactly recover the analytically optimal bang-bang control solution to the minimum time parking problem on-line and faster than real-time in closed-loop application. Consider the problem of driving a vehicle model from a starting configuration to a goal configuration in minimum time using bounded acceleration. This example assumes a simple model with a state consisting of 1D position and velocity x=(x_{c},\dot{x}_{c}), and linear dynamics

$$f ( x , u ) = ( \begin{matrix}{\dot{x}}_{c} \\ a\end{matrix} ) , \qquad ( 27 )$$

under acceleration control u=(a) where a

$$∈ [ - 1 , 1 ] \frac{m}{{s}^{2}} .$$

For these conditions, an optimal solution can be computed analytically and is provided by a bang-bang style controller. This controller applies full acceleration to the vehicle for the first half of the trajectory and then maximal deceleration for an equal time to stop the system at the goal.

The results in FIGS. 16A-B demonstrate that SAC process 100 recovers, e.g., exactly, the optimal bang-bang control trajectory for this system when (17) imposes norms on tracking error with Q=Diag[1000, 0], R=[1], P₁=0, and T=0.9 s. Also, the magnitude of α_{d} is increased from its usual range by specifying γ=50 in order to reach the goal as quickly as possible. This naturally produces control actions that hit saturation limits and SAC efficiently replaces calculated controls with saturated versions without performing constrained optimizations (22). While modifying parameters like the prediction horizon can influence the solution so it is no longer globally optimal, these alternate solutions generally approximate the bang-bang solution. It is notable that SAC process 100 achieves these time-optimal results on-line, without directly solving any time-optimal control problem.

SAC: Extension to Hybrid Impulsive Systems

Robotic locomotion and manipulation tasks result in hybrid impulsive dynamics that switch as functions of state at contact and impact events. These problems are notoriously difficult to control using optimization based methods due to the fact that the dynamics are non-smooth and so derivative information required for optimization is unavailable. Such non-smooth systems give rise to more complicated optimality conditions and require special treatment in optimal control. However, because SAC process 100 plans infinitesimal actions individually, the algorithm does not need to optimize control curves over discontinuous segments of the trajectory. Instead, SAC computes the sensitivity of a finite horizon trajectory cost functional (3) to control actions and chooses actions that optimize this sensitivity (maximize the expected improvement in cost relative to control effort) according to (6).

As discussed above, the mode insertion gradient (4) indicates the cost sensitivity at any potential application time, sε[t₀,t_{f}], based only on an adjoint variable and dynamics. However, the mode insertion gradient (4) (and adjoint variable in (5)) is only valid for differentiable nonlinear systems. Below includes derivations that extend the definition of the mode insertion gradient to larger classes of hybrid impulsive systems with resets. Hence, these methods can enable mode scheduling algorithms, which rely on the mode insertion gradient, to be applied to this wider array of systems.

Derivations parallel the approach for continuous systems to develop a first-order approximation of the variation in cost due to perturbations in a nominal control signal generated by infinitesimal SAC actions. Using this model, the section derives an equation for an adjoint variable similar to (5), but which applies to hybrid impulsive systems. Calculations prove the formula for the sensitivity of a cost functional (3) to infinitesimal control actions remains the same as the mode insertion gradient formula (4) assuming the adjoint variable is modified for hybrid impulsive systems. Hence, the SAC process 100 described above remains the same for hybrid impulsive systems except for the additions of jump terms (resets), which appear in the adjoint variable at switching events (assuming actions are not applied at switching times and no Zeno behavior). Hybrid system calculations based on a 1D system are described and then the hybrid SAC approach in simulation is described for on-line control of a bouncing ball.

The change in the adjoint (5) due to addition of jump terms may be small in practice. Because the effect of modeling errors (e.g., due to exclusion of jump terms) are often minimized by SAC's closed-loop receding horizon style control approach, results show that SAC can (often) control hybrid impulsive systems in relatively challenging environments (SAC controls a spring-loaded inverted pendulum model up stairs on-line and in real-time) without these hybrid systems modifications. This is a benefit of SAC that simplifies implementation. However, examples provide simple scenarios where the hybrid extensions are used. These sections discuss issues that compromise SAC's model-based synthesis process to help control designers assess when the SAC approach above can be applied to hybrid impulsive systems as a heuristic.

The Variational and Adjoint Equations for Hybrid Systems

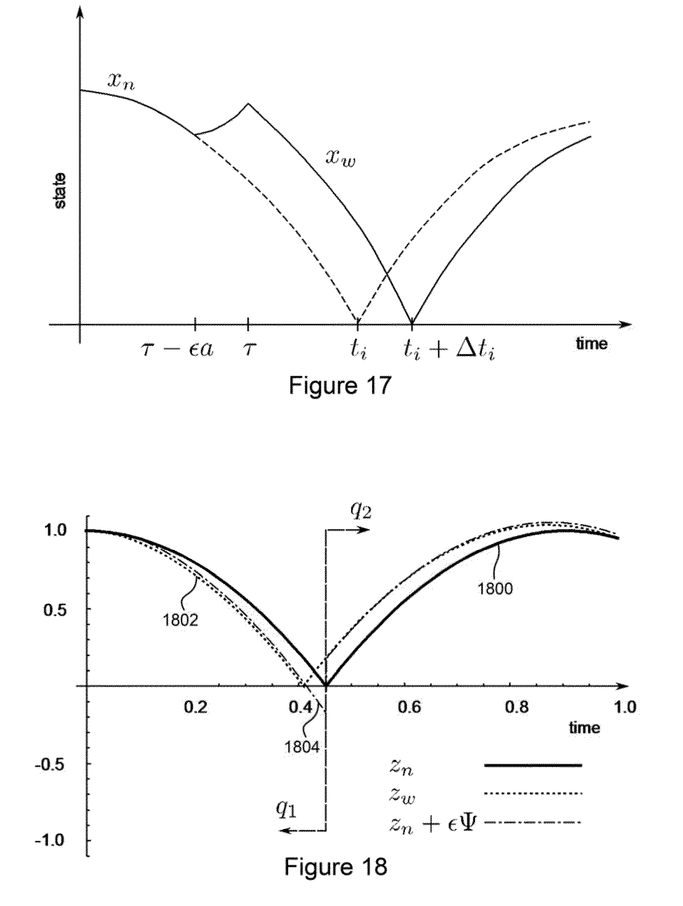

FIG. 17 is graphs of a perturbed control (top) and a corresponding (hypothetical) state variation (bottom) for a hybrid system. The nominal system switches locations at time tᵢ and the perturbed system switches at time tᵢ+Δt. Taken in the limit as εa→0⁺, the control perturbation is a needle perturbation that is equivalent to an infinitesimal action in SAC.

The classes of hybrid systems considered here are determined such that:
1. Q is a finite set of locations.
2. [symbol] ={ [symbol] _{q}⊂ [symbol] ⁿ^{_{q}}}_{qεQ} is a family of state space manifolds indexed by q.
3. U={U_{q}⊂ [symbol] ^{m}^{_{q}εQ}} is a family of control spaces.
4. f={f_{q}εC( [symbol] _{q}×U_{q},T [symbol] _{q})}_{qεQ} is a family of maps to the tangent bundle, T [symbol] _{q}. The maps f_{q}(x,u)εTₓ [symbol] _{q} are the dynamics at q.
5. U={U_{q}⊂L(⊂ [symbol] ,U_{q})}_{qεQ} is a family of sets of admissible control mappings.
6. J={J_{q}⊂ [symbol] ⁺}_{qεQ} is a family of consecutive subintervals corresponding to the time spent at each location q.
7. The series of guards, Φ={(Φ_{q,q′}εC¹( [symbol] _{q}, [symbol] q,q′)εQ}, indicates transitions between locations q and q′ when Φ_{q,q′}(x)=0. The state transitions according to a series of corresponding reset maps, Ω={Ω_{q,q′}εC¹( [symbol] _{q}, [symbol] _{q′}):(q, q′)εQ}. A single element of Φ may be active (zero) at a given time.

For the sake of clarity, numerical subscripts are avoided for the nominal control, u₁, from above. Instead, this assumes a series of (possibly null) nominal control laws, uₙ={u_{n,q}εU_{q}}_{q,εQ}, exists and is determined over the domain [t₀,t_{f}]⊂ [symbol] ⁺ for each location. With an initial location q₁, state x(t₀)=xᵢₙᵢₜε [symbol] _{q}_{₁}, and the collection {f, Φ, Ω}, the location sequence, q=(q₁, . . . , qᵣ):rε [symbol] and intervals, J, exist and are determined based on the nominal state trajectory, xₙ(t)=x_{n,q}_{ᵢ}(t):iε{1, . . . , r},tεJ_{q}_{ᵢ} from forward simulation,

\dot{x}_{n,q}_{ᵢ}=f_{q}_{ᵢ}(x_{n,q}_{ᵢ},u_{n,q}_{ᵢ}):tεJ_{q}_{ᵢ}. (28)

The controlled system is assumed to exclude Zeno behavior by design. Guards, Φ, indicate when a transition should occur (they specify the end of each interval J_{q}_{ᵢ}) and the next location, qᵢ₊₁, in the sequence q (based on which guard becomes 0). Reset maps determine the initial condition for evolution of the state according to (28) in location qᵢ₊₁ as {x_{n,q}_{ᵢ₊₁}(tᵢ⁺)=Ω_{q}_{ᵢ}_{,q}_{ᵢ₊₁}(tᵢ⁻)):tᵢ⁻ [symbol] supJ_{q}_{ᵢ},tᵢ⁺ [symbol] infJ_{q}_{ᵢ₊₁}}.

Infinitesimal actions in SAC are needle perturbations relative to a nominal control. To model the effects of these needle perturbations in the nominal control, uₙ, to first order, a perturbed control signal is determined,

$${u}_{w} {=}^{Δ} \{ \begin{matrix}{u}_{n} & \text{:} t ∉ [ τ - ɛ a , τ ] \\ w & \text{:} t ∈ [ τ - ɛ a , τ ]\end{matrix} ,$$

for a (short) duration λ=εa. The magnitude of λ is specified as εεIR⁺ and the direction by an arbitrary positive scalar aε [symbol] ⁺. Because the perturbed system is eventually evaluated for λ→0⁺, assume the perturbation occurs in the arbitrary location qᵢ associated with the state xₙ(τ) so that [τ−εa,τ]⊂J_{q}_{ᵢ}. FIG. 17 depicts the perturbed control and the corresponding perturbed (1D) state.

The following subsection will develop a first-order model of the perturbed state,

z_{w}(t,ε) [symbol] xₙ(t)+εΨ(t)+o(ε):tεJ. (29)

The litte-o notation, o(ε), indicates terms that are higher than first order in ε. These terms go to zero faster than first-order terms in (29) as ε→0. To solve for the direction of state variations, Ψ, this subsection follows the approach derived for continuous systems and uses first-order Taylor expansions to approximate Ψ(τ).

Initial Condition for State Variations

First, expansion of xₙ about t=τ, and (29) about t=τ−εa yields

xₙ(τ−εa)=xₙ(τ)−f_{q}_{ᵢ}(xₙ(τ),uₙ(τ))εa+o(ε) (30)

and

x_{w}(τ,ε)=xₙ(τ−εa)+f_{q}_{ᵢ}(xₙ(τ−εa),w)εa+o(ε). (31)

Similarly, expand f_{q}_{ᵢ}(xₙ(τ−εa),w) around xₙ(τ),

f_{q}_{ᵢ}(xₙ(τεa),w)=f_{q}_{ᵢ}(xₙ(τ),w)+Dₓf_{q}_{ᵢ}(xₙ(τ),w)[xₙ(τ−εa)−xₙ(T)]+o(xₙ(τ−εa)−xₙ(τ)),
and apply xₙ(τ−εa)−xₙ(τ)=−f_{q}_{ᵢ}(xₙ(τ),uₙ(τ))εa+(ε) from (30), in order to simplify (31) to obtain,

x_{w}(τ,ε)=xₙ(τ−εa)+f_{q}_{ᵢ}(xₙ(τ),w)εa+(ε). (32)

Plugging (30) into (32) results in a first-order approximation of the perturbation at time t=τ,

x_{w}(τ,ε)=xₙ(τ)+(f_{q}_{ᵢ}(xₙ(τ),w)−f_{q}_{ᵢ}(xₙ(τ),uₙ(τ)))εa+o(ε). (33)

Finally, based on (29), the formula (33) indicates the initial direction for state variations,

Ψ(τ)=(f_{q}_{ᵢ}(xₙ(τ),w)−f_{q}_{ᵢ}(xₙ(τ),uₙ(τ)))α. (34)

Propagation of Variations within a Location

Assuming the variation occurs at t=τ in location qᵢεQ, the varied state propagates according to

x_{w}(t,ε)=x_{w}(τ,ε)+∫_{τ}^{t}f_{q}_{ᵢ}(x_{w}(s,ε),uₙ(s))ds:tεJ_{q}_{ᵢ}. (35)

By (29), Ψ(t)=D_{ε}x_{w}(t,ε)|_{ε→0}, hence differentiating (35) develops the variational equation,

$${D}_{ɛ} {x}_{w} ( t , 0 ) = {D}_{ɛ} {x}_{w} ( τ , 0 ) + {\int }_{τ}^{t} {D}_{x} {f}_{{q}_{i}} ( {x}_{w} ( s , 0 ) , {u}_{n} ( s ) ) {D}_{ɛ} {x}_{w} ( s , 0 ) d s \\ \begin{matrix}Ψ ( t ) = Ψ ( τ ) + {\int }_{τ}^{t} {D}_{x} {f}_{{q}_{i}} ( {x}_{n} ( s ) , {u}_{n} ( s ) ) Ψ ( s ) d s \\ = Ψ ( τ ) + {\int }_{τ}^{t} {A}_{{q}_{i}} ( s ) Ψ ( s ) d s .\end{matrix} \qquad ( 36 )$$

The term A_{q}_{ᵢ}(t) [symbol] Dₓf_{q}_{ᵢ}(xₙ(t),uₙ(t)):tεJ_{q}_{ᵢ} is the linearization about the (known) nominal state trajectory at qᵢ. Based on the initial condition (34), (36) is the solution to,

\dot{Ψ}A_{q}_{ᵢ}Ψ:tεJ_{q}_{ᵢ}, (37)
which governs the flow of the first-order state variation at qᵢ.

Propagation of Variations Through Locations

Assuming the control perturbation occurs at t=τ in location qᵢεQ, the expression,

$$\begin{matrix}{x}_{w} ( t , ɛ ) = {x}_{w} ( {t}_{i} + Δ {t}_{i}^{+} , ɛ ) + {\int }_{{t}_{i} + Δ {t}_{i}^{+}}^{t} {f}_{{q}_{i + 1}} ( {x}_{w} ( s , ɛ ) , {u}_{n} ( s ) ) d s \\ = {Ω}_{{q}_{i} , {q}_{i + 1}} ( {x}_{w} ( {t}_{i} + Δ {t}_{i}^{-} , ɛ ) ) + {\int }_{{t}_{i} + Δ {t}_{i}^{+}}^{t} {f}_{{q}_{i + 1}} ( {x}_{w} ( s , ɛ ) , {u}_{n} ( s ) ) d s \\ = {Ω}_{{q}_{i} , {q}_{i + 1}} ( {x}_{w} ( {t}_{i} , ɛ ) + {\int }_{{t}_{i}}^{{t}_{i} + Δ {t}_{i}^{-}} {f}_{q} ( {x}_{w} ( s , ɛ ) , {u}_{n} ( s ) ) d s ) + \\ {\int }_{{t}_{i} + Δ {t}_{i}^{+}}^{t} {f}_{{q}_{i + 1}} ( {x}_{w} ( s , ɛ ) , {u}_{n} ( s ) ) d s \text{:} t ∈ {𝒥}_{q + 1} ,\end{matrix} \qquad ( 38 )$$

propagates the varied system to location qᵢ₊₁. Note tᵢ is the time at which the nominal (unperturbed) state, xₙ, transitions between locations qᵢ and qᵢ₊₁, Δtᵢ [symbol] Δtᵢ(ε) is the change in transition time due to the state variations, and a “−” or “+” superscript (as in tᵢ+Δtᵢ⁻) indicates the time just before or after a transition. FIG. 17 shows how the control perturbation causes an update in transition time from tᵢ to tᵢ+Δtᵢ for the perturbed state. The figure depicts a scenario where the reset map, Ω_{q}_{ᵢ}ᵢ₊₁, causes the state's velocity to reflect (as in a collision) when Φ_{q}_{ᵢ}_{,q}_{ᵢ₊₁}(x) [symbol] x:xε [symbol] _{q}_{ᵢ} becomes 0 at x_{w}(tᵢ+Δtᵢ)=0.

As before, differentiating (38) as ε→0 provides the first-order variational equation for Ψ at qᵢ₊₁ due to a control perturbation at qᵢ,

$${D}_{ɛ} {x}_{w} ( t , 0 ) = {D}_{x} {Ω}_{{q}_{i} , {q}_{i + 1}} ( {x}_{w} ( {t}_{i}^{-} , 0 ) ) \frac{d {x}_{w} ( {t}_{i} + Δ {t}_{i}^{-} , ɛ )}{d ɛ} {\vert}_{ɛ -> 0} + {\int }_{{t}_{i} + Δ {t}_{i}^{+}}^{t} {D}_{x} {f}_{{q}_{i + 1}} ( {x}_{w} ( s , 0 ) , {u}_{n} ( s ) ) {D}_{ɛ} {x}_{w} ( s , 0 ) d s - \frac{d Δ {t}_{i}^{+}}{d ɛ} {\vert}_{ɛ -> 0} {f}_{{q}_{i + 1 }} ( {x}_{n} ( {t}_{i}^{+} ) , {u}_{n} ( {t}_{i}^{+} ) ) \\ Ψ ( t ) = {D}_{x} {Ω}_{{q}_{i} , {q}_{i + 1}} ( {x}_{n} ( {t}_{i}^{-} ) ) [ Ψ ( {t}_{i}^{-} ) + \frac{d Δ {t}_{i}}{d ɛ} {\vert}_{ɛ -> 0} {f}_{{q}_{i}} ( {x}_{n} ( {t}_{i}^{-} ) , {u}_{n} ( {t}_{i}^{-} ) ) ] - \frac{d Δ {t}_{i}}{d ɛ} {\vert}_{ɛ -> 0} {f}_{{q}_{i + 1}} ( {x}_{n} ( {t}_{i}^{+} ) , {u}_{n} ( {t}_{i}^{+} ) ) + {\int }_{{t}_{i}^{+}}^{t} {A}_{{q}_{i + 1 } ( s )} Ψ ( s ) d s . \qquad ( 39 )$$

This variational equation uses

$${\frac{d Δ {t}_{i}}{d ɛ} \vert}_{ɛ -> 0} .$$

The term is obtained by locally enforcing the guard equation,

Φ_{q}_{ᵢ}_{,q}_{ᵢ₊₁}(x_{w}(tᵢ+Δtᵢ⁻,ε))=0, (40)
based on the first-order Taylor expansion of (40) around ε→0,

$$0 = {Φ}_{{q}_{i} , {q}_{i + 1}} ( {x}_{n} ( {t}_{i}^{-} ) ) + {D}_{x} {Φ}_{{q}_{i} , {q}_{i + 1}} ( {x}_{n} ( {t}_{i}^{-} ) ) [ {f}_{{q}_{i}} ( {x}_{n} ( {t}_{i}^{-} ) , {u}_{n} ( {t}_{i}^{-} ) ) \frac{d Δ {t}_{i}}{d ɛ} {\vert}_{ɛ -> 0} + Ψ ( {t}_{i}^{-} ) ] + o ( ɛ ) .$$

Applying Φ_{q}_{ᵢ}_{,q}_{ᵢ₊₁}(xₙ(tᵢ⁻))=0 in the expansion yields,

$${\frac{d Δ {t}_{i}}{d ɛ} \vert}_{ɛ -> 0} = - \frac{{D}_{x} {Φ}_{{q}_{i} , {q}_{i + 1}} ( {x}_{n} ( {t}_{i}^{-} ) ) Ψ ( {t}_{i}^{-} )}{{D}_{x} {Φ}_{{q}_{i} , {q}_{i + 1}} ( {x}_{n} ( {t}_{i}^{-} ) ) {f}_{{q}_{i}} ( {x}_{n} ( {t}_{i}^{-} ) , {u}_{n} ( {t}_{i}^{-} ) )} . \qquad ( 41 )$$

Finally, determine a new reset term,

$${Π}_{{q}_{i} , {q}_{i + 1}} {=}^{Δ} {D}_{x} {Ω}_{{q}_{i} , {q}_{i + 1}} ( {x}_{n} ( {t}_{i}^{-} ) ) [ I - {f}_{{q}_{i}} ( {x}_{n} ( {t}_{i}^{-} ) , {u}_{n} ( {t}_{i}^{-} ) ) \frac{{D}_{x} {Φ}_{{q}_{i} , {q}_{i + 1}} ( {x}_{n} ( {t}_{i}^{-} ) )}{{D}_{x} {Φ}_{{q}_{i} , {q}_{i + 1 }} ( {x}_{n} ( {t}_{i}^{-} ) ) {f}_{{q}_{i}} ( {x}_{n} ( {t}_{i}^{-} ) , {u}_{n} ( {t}_{i}^{-} ) )} ] + {f}_{{q}_{i + 1}} ( {x}_{n} ( {t}_{i}^{+} ) , {u}_{n} ( {t}_{i}^{+} ) ) \frac{{D}_{x} {Φ}_{{q}_{i} , {q}_{i + 1}} ( {x}_{n} ( {t}_{i}^{-} ) )}{{D}_{x} {Φ}_{{q}_{i} , {q}_{i + 1}} ( {x}_{n} ( {t}_{i}^{-} ) ) {f}_{{q}_{i}} ( {x}_{n} ( {t}_{i}^{-} ) , {u}_{n} ( {t}_{i}^{-} ) )} , \qquad ( 42 )$$

such that plugging (36) and (41) into (39) reveals

$$\begin{matrix}Ψ ( t ) = {Π}_{{q}_{i} , {q}_{i + 1}} [ Ψ ( τ ) + {\int }_{τ}^{{t}_{i}^{-}} {A}_{{q}_{i}} ( s ) Ψ ( s ) d s ] + {\int }_{{t}_{i}^{+}}^{t} {A}_{{q}_{i + 1}} ( s ) Ψ ( s ) d s \\ = {Π}_{{q}_{i} , {q}_{i + 1}} Ψ ( {t}_{i}^{-} ) + {\int }_{{t}_{i}^{+}}^{t} {A}_{{q}_{i + 1}} ( s ) Ψ ( s ) d s \text{:} t ∈ {𝒥}_{i + 1} .\end{matrix} \qquad ( 43 )$$

Just as Ω_{q}_{ᵢ}_{,q}_{ᵢ₊₁} resets the state in (38), Π_{q}_{ᵢ}_{,q}_{ᵢ₊₁} provides a (linear) reset map for variations that transitions them between locations in (43).

Rather than calculate Ψ from (43), compute variations from a series of differential equations and resets. When the control perturbation occurs in location qᵢ, Ψ flows to qᵢ₊₁ based on,

$$Ψ {=}^{Δ} \{ \begin{matrix}( {f}_{{q}_{i}} ( {x}_{n} ( τ ) , w ) - {f}_{{q}_{i}} ( {x}_{n} ( τ ) , {u}_{n} ( τ ) ) ) a & \text{:} t = τ ∈ {𝒥}_{{q}_{i}} \\ \dot{Ψ} = {A}_{{q}_{i}} Ψ & \text{:} t ∈ ( τ , {t}_{i}^{-} ] \\ Ψ ( {t}_{i}^{+} ) = {Π}_{{q}_{i} , {q}_{i + 1}} Ψ ( {t}_{i}^{-} ) & \text{:} t = {t}_{i}^{+} \\ \dot{Ψ} = {A}_{{q}_{i + 1}} Ψ & \text{:} t ∈ ( {t}_{i}^{+} , {t}_{i + 1}^{-} ]\end{matrix} . \qquad ( 44 )$$

Note that if the nominal trajectory evolves through additional locations, each transition requires reset of Ψ at transition times according to (42). Variations continue according to the dynamics linearized about the nominal trajectory. Thus, by repeating computations in rows 2-4 of (44) between consecutive locations, variations can be propagated to t=t_{f}.

Sensitivity to Variations

Assume a series of incremental costs, {l_{q}_{ᵢ}εC¹( [symbol] _{q}_{ᵢ}×U_{q}_{ᵢ}, [symbol] )}_{q}_{ᵢ}_{εQ}, such that l=l_{q}_{ᵢ}:tεJ_{q}_{ᵢ}. Given (xₙ, q, J) resulting from nominal control, uₙ, the objective,

J=∫ₜ_{₀}^{t}^{_{f}}l(x(t),u(t))dt, (45)
measures performance of the hybrid trajectory. Note that by appending the incremental costs l_{q}_{ᵢ} to the dynamics vectors f_{q}_{ᵢ} in each location, the hybrid system is translated to Mayer form with (45) as an appended state. Objects with a bar refer to appended versions of hybrid system such that f̅_{q}_{ᵢ}=[l_{q}_{ᵢ},f_{q}_{ᵢ}^{T}]^{T}, x̅=[J,x^{T}]^{T}, and

$${{\overline{A}}_{{q}_{i}} = ( \begin{matrix}0 & {D}_{x} {l}_{{q}_{i}} \\ 0 & {A}_{{q}_{i}}\end{matrix} ) \vert}_{( {x}_{n} , {u}_{n} )} .$$

In Mayer form, it is straightforward to compute the first-order variation, δJ [symbol] εv, in system performance (45) due to a needle perturbation in the control at arbitrary (given) time τε[t₀,t_{f}]. One need only propagate appended state variations using the methods just introduced. The first component of Ψ̅(t_{f}) provides the direction, v(t_{f}), of the variation in (45) and ε is its magnitude. However, computing the variation direction, v(t_{f}), due to a control perturbation at a different time τ′≠τ, requires re-simulation of Ψ̅ from the new initial condition at Ψ̅(τ′). Hence, the process is computationally intensive.

To compute the first-order variation direction, v(t_{f}), resulting from a needle variation in the control at an arbitrary, unknown time τε[t₀,t_{f}], this section derives an adjoint system, ρ̅, to the variational system Ψ̅. The two systems are adjoint if,

$$\frac{d}{d t} ( \overline{ρ} \cdot \overline{Ψ} ) = 0 = {ρ}^{\dot{\_}} \cdot \overline{Ψ} + \overline{ρ} \cdot {Ψ}^{\dot{\_}} . \qquad ( 46 )$$

The adjoint system belongs to the tangent bundle, ρ̅εT* [symbol] _{q}_{ᵢ}, such that ρ̅(t):Tₓ [symbol] _{q}_{ᵢ} [symbol] [symbol] , ∀tεJ_{q}_{ᵢ},∀qᵢεq. That is, ρ̅·Ψ̅ is constant, a property that is enforced through differentiation in deriving the adjoint system. With a terminal condition, ρ̅(t_{f}), in which the first element of ρ̅(t_{f}) is 1 and the remaining elements are 0, the inner product ρ̅(t_{f})·Ψ̅(t_{f})=v(t_{f}). Because of (46), the inner product is constant and equal to v(t_{f}) for all time, ρ̅(t)·Ψ̅(t)=v(t_{f})∀tε[τ,t_{f}]. This property facilitates analysis of control perturbations at different times τε[t₀,t_{f}]. Assuming the system is at the (arbitrary) location qεQ at the perturbation time t=τ, the inner product in (46) yields

$$\begin{matrix}\overline{ρ} ( τ ) \cdot \overline{Ψ} ( τ ) = \overline{ρ} ( τ ) \cdot ( {\overline{f}}_{q} ( {x}_{n} ( τ ) , w ) - {\overline{f}}_{q} ( {x}_{n} ( τ ) , {u}_{n} ( τ ) ) ) a \\ = v ( {t}_{f} ) .\end{matrix} \qquad ( 47 )$$

Note that the initial time, τ, of the control perturbation is arbitrary and the right side of equation (47) provides the sensitivity of the cost to a control perturbation (e.g., it provides v(t_{f})) occurring at any time τε[t₀,t_{f}]. Because (46) implies the relationship, ρ̅·Ψ̅(t)=v(t_{f})∀tε[τ,t_{f}], is constant at times subsequent to the control perturbation, ρ̅ evaluated at any time can be interpreted as the sensitivity of (45) to the state variation at that time. At time t=el in (47), the state sensitivity is based on the initial condition (34) resulting from a needle variation in the control. When the direction of the needle variation is arbitrarily chosen as a=1, its duration is A=εa=E. In this case, evaluating (47) at any time τε[t₀,t_{f}] provides the sensitivity of (45) to the duration of a control needle perturbation applied at that time (e.g., v(t_{f})) in the same way as the mode insertion (4) described above. Considering two possible times τ<τ′ at which needle variations may be applied, v(t_{f}) would require separate simulations of ψ̅ from [τ,t_{f}] and [τ′,t_{f}]. One may also apply linear transformations to the variational system simulated from the perturbation at el based on superposition of the initial condition at τ′. Variational reset maps would require similar transformation. In contrast, a single (backwards) simulation of ρ̅ from [t_{f},τ] evaluated at τ and τ′ in (47) provides the performance sensitivity, v(t_{f}), for each case.

Relation to the Mode Insertion Gradient

In hybrid systems literature, the mode insertion gradient is derived for systems with incremental costs, l, which do not depend on the control (see (3)), and the state dimension is fixed, so f_{q}, and f_{q} are assumed to be of the same dimension (q, q′)εQ. Under these assumptions, the mode insertion gradient provides the sensitivity of J to insertion of a different dynamic mode (e.g., switching from f_{q} to the dynamics f_{q}, of an alternate location q′ for a short duration around λ→0+). In the case of SAC, the alternate dynamic modes differ only in control (e.g., f_{q}, [symbol] f_{q}(xₙ(τ), w) and f_{q} [symbol] f_{q}(xₙ(τ),uₙ(τ))) and so result in the form of the mode insertion gradient in (4) for smooth systems. The expression (47) provides SAC the same information (the sensitivity of a trajectory cost, J, to applying an infinitesimal action at some time) as the form of the mode insertion gradient in (4) but applies to hybrid impulsive systems with resets. The equation (47) is equivalent to the mode insertion gradient formula in (4) when w corresponds to an optimal infinitesimal action, the incremental costs, l, do not depend on the control (see (3)), and the system is not hybrid (locations qᵢ and qᵢ₊₁ are the same).

Using the methods presented, modify the initial condition of the variational equation (34) to accommodate an arbitrary dynamic mode insertion, f_{q′}, rather than a control perturbation. Note the formulas for the variational flow (44) and its corresponding adjoint equation, which is derived in the subsequent subsection, remain unchanged. In this case, (47) becomes the more general form of the mode insertion gradient from hybrid systems literature (as it considers more than just control perturbations), but applies to broader classes of hybrid impulsive systems with resets. Hence, the derivations and hybrid adjoint and mode insertion gradient calculations (47) can enable mode scheduling algorithms for these larger classes of hybrid and impulsive systems.

Adjoint Simulation

To compute the sensitivity of a cost functional to control perturbations using (47), develop an expression governing the adjoint system, ρ̅, that maintains its interpretation as the sensitivity of the cost to state variations, as in ρ̅(t)·Ψ̅(t)=v(t_{f})∀tε[τ,t_{f}]. First, assume the system is in location qᵢ₊₁ at final time t=t_{f} and that the needle perturbation in the control occurred at t=τ in the same location. The state variations will flow forward on [τ,t_{f}] with (34) (replacing qᵢ with qᵢ₊₁ and the dynamics with appended versions) as an initial condition under dynamics \overline{\dot{Ψ}}=Ā_{q}_{ᵢ₊₁}Ψ̅. In this location, \overline{\dot{ρ}}=−Ā_{q}_{ᵢ₊₁}^{T}ρ̅ satisfies (46) and so is adjoint to Ψ̅. With its dynamics determined, ρ̅ is obtained by simulation from an appropriate initial/terminal condition. As just described, choosing

$$\overline{ρ} ( {t}_{f} ) = {[ 1 , 0 , … , 0 ]}^{T} ∈ {{n}_{{q}_{i + 1}}}^{}$$

as the terminal condition maintains the desired relationship, ρ̅(t)·Ψ̅(t)=v(t_{f})∀tε[ε,t_{f}].

Now consider the case where the system is in location qᵢ₊₁ at the final time, t=t_{f}, and that the needle perturbation in the control occurred at t=τ in location qᵢ. The variational system evolves according to (44). The adjoint system follows the same differential equation, \overline{\dot{ρ}}=−Ā_{q}_{ᵢ₊₁}^{T}ρ̅, and terminal condition as in the previous case. The adjoint flows backwards in time until the variational equation jumps at tᵢ. The corresponding adjoint reset map is derived by enforcing (46) at tᵢ. As such, the inner product of the adjoint and variational equations are constant from tε[tᵢ⁻,tᵢ⁺],

$$\frac{d ( \overline{ρ} ( {t}_{i} ) \cdot \overline{Ψ} ( {t}_{i} ) )}{d t} = 0 = \frac{\overline{ρ} ( {t}_{i}^{+} ) \cdot \overline{Ψ} ( {t}_{i}^{+} ) - \overline{ρ} ( {t}_{i}^{-} ) \cdot \overline{Ψ} ( {t}_{i}^{-} )}{{t}_{i}^{+} - {t}_{i}^{-}}$$

$$0 = \overline{ρ} ( {t}_{i}^{+} ) \cdot {\overline{Π}}_{{q}_{i} , {q}_{i + 1}} \overline{Ψ} ( {t}_{i}^{-} ) - ρ ( {t}_{i}^{-} ) - ρ ( {t}_{i}^{-} ) \cdot \overline{Ψ} ( {t}_{i}^{-} )$$

$$\overline{ρ} ( {t}_{i}^{-} ) = {\overline{Π}}_{{q}_{i} , {q}_{i + 1}}^{T} \overline{ρ} ( {t}_{i}^{+} ) ,$$

The final expression provides the reset map required to flow ρ̅ backwards from tᵢ⁺ in location qᵢ₊₁ to tᵢ⁻ in location qᵢ. Once in location qᵢ, the flow evolves according to the dynamics \overline{\dot{ρ}}=−Ā_{q}_{ᵢ}^{T}ρ̅ to remain adjoint to Ψ̅ until t=τεJ_{q}_{ᵢ}. Thus the adjoint satisfies

$$\overline{ρ} {=}^{Δ} \{ \begin{matrix}{[ 1 , 0 , … , 0 ]}^{T} & \text{:} t = {t}_{f} \\ {ρ}^{\dot{\_}} = - {\overline{A}}_{{q}_{i + 1}}^{T} \overline{ρ} & \text{:} t ∈ [ {t}_{i}^{+} , {t}_{f} ) \\ \overline{ρ} ( {t}_{i}^{-} ) = {\overline{Π}}_{{q}_{i} , {q}_{i + 1}}^{T} \overline{ρ} ( {t}_{i}^{+} ) & \text{:} t = {t}_{i}^{-} \\ {ρ}^{\dot{\_}} = - {\overline{A}}_{{q}_{i}}^{T} \overline{ρ} & \text{:} t ∈ [ τ , {t}_{i + 1}^{-} )\end{matrix} . \qquad ( 48 )$$

As for the variational equation, propagate ρ̅ between arbitrary numbers of consecutive modes by repeating the reset and continuous flow steps.

A Terminal Objective

The previous subsection shows that deriving the adjoint equation based on the terminal condition ρ̅(t_{f})=[1, 0, . . . , 0]^{T} results in a constant inner product, ρ̅(t)·Ψ̅(t)=v(t_{f})∀tε[τ,t_{f}]. It is this choice that allows interpretation of (47) as the sensitivity of the performance objective (45) to a needle variation in the control that may occur at any time τε[t₀,t_{f}]. Similarly, ρ̅(τ) is the sensitivity of the objective to state perturbations for τε[t₀,t_{f}]. This subsection derives a terminal condition that maintains ρ̅(t)·Ψ̅(t)=v(t_{f}) and the meaning of ρ̅ and (47) when (45) includes terminal cost mapping, m, such that {m_{q}_{ᵢ}εC¹( [symbol] _{q}_{ᵢ}, [symbol] )}_{q}_{ᵢ}_{εQ}, m=m_{q}_{ᵢ}:tεJ_{q}_{ᵢ}, and

J=∫ₜ_{₀}^{t}^{_{f}}l(x(t),u(t))dt+m(x(t_{f})). (49)

Again, by setting the first element of ρ̅ to 1, the inner product ρ̅(t_{f})·Ψ̅(t_{f}) includes the direction of variation in the incremental cost component, ∫ₜ_{₀}^{t}^{_{f}}l(x(t),u(t))dt, when the state is in Mayer form. By adding the direction of variation in m(x(t_{f})), one obtains the new variation direction v(t_{f}) for (49). The derivative of m(x(t_{f})) as ε→0,

D_{ε}m(x_{w}(t_{f},0))=Dₓm(x(t_{f}))Ψ(t_{f}), (50)
provides the first-order direction of variation in the terminal cost. Note (50) is an inner product of the (known) gradient ∇m(x(t_{f})) and the (un-appended) direction of state variation at the final time Ψ(t_{f}). Hence, the variation direction for the performance objective is provided as v(t_{f})=[1,Dₓm(x(t_{f}))]Ψ̅(t_{f}) when J includes a terminal cost. With the new terminal condition,

ρ̅(t_{f})=[1,Dₓm(x(t_{f}))]^{T}, (51)
the adjoint relationship ensures ρ̅(t)·Ψ̅(t) and (47) are equal to v(t_{f})∀tε[τ,t_{f}] and ∀τε[t₀,t_{f}].

### Illustrative Examples

FIG. 18 is a graph of an example mass dropped from a height, e.g., the height z(t) of a mass dropped from 1 m. The mass follows the nominal trajectory 1800, zₙ, and bounces at impact due to an elastic collision. The reset map reflects its velocity in transitioning from location q₁ to q₂. The curve 1802 is the varied trajectory based on the hybrid impulsive dynamics and application of a needle variation at τ=0.1 s of duration τ=0.1 s (a=1, ε=0.1 s) in the nominal control. The variation accelerates the mass in the z direction at

$$w = - 5 \frac{m}{{s}^{2 }} .$$

The curve 1664 is the approximated system trajectory based on the first-order variational model.

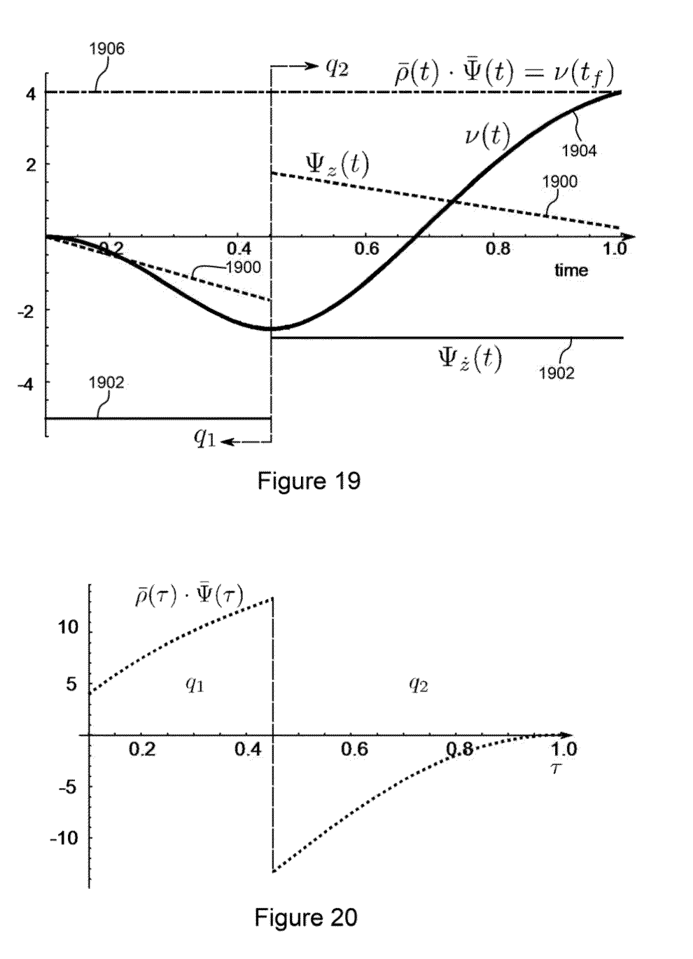

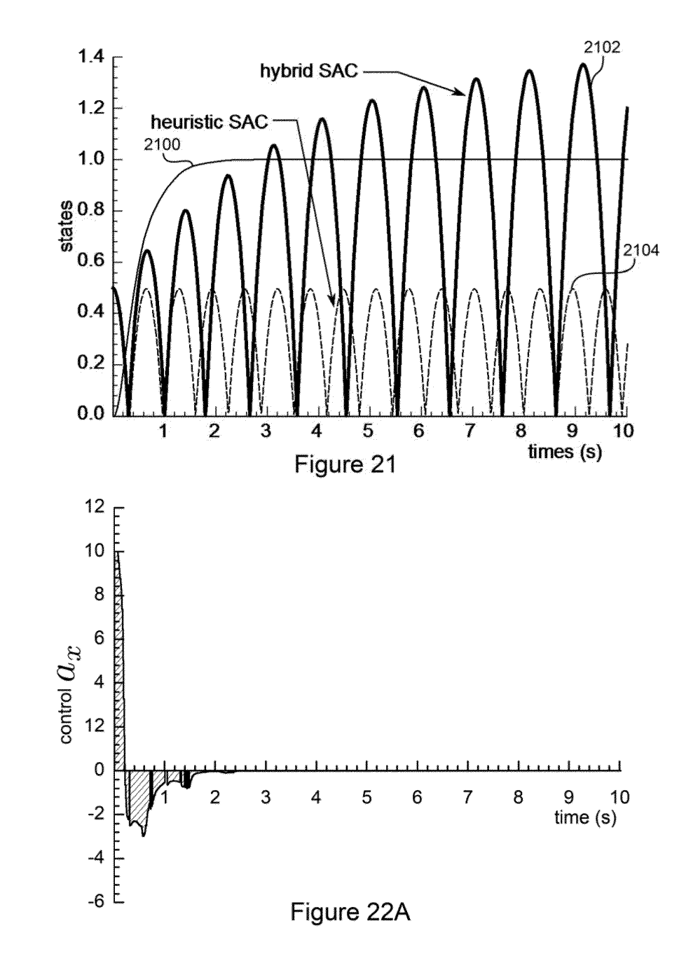

The following provides two illustrative examples using the systems and methods described in this chapter, e.g., with regard to the SAC process 100. FIGS. 19 and 20 are graphs including a 1D example to demonstrate the calculation of the variational equation, adjoint equation, and the sensitivity of a cost to control (47). FIG. 21 is a graph of an example to use (47) (based on the adjoint in (48)) to amend SAC calculations in order to control a bouncing ball through impacts and toward a goal state.

In FIG. 19, the direction of state (and cost) variations, Ψ̅=(v, Ψ_{z}, Ψ_{ż}), resulting from a needle variation at τ=0.1 s of duration λ=0.1 s (a=1, ε=0.1 s) in the nominal control. The control variation accelerates the falling mass in the z direction at

$$w = - 5 \frac{m}{{s}^{2 }} .$$

At all times subsequent the control variation, ∀tε[τ,t_{f}], the inner product ρ̅(t)·Ψ̅(t) is constant and equal to the direction of variation in the cost propagated to the final time, v(t_{f}). The state variations in the z and ż directions are discontinuous at the transition between locations q₁ and q₂, while the variation in cost, which corresponds to v(t), is continuous.

In FIG. 20, the value of ρ̅(τ)·Ψ̅(τ) (according to (47)) for different values of τ. The term indicates the sensitivity of the performance objective to the control perturbation,

$$w = - 5 \frac{m}{{s}^{2 }} ,$$

if that perturbation were to occur at different points in time τε[t₀,t_{f}]. Before the impact, (47) indicate a short control perturbation will increase cost (49). In contrast, ρ̅(τ)·Ψ̅(τ)<0 after impact, indicating that accelerating the mass toward the ground after impact will reduce cost (it keeps the system closer to the origin, which is the goal specified by the choice of l(x(t),u(t)) in (49)).

Variations, Adjoint, and Control Sensitivity for a 1D Bouncing Mass

Referring to FIGS. 18-20, the systems and methods can compute variational and adjoint equations for a simple point mass system with impacts. The point mass is released from a height of z₀=1 m with no initial velocity. It falls under gravity until it impacts with a flat surface (guard) at z=0 m. The dynamics before and after impact (locations q₁ and q₂, respectively) are the same, corresponding to a point mass in gravity. However, a reset map reflects velocity, 2, when the guard becomes 0 at impact. The system and control parameters for simulation results follow.

| System Parameters: | |
|---|---|
| x = [z, ż]^{T} | f_{q}_{₁} (x, u) =[ż, −g + u]^{T} |
| $g = 9.81 \frac{m}{{s}^{2}}$ | f_{q}_{₂} (x, u) = f_{q}_{₁} (x, u) |
| J = ∫ₜ_{₀} ^{t}^{_{f}} x^{T} Q x dt | Q = Diag[200, 0.01] |
| Ω_{q}_{₁}_{,q}_{₂} = Diag[1, −1] | Φ_{q}_{₁}_{,q}_{₂} (x(t)) = z(t) |

| Control Perturbation: | |
|---|---|
| ${u}_{n} = 0 \frac{m}{{s}^{2}}$ | τ = 0.1 s |
| a = 1 | ε = 0.1s |
| $w = - 5 \frac{m}{{s}^{2}}$ | λ = 0.1 s |

FIG. 18 shows the system's nominal trajectory (curve 1800) and the varied trajectory resulting from a simulated needle variation in control (see the control perturbation parameters). The varied trajectory is computed from both the first-order variational model (curve 1804) and the true, nonlinear hybrid impulsive dynamics (curve 1802). The variation directions resulting from (44) are in FIG. 19. In FIG. 19, the state variations (corresponding to the curve 1900 and curve 1902) are discontinuous at impact, while the direction of the cost variation, v(t) (curve 1904), is continuous over time. The line 1906 in FIG. 19 confirms the inner product, ρ̅·Ψ̅, is constant and equal to the direction of the cost variation, v(t_{f}), for all time subsequent the control perturbation, ∀tε[τ,t_{f}]. In FIG. 20, this inner product (the value of (47)) would change if the control perturbation were applied at different times, τε[t₀,t_{f}]. Supporting numerical results follow.

$${Results \text{:} \\ \overline{ρ} ( τ ) \cdot \overline{Ψ} ( τ ) \vert}_{τ = 0.1} = 4$$

$$v ( {t}_{f} ) = {[ 1 , 0 , 0 ]}^{T} \cdot \overline{Ψ} ( {t}_{f} ) = 4$$

$$Δ {t}_{i} \approx ɛ \times \frac{d Δ {t}_{i}}{d ɛ} {\vert}_{ɛ -> 0} = - 0.04 s$$

$${Π}_{{q}_{1} , {q}_{2}} = ( \begin{matrix}- 1 & 0 \\ \frac{- 2 g + 2 u}{\dot{z}} & - 1\end{matrix} )$$

As described earlier, the approximation of the change in cost (49) from (47) agrees with the first-order approximation of the change in cost from simulation of Ψ̅(t_{f}). The first-order variational model, zₙ+εΨ, in FIG. 18 closely approximates the true perturbed trajectory, z_{w}, simulated from the perturbed control and the nonlinear dynamics. Additionally, (41) estimates the impact time of the varied system as t=0.41 s, which is near the updated impact time of z_{w} as in FIG. 18.

Furthermore, in FIG. 20 equation (47) correctly indicates it is helpful (reduce trajectory cost according to (49)) to apply the control perturbation (push the mass toward the ground) after impact, when the ball is moving away from the ground. Similarly, the figure suggests it is detrimental to apply the control perturbation before impact because it results in a net gain (positive change) in trajectory cost according to the first-order model. These results are intuitive considering the incremental cost in (49) is selected to accumulate error between the mass trajectory and the origin.

Note that the reset map, Π_{q}_{₁}_{,q}_{₂}, is only determined for velocities ż that are non-zero. As is typical for hybrid systems, these methods require that some component of the system's velocity vector lie in the direction of the switching surface so as to preclude grazing impacts. By providing DₓΦ_{q,q′}(xₙ(tᵢ⁻))f_{q}_{ᵢ}(xₙ(tᵢ⁻),uₙ(tᵢ⁻))≠0∀(q,q′)εQ, the requirement ensures both (41) and (42) are determined.

Control of a Bouncing Ball

In FIG. 21, the SAC process 100 described above with the adjoint variable (48) is used to develop closed-loop controls on-line that drive a hybrid impulsive bouncing ball model toward different desired states. The first term of the appended adjoint is always 1 and can be stripped to obtain an unappended version of the hybrid adjoint, ρ, which can be applied to unappended dynamics exactly as in (4) when the incremental cost does not depend on the control (as in (3)). The system state vector consists of the 2D position and velocity of the ball, x=(x_{b}, Z_{b}, \dot{x}_{b}, ż_{b}). The system inputs are constrained accelerations,

$$u = ( {a}_{x} , {a}_{z} ) \text{:} {a}_{x} ∈ [ - 10 , 10 ] \frac{m}{{s}^{2}} , {a}_{z} ∈ [ - 10 , 0 ] \frac{m}{{s}^{2}} ,$$

such that the dynamics are

$${f}_{q} ( x , u ) = ( \begin{matrix}{\dot{x}}_{b} \\ {\dot{z}}_{b} \\ {a}_{x} \\ {a}_{z} - g\end{matrix} ) \text{:} ∀ q ∈ Q .$$

As in the previous example, impacts are modeled as being conservative and so reflect velocity orthogonal to the impact surface.

In FIG. 21, the SAC process 100 accelerates the ball to the right until its horizontal position, x_{b} (curve 2100), is at the desired point 1 m away. The SAC process 100 does not have the ability to accelerate the ball against gravity (because of control constraints) and so cannot come to rest at the desired height. Instead, SAC process 100 accelerates the ball into the floor to rebound and increase its height, z_{b} (curve 2102), until it bounces in a way that maximizes the time spent around the desired height of 1 m. If the SAC process 100 is applied as a heuristic (without the hybrid modifications), SAC process 100 drives the ball to the desired horizontal position but does not apply any control in the a_{z} direction. As such, the ball will continuously bounce at the initial height (curve 2104).

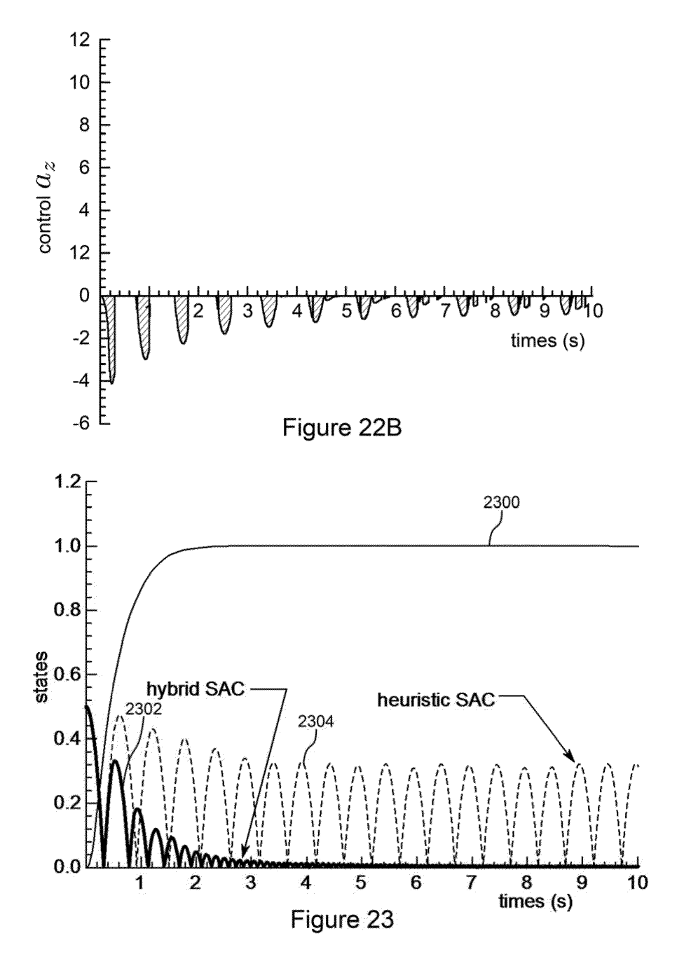

FIGS. 22A-B are graphs of example accelerations SAC applies in the horizontal (see FIG. 22A) and vertical (see FIG. 22B) directions. Because of control constraints on a_{z}, SAC cannot accelerate the ball against gravity and so SAC accelerates it into the floor to increase its height upon rebound. Without the hybrid impulsive extension to the adjoint equation (48), SAC may be unable to increase the height of the ball.

The SAC process 100 is initialized from half a meter off the ground, xᵢₙᵢₜ=(0, 0.5 m, 0, 0), and results are presented for two different tracking scenarios assuming a flat floor at z_{b}=0 m as the impact surface (guard). In the first case, SAC can use the quadratic tracking cost (17) with Q=Diag[0, 10, 0, 0], P=Diag[10, 0, 0, 0], and applies R=Diag[1,1] with T=0.5 s, γ=−10, and feedback sampling at 100 Hz. In each scenario the algorithm is specified with parameters that cause it to skip the (optional) control search process described above as it is unnecessary for this simple case and provides similar results. In this scenario, SAC process 100 is set to minimize L₂ error between the trajectory of the ball and a desired state a meter to the right of its starting position and one meter above the ground, x_{d}=(1 m, 1 m, 0, 0). The 10 s closed-loop tracking results included in FIGS. 21 and 22A-B use 0.21 s to simulate using the C++ SAC implementation.

As SAC is able to accelerate the ball in both horizontal directions, it easily reaches the desired horizontal position 1 m away. Due to the control constraints on a_{z} however, SAC cannot fight gravity as required to stabilize to the desired height. Instead, in FIG. 22B SAC accelerates the ball into the ground in order to increase its height after impact. The behavior is noteworthy because it cannot be achieved without the modifications to the adjoint variable (48). That is, applying the SAC algorithm derived for differentiable systems above approximately result in the a, control in FIG. 22A, but SAC may not apply any a, control and the ball continuously bounces at the initial height (see curve 2104 in FIG. 21). Without the jump terms in the adjoint simulation (from reset map Π_{q,q′}), the mode insertion gradient (4) does not switch signs at impact events as in FIG. 20 and so does not accurately model the sensitivity to control actions.

Though the hybrid extensions control this simple system, the following description includes a hybrid locomotion example where SAC controls a spring-loaded inverted pendulum hopping model up stairs in 3D using only the methods described above as a heuristic. Empirically, systems with more degrees of freedom (especially with respect to free dynamics) are often easier to control by SAC and permit such heuristics. In part, this is due to the fact that SAC's closed-loop synthesis approach compensates for modest model inaccuracies. Additionally, while systems with more interesting free dynamics/degrees of freedom are harder to control by alternative methods, they provide SAC more control authority in some respects. Their natural dynamics sweep through more of the state space and therefore allow SAC to consider the effect of actions in a wide variety of directions (or SAC can wait and take advantage of free dynamical motion directly). In either case, the systems and methods introduced provide for SAC to handle hybrid impulsive events.

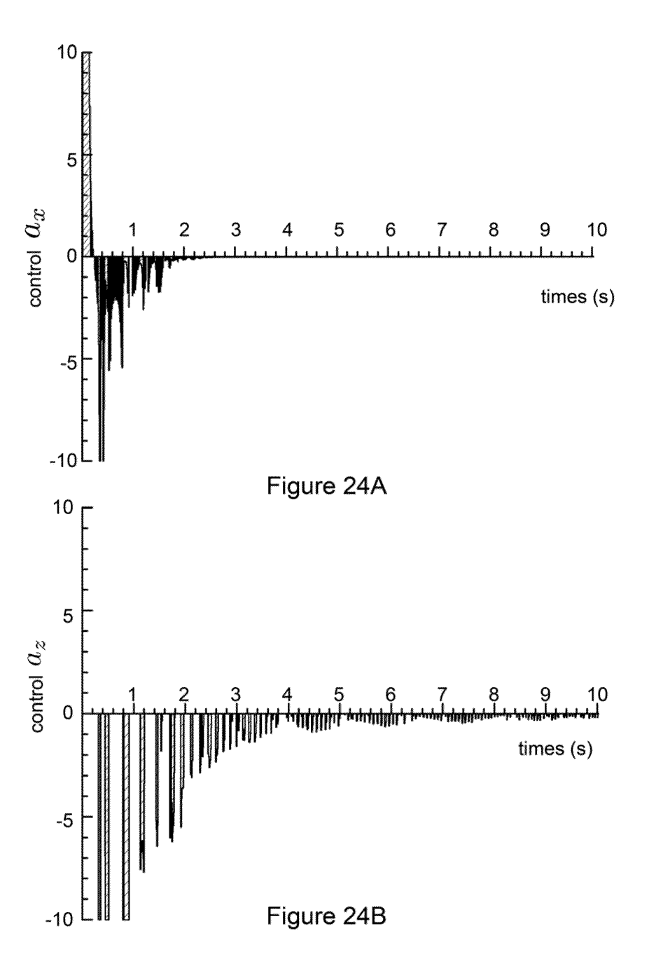

FIG. 23 and FIGS. 24A-B are graphs of example results obtained in a scenario where SAC is specified to track the desired state, x_{d}=(1 m, 0, 0, 0), which is also 1 m from the starting position but on the ground. Results take 0.29 s to compute and are based on all the same parameters previously mentioned but with Q=Diag[0, 0, 0, 10], so that the cost includes errors on horizontal position (from the P matrix specifying the terminal cost) and vertical velocity. In FIG. 23, the SAC process 100 accelerates the ball to the right until its horizontal position, x_{b} (curve 2300), is at the desired point 1 m away. The SAC process 100 removes energy from the (conservative) system by accelerating the ball toward the floor when its momentum is away from the floor (see FIGS. 24A-B). Though it gets indistinguishably close, the height of the ball, z_{b} (curve 2302), cannot come to rest on the ground or it would result in infinite switching. If the SAC process 100 is applied as a heuristic, SAC drives the ball to the desired horizontal position but cannot reduce the bouncing height below z_{b}≈0.3 m (curve 2304). In FIGS. 24A-B, the accelerations SAC applies in the horizontal (see FIG. 24A) and vertical (see FIG. 24B) directions. Because of control constraints on a_{z}, SAC cannot accelerate the ball against gravity, instead SAC removes energy from this conservative system by accelerating the ball toward the ground when its momentum is away from the floor.

Because the system is conservative, SAC applies control authority in the a, direction to remove energy. As SAC can only accelerate the ball into the ground, the algorithm waits until the ball's momentum carries it upward and away from the floor to apply control, a_{z}. Though the ball appears to reach the desired state, this is actually impossible because it would require infinite switching. The scenario shows that in practice, SAC can handle such degenerate cases (which are typically assumed away by design in hybrid system literature) gracefully.

By applying the smooth version of SAC process 100 to this control scenario, the algorithm controls the ball to the desired horizontal point. While the SAC process 100 reduces the height of the ball from the initial value of 0.5 m to approximately 0.3 m, it ceases to make progress beyond this point (see curve 2304 in FIG. 23). By reducing the receding time horizon, T, it is possible to recover results similar to those produced by the hybrid version of SAC in FIGS. 22-25 (T=0.25 s yields similar results). This highlights the fact that the mode insertion gradient (4) provides a poor model for hybrid systems with many switching events. Using shorter time horizons reduces the number of mode transitions that are accounted for in computing the adjoint and increases the likelihood that (4) is accurate (or close enough) over at least some portion of the system's trajectory.

Automating Control

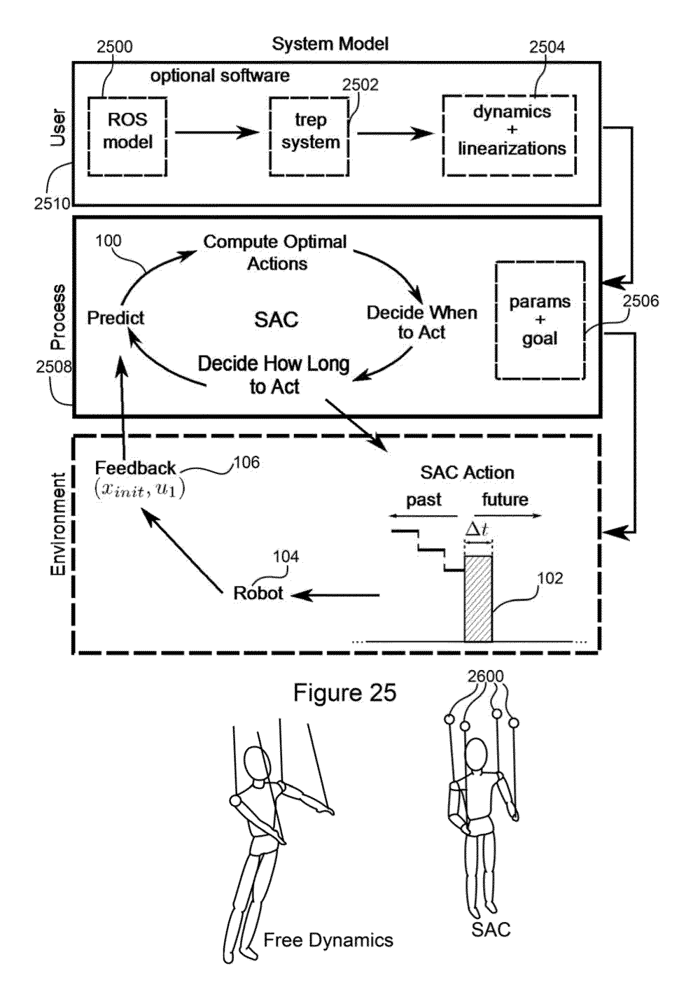

FIG. 25 is a system and flow diagram of another exemplary SAC process 100. Examples presented show SAC can take advantage of dynamics to develop constrained optimal actions on-line that outperform off-line nonlinear trajectory optimization on benchmark control problems. While these examples represent challenging control tasks, they may be limited to nonlinear systems of state dimension ≦8 where dynamics (and linearizations) are directly provided by users. In contrast, the discussions and examples provided here highlight the scalable and automated nature of SAC control synthesis and indicate that it can apply to a variety of more complicated robotic systems. The following describes an implementation of SAC process 100 that allows users to specify a high-level robot model using the Robot Operating System (ROS) URDF schema 2500. With another open-source software package, trep 2502, to derive dynamics and linearizations 2504 that enforce state constraints, results demonstrate the approach computes (state and control) constrained trajectories for closed-loop pose control of an underactuated 56-state marionette model using 4 strings.

Users can specify a robot model as a ROS URDF 2500, a trep system 2502, or directly encode the dynamics and linearizations. Users can specify a tracking goal and SAC algorithm parameters v (typ. 2-3 scalar parameters require tuning). The SAC process 100 follows the cyclic process depicted in the process box 2508 to sequence optimal actions into a piecewise continuous closed-loop response to state.

In addition to scaling to large systems, simulations apply the same SAC approach to a popular dynamic running model known as the spring-loaded inverted pendulum (SLIP). The SLIP is a nonlinear underactuated hybrid system with impacts that provides a relatively low-dimensional representation of the center of mass dynamics and energetics of running for a wide variety of animal species. A number of robots have been designed according to this model, while others use it a template for control.

Like other hybrid and impacting systems, robots based on the SLIP model usually require highly specialized control designed for a particular system. In the case of the SLIP, state-of-the-art techniques rely on separate controllers regulating the system according to determined goals 2506. These are often designed to achieve prescribed touchdown angles that produce stable running gaits and to maintain energy during stance for disturbance rejection. In contrast, the SAC process 100 requires little domain/system specific knowledge to control the SLIP. Through tracking goals 2506 encoding the desired direction of motion, SAC can directly use the system's dynamic model and automatically plans leg placement and touchdown angles on-line that account for terrain. Beyond accommodating nominal terrain variations, SAC process 100 can scale significant obstacles like stairs while accounting for swing-leg motion. Alternative methods often focus on designing touchdown angle and ignore swing leg motion even though the swing leg can impact ledges (e.g., moving up stairs) that would cause a real robot to fall.

Software Interfaces

Though non-traditional, SAC process 100 is relatively easy to implement in code and offers a highly automated synthesis process based on high-level system models. The examples use the same underlying C++ implementation, which interfaces with users and the environment FIG. 25. The SAC implementation relies only on open-loop simulations (2) and (5), which are obtained directly from robot models using first-order information and a default cost (the Predict phase in FIG. 25). Optimal actions can be hard coded based on an analytical expression (8) with u₁=0 as the default control (the Compute Optimal Actions phase in FIG. 25). Finally, a single pre-coded and parallelizeable numeric optimization is performed to approximate the best time to act (15) and a line search determines the duration (phases Decide When to Act and Decide How Long to Act in FIG. 25). Of the parameters described, only the prediction horizon T, desired rate improvement γ, and a binary variable that determines if SAC should skip the process of choosing when to act (useful in “greedy” tracking problems) can include tuning. As described above, α_{d} is specified as a proportional feedback law based on the current (receding horizon) trajectory cost simulated before SAC action, α_{d}=−γJ_{1,init}.

To specify the system model for control computations, SAC implementations rely on users to supply the dynamics and linearizations of the robot under SAC control. Note that linearizations can be obtained from system dynamics using modern symbolic algebra software in Python, MATLAB, Mathematica, etc. For (dynamically) simple robots these are often manually encoded and directly linked. As this may be impractical for larger systems, SAC implementations can interface with existing software for scalability (see the User box 2510 in FIG. 25).

While existing software packages provide dynamics and linearizations from high-level robot models, SAC implementations provide the option for users to specify the robot model as a ROS URDF. This is primarily due to the URDF model's widespread use in the robotics community and simple XML based schema. Through publicly available APIs, custom middleware maps the URDF model to a system model used by an open-source package for mechanical simulation and optimization known as trep 2502. The user also has the option to specify a trep system directly. The SAC library uses trep's C-language API to provide required dynamics and linearizations. The library interfaces with trep for several reasons. First, it is integrated in ROS 2500 and provides access to ROS's tools for analyzing, simulating, and graphing results. Additionally, trep 2502 offers numerical advantages. It uses efficient tree structures to represent mechanical systems, provides structured integration and linearizations, and can directly incorporate constraints specified in robot models into dynamics and linearizations through forced Euler-Lagrange equations. Other types of systems can be used.

To simplify the process of encoding of the control objective and any SAC parameters that may be required by the user, the implementations provide both C++ and Python APIs. There is rarely a need to tune more than 2-3 key parameters, the SAC library uses a default set of parameters and cost function and users adjust only as required. Since a quadratic trajectory tracking objective (17) tends to be sufficient for control of a surprising number of robotic systems, this form of trajectory cost is used by default. Even the weights in Q, R, and P require little or no attention. This is notable considering these matrices require significant tuning in traditional nonlinear trajectory optimization.

### Example Simulations

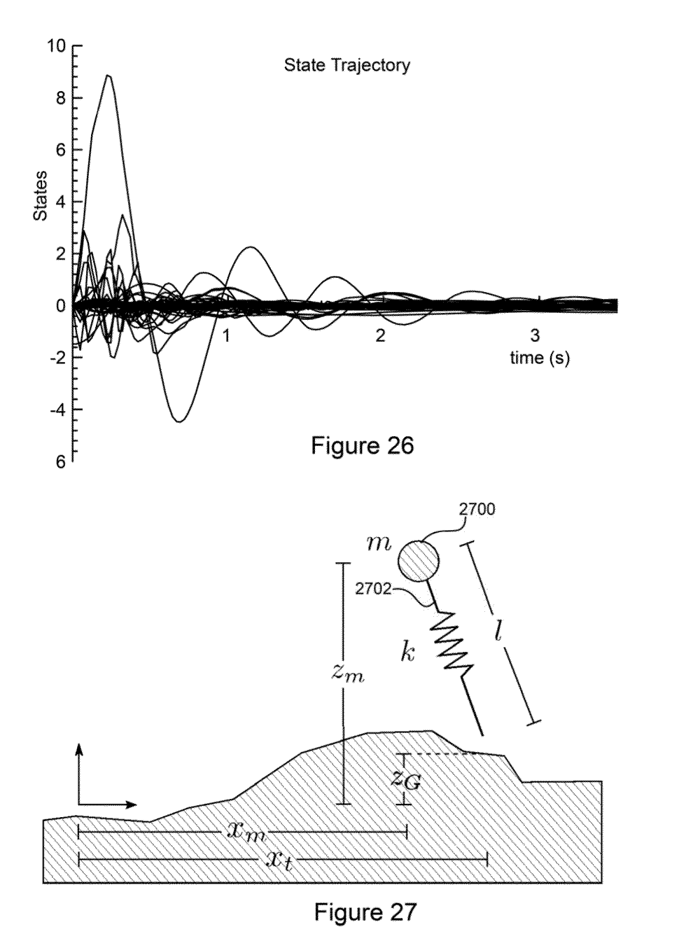

FIG. 26 is a diagram of an example marionette system and corresponding graph of example state trajectories. SAC process 100 automates pose control of a constrained and underactuated nonlinear marionette model with 56 states and 8 controls based on a real robot controlled marionette system. The user specifies the marionette model as a URDF and SAC uses a determined quadratic objective to compute constrained controls in closed-loop that move four strings endpoints 2600 to transition to a desired (at the origin). The trep software computes Lagrange multipliers to enforce string length constraints in the dynamics and linearizations it provides from the URDF. Simulations include a high-dimensional control example for a nonlinear constrained continuous system that shows SAC implementations can utilize existing software for improved scalability. A hybrid system example shows the same SAC implementation can automate dynamic locomotion over uneven terrain with impacts. These examples indicate potential application for a wide variety of robotic systems.

### Continuous System Example

### Marionette Pose Control

To illustrate the ease and scalability of SAC control synthesis using the implementation and software interfaces (e.g., ROS and trep) described, SAC can be applied in simulation to control an underactuated, state and control constrained (nonlinear) marionette model with 56 states and 8 controls. Note that trep's use of generalized coordinates reduces model dimension. Other choices of representation can lead to as many as 124 states (9 rigid bodies εSO(3) and four string endpoints with 8 DOF). The model parameters can be validated experimentally and are based on a real (physical) robot controlled marionette system. Results are included in FIG. 26.

FIG. 26 reflects a pose control example in which SAC moves 4 string endpoints (green points) to drive the marionette model from an initial pose with the left arm raised, to a desired pose, specified as the origin (top right), while keeping the rest of the body stationary. Computations are based on a URDF model specified by the user, where trep automatically enforces string length constraints in derived dynamics and linearizations. The marionette URDF system model is too large to be included here, but is provided (along with model parameters) in the Appendix. Control min/max saturation constraints are arbitrarily specified through a Python front-end as

$$\pm 1 \frac{m}{s} ,$$

along with the desired feedback sampling rate of 40 Hz. All other parameters are based on default values (no tuning), and the default quadratic tracking objective (17) tracks an arbitrarily specified desired pose. By default, Q, R, and P₁ are identity matrices to provide quadratic Euclidean norms on state tracking errors and control effort at each point in time. The example emphasizes SAC's relative insensitivity to local minima, and, relatedly, the choice of weights in the Q, R, and P₁ matrices. The 56×56 dimensional state weighting matrices is difficult to adjust even using sample based methods from the machine learning community.

While the example is not yet real-time (controlled simulations run on a laptop at ≈150×real time), it is orders of magnitude faster than alternatives. Based on experiments with nonlinear trajectory optimization methods provided with trep, pose control is usually very slow and often unsuccessful as there are many local minima. It is also worth noting that the current implementation relies on interpreted and run-time code that would be straightforward to pre-compile. Combined with parameter optimization, it is likely that real-time control for systems of similar size is possible on standard hardware.

### Hybrid System Example

### The SLIP Model

FIG. 27 is a block diagram of example planar configuration variables for the SLIP system. The full 3D model includes the location of the toe and mass (yₘ, yₜ) along an axis pointing into the page (according to a right-hand coordinate frame). In FIG. 27, the same SAC implementation previously described and applied to continuous nonlinear systems is capable of controlling an underactuated nonlinear hybrid system including impacts. Though this SLIP example is a hybrid system, the control approach uses the methods discussed above (derived for continuous system) as a heuristic substitute for the hybrid methods discussed above. This heuristic approach avoids the need to reset the adjoint variable between switching events. Results are provided for a spring-loaded inverted pendulum (SLIP) model commonly applied in 3D dynamic hopping and running. FIG. 27 shows a planar version of the model, which includes a point mass 2700 attached to a spring 2702. The state, x=(xₘ, \dot{x}ₘ, yₘ, \dot{y}ₘ, zₘ, żₘ, xₜ, yₜ), includes the 3D position and velocities of the center of mass followed by planar “toe” coordinates (xₜ, yₜ) corresponding to the spring endpoint.

The dynamics of the SLIP are hybrid and include two modes/phases: 1) a flight phase where the toe endpoint is in the air and 2) a stance phase where the toe is in rolling contact with the ground. The length, l, of the SLIP model matches the resting length of the spring, l=l₀, in flight and

l=\sqrt{(xₘ−xₜ)²+(yₘ−yₜ)²+(zₘ−z_{G})²} (52)
in the stance phase. The z_{G} term in (52) tracks the height of the terrain at the location of the toe. Note that (52) assumes the model is in the stance phase where z_{G} is the height of the toe. The transition between flight and stance is state based and determined by zero crossings of an indicator function,

$$φ ( x ) = {z}_{m} - \frac{{l}_{0} ( {z}_{m} - {z}_{G} )}{l} - {z}_{G} , \qquad ( 53 )$$

which applies l from (52). Hence, the spring is assumed to be in compression when in stance and the model lifts-off once it expands back to full (rest) length.

Control authority for the SLIP also switches with phase. On the ground SAC can apply force along the spring axis, uₛ, and in flight SAC can affect the velocity of the toe in the plane (uₜ_{ₓ}, uₜ_{_{y}}). In practice this can be accomplished by rotating the center of mass. The complete 3D control vector is u=(uₛ, uₜ_{ₓ}, uₜ_{_{y}}). The flight phase dynamics,

$${f}_{f} ( x , u ) = ( \begin{matrix}{\dot{x}}_{m} \\ 0 \\ {\dot{y}}_{m} \\ 0 \\ {\dot{z}}_{m} \\ - g \\ {\dot{x}}_{m} + {u}_{{t}_{x}} \\ {\dot{y}}_{m} + {u}_{{t}_{y}}\end{matrix} ) , \qquad ( 54 )$$

and stance phase dynamics,

$${f}_{s} ( x , u ) = ( \begin{matrix}{\dot{x}}_{m} \\ \frac{( k ( {l}_{0} - l ) + {u}_{s} ) ( {x}_{m} - {x}_{t} )}{ml} \\ {\dot{y}}_{m} \\ \frac{( k ( {l}_{0} - l ) + {u}_{s} ) ( {y}_{m} - {y}_{t} )}{ml} \\ {\dot{z}}_{m} \\ \frac{( k ( {l}_{0} - l ) + {u}_{s} ) ( {z}_{m} - {z}_{G} )}{ml} - g \\ 0 \\ 0\end{matrix} ) , \qquad ( 55 )$$

depend on gravity,

$$g = 9.81 \frac{m}{{s}^{2 }} , mass , m = 1 kg ,$$

a spring resting length, l₀=1 m, and spring constant,

$$k = 100 \frac{N}{m} .$$

As discussed, though the SLIP model is a relatively simple abstraction, it is popular and used by modern robotic control systems because it captures the center of mass dynamics of running and hopping. In fact, many alternatives use a reduced flight model considering only ballistic motion of the mass. Recent methods directly specify the toe location according to prescribed touchdown angles that leave the SLIP robust to modest terrain variation. While the approach may be advantageous in that it does not require a terrain model, for robots designed to directly emulate the SLIP, the process ignores potential collisions (e.g., ledges between stairs) in not accounting for the motion of the swing-leg between take-off and landing.

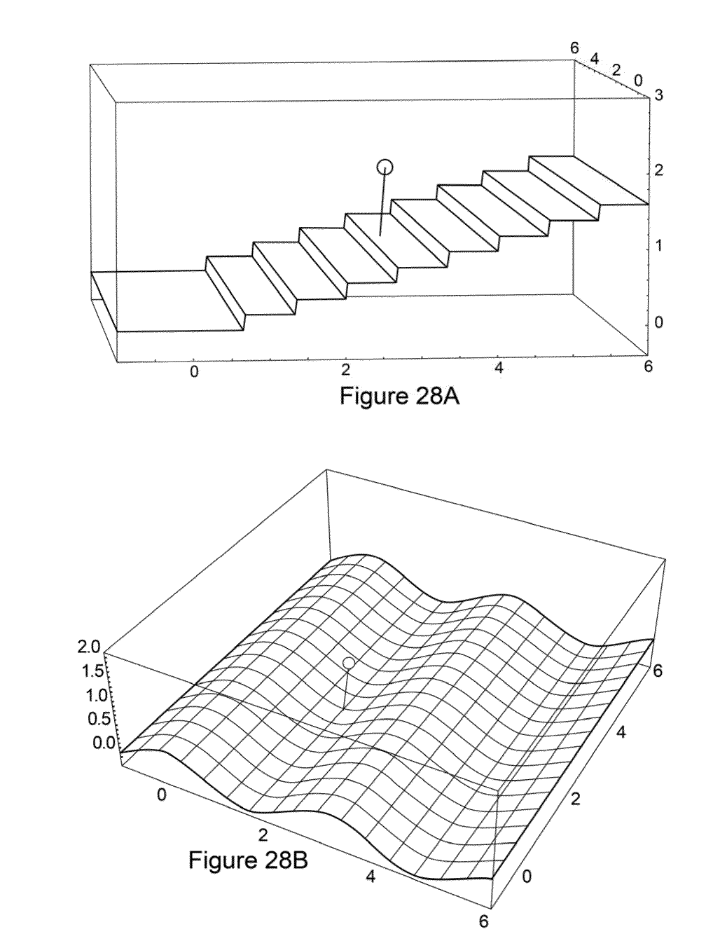

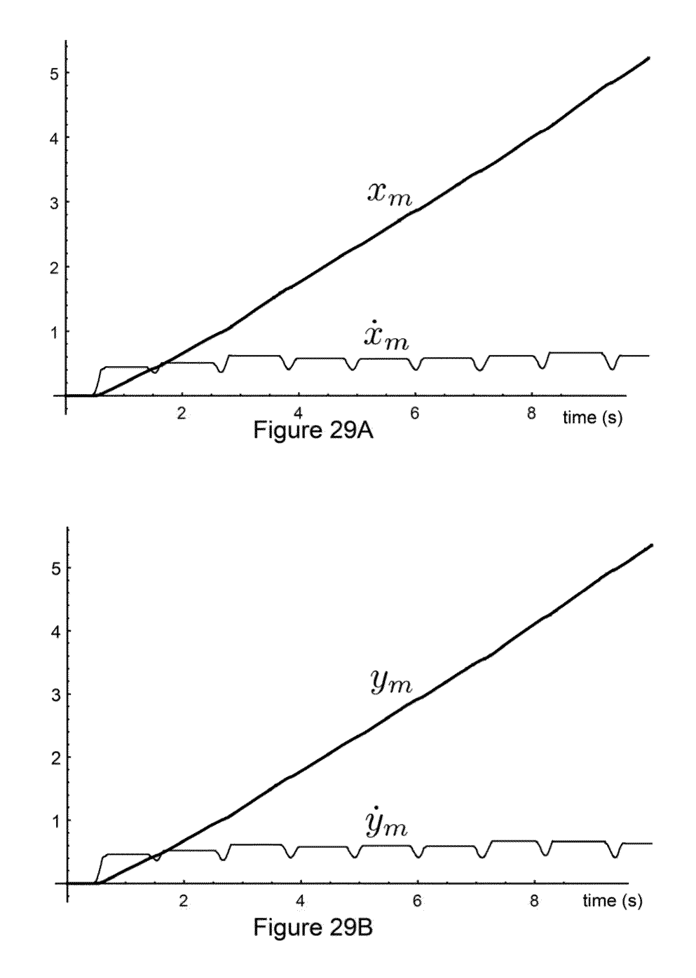

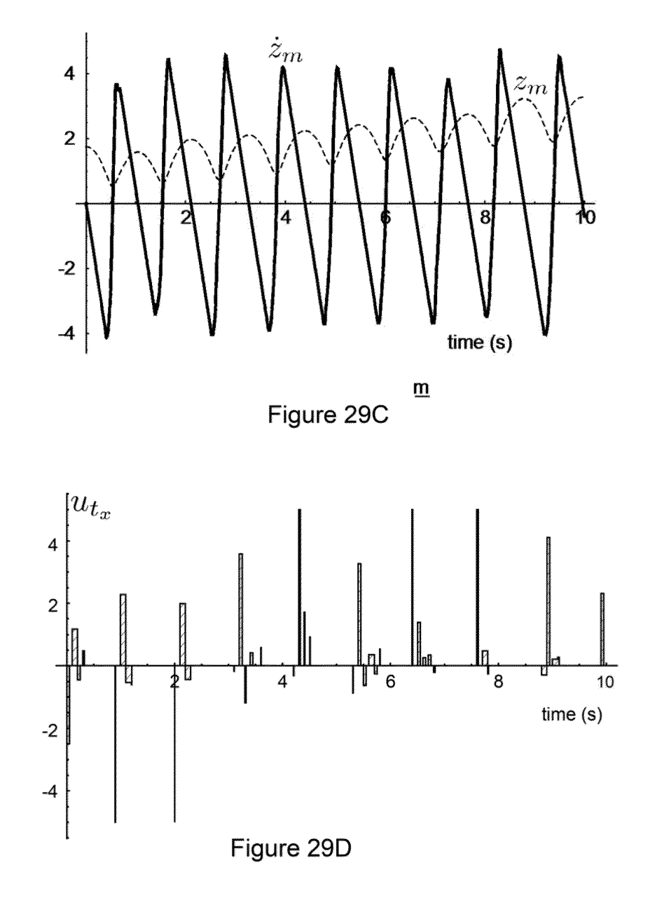

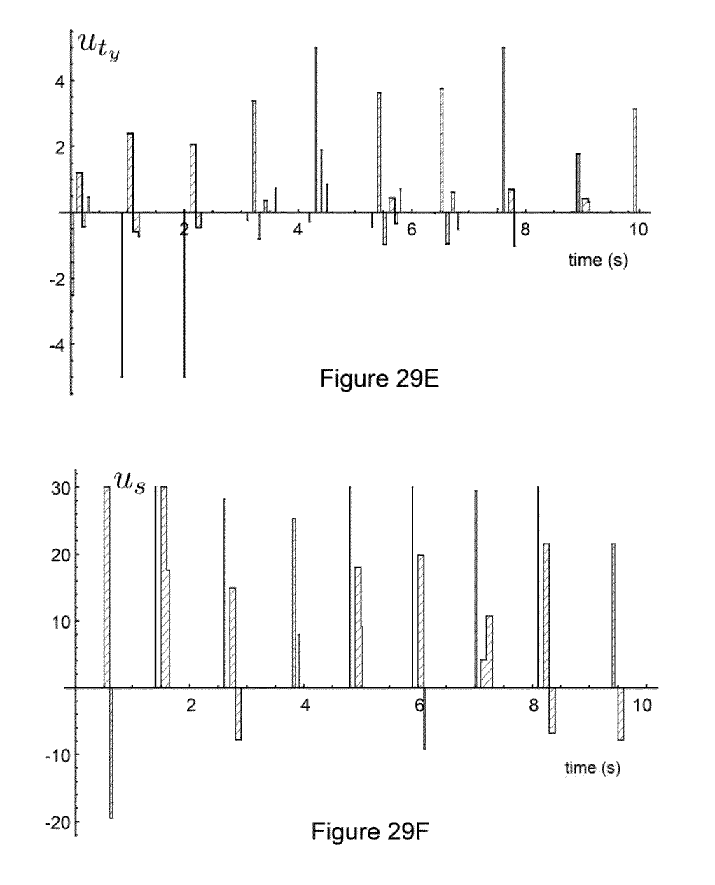

FIGS. 28A-B are block diagrams of example snapshots of the SLIP model successfully hopping up stairs and over sinusoidal terrain. The SAC process 100 computes constrained motions on-line to place the toe of the SLIP model and develops constrained thrusts that allow it to hop without falling. The process is automated in that it requires only a robot model and high-level trajectory goals specifying the desired direction of motion for the SLIP center of mass. FIGS. 29A-F are graphs of an example trajectory corresponding to the SLIP hopping up stairs (FIG. 28A).

As the snapshots of successful hopping scenarios in FIGS. 28A-B and trajectory results in FIGS. 29A-F (corresponding to the stair climbing example in FIG. 28A) show, SAC process 100 uses the flight dynamics (54) to include and automate swing-leg planning. It provides closed-loop, velocity constrained swing-leg motions on-line that avoid ledges and uses thrust to hop up stairs and over uneven, sinusoidal terrain. These tasks are achieved based on high-level trajectory goals specifying the desired direction of motion for the SLIP center of mass. They do not require system or domain specific knowledge to pre-determine touchdown angles or required hopping height. While the SAC implementation can be tested on different terrain functions, the stairs in FIG. 28A result from a ground height, z_{G}, equal to a piecewise function with a rise of 0.2 m every

$$\frac{2}{3} m .$$

The sinusoidal floor in FIG. 28B corresponds to ground height z_{G}(x)=0.3 cos(2x) m.

Besides a robot model, the only user input required for the examples in FIGS. 28A-B is a trajectory goal (3), min/max control constraints, and two scalar parameters, (T,α_{d}). Both cases use the default quadratic trajectory goal and so only require a Q matrix and desired trajectory, x_{d}. Each example applies Q=Diag[0, 70, 0, 70, 50, 0, 0, 0]. The stairs example uses

$${x}_{d} = ( 0 , 0.7 \frac{m}{s} , 0 , 0.7 \frac{m}{s} , {z}_{G} + 1.4 m , 0 , 0 , 0 )$$

to produce (approximately) constant velocity motion along the diagonal as the SLIP hops up the stairs. The trajectory results in FIG. 29A-F show the SLIP maintains the center of mass trajectory above the ground according to this desired trajectory and does not trip. In the example from FIG. 28B the SLIP successfully traverses the sinusoidal terrain while following the desired trajectory,

$${x}_{d} = ( 0 , 0.7 \frac{m}{s} , 0 , 0.7 \frac{m}{s} , {z}_{G} + 1.5 m , 0 , 0 , 0 ) .$$

This choice specifies the same constant velocity translation at fixed desired height. In each example controls are constrained on-line so that

$$\vert {u}_{{t}_{x}} \vert and \vert {u}_{{t}_{y}} \vert \leq 5 \frac{m}{s} and \vert {u}_{s} \vert \leq 30 N .$$

Once specified, neither the cost parameters (Q and x_{d}) nor the control constraints require tuning and result in successful hopping over a number of different terrain types and initial conditions. Other than the prediction horizon, T, and the rate of cost improvement, γ, all other parameters are based on standard (default) values. While (T,α_{d}) may require tuning to accommodate new robot models, once specified they often result in good performance for a variety of conditions and tracking objectives. As evidence, both SLIP examples use the same values with T=0.6 s and γ=−10. As a 90 s closed-loop trajectory (30 Hz feedback) for this SLIP on varying terrain requires <2 s to simulate on a laptop, tuning, if required, is relatively efficient, easily automated, and can be parallelized. Similar to existing methods designed around empirically stable SLIP hopping, leverage the speed of SAC to search for parameters that yield successful long-term hopping over varying terrain and initial conditions.

### CONCLUSIONS AND OTHER DIRECTIONS

The systems and methods can contribute a model-based algorithm, SAC, that sequences optimal actions together to allow closed-loop, trajectory-constrained control at roughly the rate of simulation. The systems and methods are scalable and included examples show SAC process 100 can automate control policy generation for a variety of challenging nonlinear systems using only high-level models and trajectory goals. Benchmark trials can confirm the SAC process 100 can outperform standard methods for nonlinear optimal control in terms of both tracking performance and speed.

For the continued development of SAC, consider that there are likely systems and conditions under which SAC trajectories provably coincide with optimal control solutions from dynamic programming principles (HJB). Note for instance that SAC is able to recover (on-line) the analytically optimal bang-bang minimum time parking solution, which requires non-trivial analysis tools to generate using HJB. Regularity assumptions in HJB technically exclude optimal switching solutions, and thus do not technically apply even for systems as simple as the minimum-time parking example. If such a connection exists, it is beneficial, as SAC may provide a low complexity alternative to develop optimal trajectories on-line for other systems (particularly switched systems) for which control policy generation requires specialized treatment. The connection may also yield additional criteria for selection of SAC parameters.

In spite of its ability to avoid many of the local minima issues that affect nonlinear trajectory optimization, SAC is still a local method and cannot guarantee a globally optimal solution through the state space (no method does in finite time and still considers the nonlinear and non-convex problems in this thesis). As such, for the wide range of systems SAC can control, there are bound to be others that prove difficult. As a means to increase its applicability (at the expense of computation), SAC can be combined with the global, sample-based planning methods to provide a fast local planner that develops constrained optimal solutions and still considers dynamics. It is likely that these methods allow SAC to apply even to very complicated scenarios such as those required to develop dynamic trajectories for humanoids in real-world, constrained environments.

Multiple action planning provides another way to improve the performance and applicability of SAC. Such techniques offer an intermediary between planning entire optimal control curves, as in trajectory optimization, and planning individual optimal actions, which is fast but cannot account for the combined effect of multiple actions that are not already modeled in the nominal control, u₁. As the adjoint variable used to compute optimal actions in SAC is based on a linear differential equation (5) (and (48)), there can be computationally efficient means to compute the sensitivity to multiple optimal actions applied at different times along each open-loop trajectory using superposition. It can also be possible to consider the combined effect of multiple actions based on higher-order lie brackets as is performed in determining local controllability of nonlinear systems.

For hybrid systems applications, extensions to hybrid impulsive systems allow SAC to synthesize optimal actions for classes of hybrid impulsive systems with state-based resets. These methods are general, providing ways to avoid complicated, non-smooth trajectory optimization and an alternative to heuristic first-exit control strategies. In certain cases however, it may be desirable to consider systems with guards and reset maps that switch as a function of time. Considering the SAC process 100 accommodate dynamics and incremental costs that switch as a function of time, the extension can be straightforward and follow from the approach in hybrid impulsive systems.

To more completely automate the process of control policy generation and reduce required user input, SAC can use tools for parameter tuning, especially ones that provide stability. To address these concerns, local stability and input constraints describe how SAC parameters can be selected to provide local stability around equilibrium based on the (analytical) linear state feedback law for optimal actions (18). The Sums-of-Squares (SOS) tools (e.g., the S-procedure) can be used to automate parameter tuning and the generation of Lyapunov functions for provable regions of attraction.

Away from equilibrium, the analytical expression for optimal actions is no longer linear and so manual parameter tuning is required to develop long-term, empirically stable trajectories. However, because the closed-form expression for optimal actions (8) depends only on the current state, leverage the speed of SAC synthesis to pre-compute constrained optimal actions over regions of state-space and apply these actions on-line according to a state-based look-up table. The approach suffers the same curse of dimensionality that limits HJB solutions and ADP to lower-dimensional systems. However, SAC control laws tend to be highly structured with determined, state-based switching surfaces. Hence, it is likely these switching surfaces permit sparse representation and, similarly, that they may be identified by sparse sampling. Through such techniques, it may be possible to not only pre-compute and apply constrained optimal SAC actions for higher-dimensional systems, but to develop parameters that provide desired performance and stability properties. For instance, by approximating constrained SAC controls as SOS polynomials over a region of state space, the SOS techniques previously mentioned can generate conservative approximations of stable regions of attraction. While similar to the approach described, the regions can extend beyond the local neighborhood where SAC actions satisfy the linear state feedback control law (18) and would not require a quadratic cost (17).

Example results use SAC to generate real-time trajectories that maximize information gain for parameter estimation on a Baxter Robot. These results provide evidence that SAC works in noisy environments and alongside state estimators; however, formal methods for uncertainty handling have yet to be addressed. The limited number and complexity of simulations (actions require open-loop simulations (2) and (5) instead of the closed-loop, two-point boundary-value problem in optimal control) hints at simplified uncertainty modeling and propagation, even for nonlinear systems.

While the described results indicate several potential applications for SAC, there are many more that have not been discussed. The approach applies broadly to auto-pilot and stabilization systems like those in rockets, jets, helicopters, autonomous vehicles, and walking robots. It also naturally lends itself to shared control systems where the exchange between human and computer control can occur rapidly (e.g., wearable robotics and exoskeletons. It provides a reactive, on-line control process that can reduce complexity and pre-computation required for robotic perching and aviation experiments. It facilitates predictive feedback control for new flexible robots and systems that are currently restricted to open-loop. It offers real-time system ID and parameter estimation for nonlinear systems.

The systems and methods described above may be implemented in many different ways in many different combinations of hardware, software firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various embodiments have been described, it can be apparent that many more embodiments and implementations are possible. Accordingly, the embodiments are not to be restricted.

We claim:

1. A method, comprising:
determining, with a processor, an action for a mechanism;
determining when to act on the action;
determining a duration for the action;
sending the action to the mechanism, including when to act and the duration for the action; and
receiving feedback from the mechanism based on the action.

2. The method of claim 1, further comprising predicting the action based on the feedback.

3. The method of claim 2, sending the feedback at a determined sampling time.

4. The method of claim 1, where the duration for the action comprises about 0.001 seconds.

5. The method of claim 1, further comprising sequencing the action into a piecewise continuous, closed-loop control response of actions.

6. The method of claim 5, where the closed-loop control response responds to hybrid and underactuated nonlinear dynamics to capitalize on motion capabilities and allow the mechanism to react to an environment.

7. The method of claim 1, further comprising synthesizing a next action while a current action is being carried out by the mechanism.

8. The method of claim 1, where the duration of the action is determined to iteratively improve a trajectory objective of the mechanism.

9. The method of claim 1, where the determining comprises multiple action planning for the mechanism.

10. The method of claim 1, further including not optimizing the action over a discontinuous segment of a trajectory.

11. The method of claim 1, further including planning leg placement and touchdown angles for the action.

12. A system, comprising:
a mechanism for preforming an action;
a processor connected with the mechanism, the processor for executing instructions stored in a memory, the instructions when executed by the processor causes the processor to:
determine an action for the mechanism;
determine when to act on the action;
determine a duration for the action;
send the action to the mechanism, including when to act and the duration for the action;
receive feedback from the mechanism based on the action; and
predicting the action based on the feedback.

13. The system of claim 12, where the duration for the action comprises about 0.001 seconds.

14. The system of claim 12, further comprising sequencing the action into a piecewise continuous, closed-loop control response of actions.

15. The system of claim 14, where the closed-loop control response responds to hybrid and underactuated nonlinear dynamics to capitalize on motion capabilities and allow the mechanism to react to an environment.

16. The system of claim 12, further comprising synthesizing a next action while a current action is being carried out by the mechanism.

17. The system of claim 12, where the duration of the action is determined to iteratively improve a trajectory objective of the mechanism.

18. The system of claim 12, where the determining comprises multiple action planning for the mechanism.

19. The system of claim 12, further including not optimizing the action over a discontinuous segment of a trajectory.

20. The system of claim 12, further including planning leg placement and touchdown angles for the action.
